(19) United States
(12) Patent Application Publication
(10) Pub. No.: US 2022/0193588 A1
(43) Pub. Date: Jun. 23, 2022

(54) UNDULATED FILTER MEDIA

(71) Applicant: Hollingsworth & Vose Company, East Walpole, MA (US)

(72) Inventors: Sudheer Jinka, Pelham, NH (US); Praveen Kumar Yegya Raman, Ayer, MA (US); Howard Yu, Belmont, MA (US); Xinquan Cheng, Nashua, NH (US); Sudhakar Jaganathan, Northborough, MA (US)

(73) Assignee: Hollingsworth & Vose Company, East Walpole, MA (US)

(21) Appl. No.: 17/127,822

(22) Filed: Dec. 18, 2020

(51) Int. Cl. B01D 39/20; D04H 3/018; D04H 3/016; D04H 3/015; D04H 3/004

(52) U.S. Cl. CPC B01D 39/2017; D04H 3/018; D04H 3/016; D04H 3/015; D04H 3/004; D10B 2505/04; B01D 2239/1233; B01D 2239/1216; B01D 2239/0216; B01D 2239/1258; B01D 2239/069; B01D 2239/0618

(57) ABSTRACT

Filter media comprising non-woven fiber webs and having one or more advantageous structural properties are generally described. In some embodiments, a filter media and/or non-woven fiber web described herein has one or more properties that are both beneficial and easily obtainable by undulating the non-woven fiber web, such as by performing a creping procedure. This property may be characteristic of the procedure employed to form the undulations (e.g., creping and/or microcreping), or may be attainable via one or more methods of undulation.

### FIELD

The present invention relates generally to filter media, and, more particularly, to undulated filter media.

### BACKGROUND

Filter media may be employed in a variety of applications. For instance, filter media may be employed to remove contaminants from fluids. Some filter media may exhibit undesirably low dust holding capacities and/or undesirably high pressure drop.

Accordingly, improved filter media designs are needed.

### SUMMARY

Filter media, related components, and related methods are generally described.

In some embodiments, a filter media is provided. The filter media comprises a non-woven fiber web comprising fibers. A ratio of an average fiber diameter of the fibers in the non-woven fiber web to a mean flow pore size of the non-woven fiber web is greater than or equal to 0.8.

In some embodiments, a filter media comprises a non-woven fiber web comprising fibers. The non-woven fiber web has an apparent density of less than or equal to 170 gsm/mm. The non-woven fiber web has a dust holding capacity and a beta 200 micron rating. A ratio of the dust holding capacity to the beta 200 micron is greater than or equal to 10 gsm/micron.

In some embodiments, a filter media comprises a non-woven fiber web comprising fibers. The non-woven fiber web comprises a first plurality of undulations. The non-woven fiber web comprises a second plurality of undulations positioned within at least a portion of the first plurality of undulations. The second plurality of undulations comprises at least one undulation. The first and second pluralities of undulations are irregular.

In some embodiments, a method of manufacturing a filter media is provided. The method comprises passing a non-woven fiber web through a creper to form a creped non-woven fiber web.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows one non-limiting embodiment of a filter media, in accordance with some embodiments;

FIG. 2 shows one example of a non-woven fiber web that may be positioned in a filter media, in accordance with some embodiments;

FIG. 3 shows one example of a non-woven fiber web comprising two or more pluralities of undulations, in accordance with some embodiments;

FIG. 4 shows one example of a filter media comprising two or more layers, in accordance with some embodiments;

FIG. 5 shows one example of a filter media including a non-woven fiber web that comprises a second plurality of undulations positioned within a first plurality of undulations and is pleated and/or waved;

FIGS. 6A and 6B illustrate exemplary embodiments of a filter media in which a non-woven fiber web is held in a waved configuration by two support layer, in accordance with some embodiments;

FIG. 6C shows a further embodiment of a filter media that is waved, in accordance with some embodiments;

FIGS. 7A and 7B are schematic depictions of a non-woven fiber web comprising two pluralities of undulations, in accordance with some embodiments;

FIGS. 8A-8C are micrographs showing creped non-woven fiber webs, in accordance with some embodiments;

FIG. 9 is a plot showing the ratio of dust holding capacity to beta 200 micron rating for various filter media plotted as a function of the ratio of apparent density, in accordance with some embodiments; and

FIG. 10 includes two plots showing the beta 200 micron ratings and dust holding capacities for three filter media plotted as a function of the ratio of mean flow pore size to square root of air permeability, in accordance with some embodiments.

### DETAILED DESCRIPTION

Filter media comprising non-woven fiber webs and having one or more advantageous structural properties are generally described. In some embodiments, a filter media and/or non-woven fiber web described herein has one or more properties that are both beneficial and easily obtainable by undulating the non-woven fiber web, such as by performing a creping procedure. This property may be characteristic of the procedure employed to form the undulations (e.g., creping and/or microcreping), or may be attainable via one or more methods of undulation.

As one example, in some embodiments, a filter media comprises a non-woven fiber web having a structure such that the average fiber diameter of the fibers therein is relatively large in comparison to the mean flow pore size of the non-woven fiber web. Such non-woven fiber webs may advantageously exhibit benefits associated with low mean flow pore sizes (e.g., enhanced efficiency) and high surface area (e.g., enhanced efficiency, enhanced dust holding capacity) while also making use of an appreciable amount of larger diameter fibers. Larger diameter fibers are typically less expensive than smaller diameter fibers, but also often cause an increase in mean flow pore size.

As further examples, in some embodiments, a filter media comprises a non-woven fiber web having a relatively low apparent density and/or a relatively high ratio of dust holding capacity to beta 200 micron rating. The relatively high ratio of dust holding capacity to beta 200 micron rating may be indicative of a non-woven fiber web that desirably has an appreciable dust holding capacity even at high efficiencies. This advantageous performance is typically challenging to obtain in non-woven fiber webs having low apparent densities, which tend to have structures that are more open and so less efficient, resulting in a higher beta 200 micron rating.

In some embodiments, a filter media comprises a non-woven fiber web having two or more pluralities of undulations. Two pluralities of undulations present in the non-woven fiber web may be arranged such that the second plurality of undulations is positioned within at least a portion of the first plurality of undulations. The non-woven fiber web comprising the undulations may have a structure that is relatively dense and/or that has a relatively low mean flow pore size in the interior of non-woven fiber web. However, the non-woven fiber web and/or the filter media as a whole may have a relatively low apparent density due to the appreciable amount of open space in between the undulations of the non-woven fiber web. This combination may advantageously allow for a filter media to have the properties described in the preceding paragraph.

Additionally, the presence of at least two pluralities of undulations may result in a relatively high concentration of filter media area (i.e., area that can filter a fluid) per filter media footprint (i.e., outer dimensions of the filter media perpendicular to fluid flow). This may advantageously enhance the dust holding capacity of the filter media without requiring the fabrication of non-woven fiber webs having high thicknesses.

Some embodiments relate to methods of manufacturing filter media. As one example, a method may relate to passing a non-woven fiber web through a creper (e.g., a microcreper). The non-woven fiber web may emerge from the creper as a creped non-woven fiber web. Creping may beneficially introduce undulations (e.g., two or more pluralities of undulations) into the non-woven fiber web. Such undulations may have one or more desirable properties described above. Additionally, in some embodiments, creping may compress some or all of the non-woven fiber web. This compression may push the fibers inside the non-woven fiber web closer together, decreasing the mean flow pore size of the non-woven fiber web and/or enhancing the solidity of the non-woven fiber web. As also described above, these effects may beneficially decrease the mean flow pore size of the non-woven fiber web.

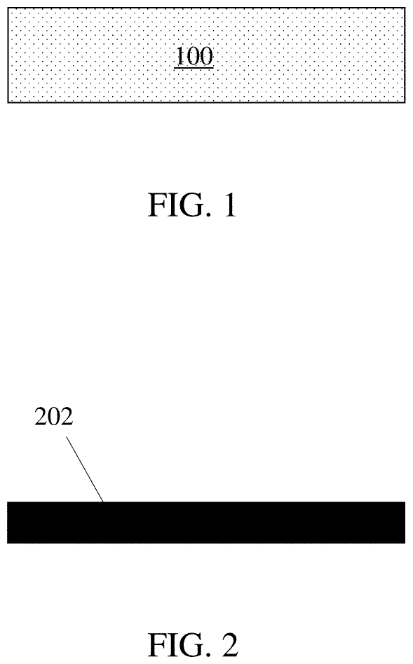

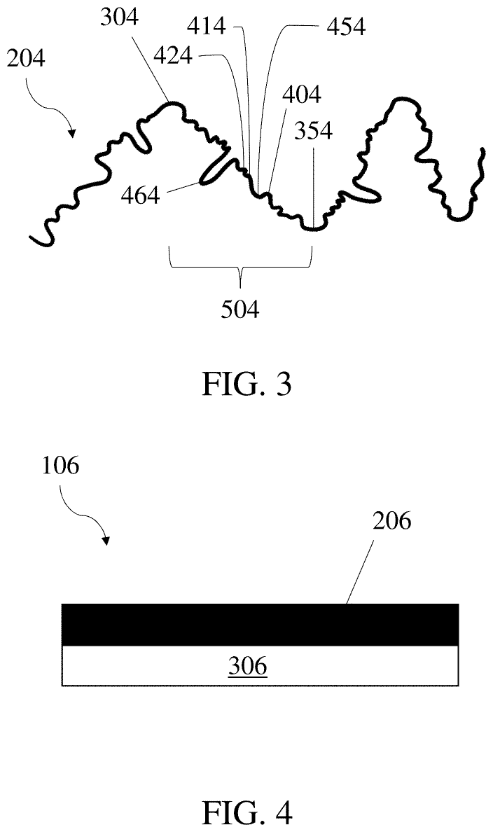

FIG. 1 shows one non-limiting embodiment of a filter media 100. In some embodiments, a filter media comprises a non-woven fiber web. FIG. 2 shows one example of a non-woven fiber web 202 that may be positioned in a filter media (e.g., a filter media like the filter media 100 shown in FIG. 1). Some non-woven fiber webs described herein comprise two or more pluralities of undulations. FIG. 3 schematically depicts one example of a non-woven fiber web having this property. In FIG. 3, the non-woven fiber web 204 comprises a first plurality of undulations comprising a peak 304 and a trough 354. The non-woven fiber web 204 depicted in FIG. 3 further comprises a second plurality of undulations comprising a peak 404 and a trough 454.

In some embodiments, like the embodiment shown in FIG. 3, a non-woven fiber web comprises a second plurality of undulations that is positioned within a first plurality of undulations. For instance, in some embodiments, a non-woven fiber web may comprise portions that are positioned between the peaks and the troughs of the first plurality of undulations and a second plurality of undulations that is present in one or more of these portions. With reference to FIG. 3, the portion 504 of the non-woven fiber web 204 is positioned between the peak 304 and the trough 354 and a second plurality of undulations is present therein. A plurality of undulations that is positioned within another plurality of undulations may start and terminate in a portion of the non-woven fiber web positioned between a peak present in the first plurality of undulations and an adjacent trough (e.g., a trough not separated from the peak by any other peaks).

In some embodiments, a non-woven fiber web comprises one or more pluralities of undulations that are irregular. For instance, in a non-woven fiber web comprising a first and second plurality of undulations in which the second plurality of undulations is positioned within the first plurality of undulations, either or both of the first and second plurality of undulations may be irregular. The irregularity may take the form of variations in peak height, trough depth, peak spacing, trough spacing, peak shape, and/or trough spacing across the plurality of undulations. With reference to FIG. 3, the trough 464 has a different depth and shape than the trough 454 although both belong to the same plurality of undulations. As another example, and also with reference to FIG. 3, the spacing between the peak 404 and the peak 414 is different from the spacing between the peak 414 and the peak 424. Although not shown in FIG. 3, it is possible for a plurality of undulations that is irregular to have one or more regular features. For instance, a plurality of undulations that is irregular may have one or more irregular features but also have one or more regular features. As one example, a plurality of undulations that is irregular may comprise peaks of differing heights but common shapes and spacings. It is also possible for a plurality of undulations to be irregular in many ways.

Some non-woven fiber webs may comprise two or more pluralities of undulations that are positioned within a first plurality of undulations. As one example, and as shown in FIG. 3, such pluralities of undulations may span each portion of the non-woven fiber web positioned between an adjacent peak and an adjacent trough. However, it is also possible for a non-woven fiber web to comprise a first plurality of undulations comprising some pairs of adjacent peaks and troughs between which a further plurality of undulations is positioned and some pairs of adjacent peaks and troughs between which no further plurality of undulations is positioned.

In some embodiments, a filter media comprises two or more layers, one or more of which may be non-woven fiber webs. FIG. 4 shows one example of a filter media having this property. In FIG. 4, the filter media 106 comprises a first layer 206 that is a non-woven fiber web and a second layer 306. In some embodiments, a filter media comprises three or more layers, four or more layers, or even more layers. It is also possible for a filter media to include exactly one layer (e.g., exactly one layer that is a non-woven fiber web).

One or more layers in the filter media may be a layer comprising two or more pluralities of undulations. In some embodiments, a filter media comprises two or more layers that each comprise two or more pluralities of undulations. For instance, a filter media may comprise two or more layers that are undulated together and/or two or more layers that are undulated separately. In layers that are undulated together, the peaks and troughs in the undulations in the different layers may substantially track each other. Layers that are undulated together and directly adjacent to each other may directly contact each other over relatively large portions of their directly adjacent surfaces. Layers that are undulated separately may lack peaks and troughs that substantially track each other and/or, for layers that are undulated separately and directly adjacent to each other, may have adjacent surfaces including substantial portions that are not in direct contact with each other.

It should also be noted that it is also possible for one or more layers in the filter media to lack any undulations at all. Layers that lack undulations may be positioned on external surfaces of the filter media, adjacent layers comprising two or more pluralities of undulations, and/or between layers that comprise two or more pluralities of undulations. In some embodiments, a filter media comprises two external layers that lack undulations and/or include fewer than two pluralities of undulations. One or more layers comprising two or more pluralities of undulations may be positioned between such external layers.

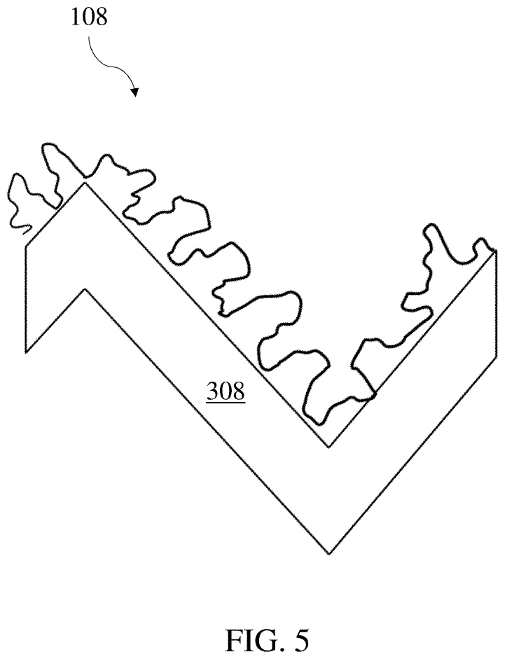

In some embodiments, a filter media is pleated and/or waved. Such filter media may comprise one or more non-woven fiber webs comprising two or more pluralities of undulations, or may lack such fiber webs. When the filter media comprises a non-woven fiber web comprising two or more pluralities of undulations, the pleats and/or waves may be on a different length scale than the pluralities of undulations. For instance, the pleats and/or waves may comprise one or more features (e.g., peaks, troughs) with a size greater in magnitude than a feature (e.g., a peak, a trough) of some or all of the pluralities of undulations. It is also possible for the pluralities of undulations present in one or more non-woven fiber webs and/or layers to have, at least partially, a different orientation than undulations forming the peaks and/or waves. A non-limiting example of a filter media including a non-woven fiber web that comprises a second plurality of undulations positioned within a first plurality of undulations and is pleated and/or waved is shown in FIG. 5. As illustrated in FIG. 5, a filter media 108 may include a non-woven fiber web 208 comprising a second plurality of undulations positioned within a first plurality of undulations, may include a second layer 308, and may be pleated or waved. Filter media may comprise non-woven fiber webs comprising two or more pluralities of undulations in addition to any pleats and/or waves that are external layers or inner layers. Similarly, filter media may comprise external and/or internal layers lacking undulations other than pleats or waves.

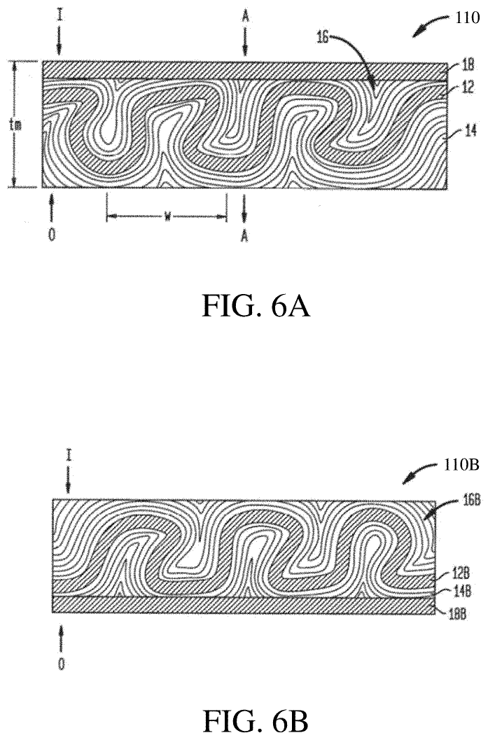

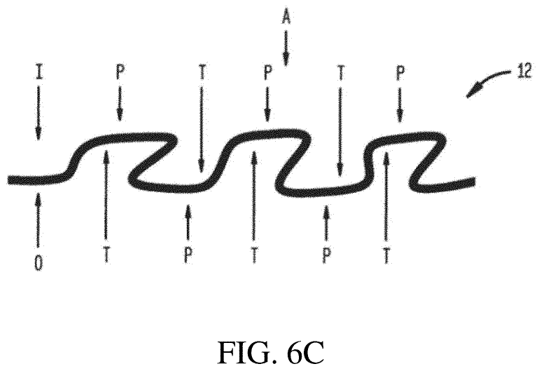

In some embodiments, a filter media comprising pleats and/or waves further comprises one or more additional support layers (e.g., one or more fibrous support layers) that hold the one or more pleated and/or waved non-woven fiber webs and/or layers in the pleated and/or waved configuration. The support layer(s) may lack pluralities of undulations and/or may be relatively flat prior to the formation of peaks and/or waves. FIG. 6A illustrates one exemplary embodiment of a filter media in which a non-woven fiber web is held in a waved configuration by two support layers. FIG. 6A depicts a filter media 110 having at least one non-woven fiber web and at least one support layer that holds the non-woven fiber web in a waved configuration. The support layer may also maintain separation of peaks and troughs of adjacent waves of the waved non-woven fiber web. In the illustrated embodiment, the filter media 110 includes a first layer 12, a first, downstream support layer 14, and a second, upstream support layer 16. The first and second support layers 14 and 16 are disposed on opposite sides of the non-woven fiber web 12. Further layers may be positioned between the non-woven fiber web and the support layers shown in FIG. 6A, such as nanofiber layer(s), meltblown layer(s), and/or scrims. Although not shown, the non-woven fiber web 12 may comprise two or more pluralities of undulations, such as a second plurality of undulations positioned within a first plurality of undulations. The first and second support layers 14 and 16 may lack undulations prior to waving with the non-woven fiber web 12. The support layers 14, 16 can help maintain the non-woven fiber web 12, and optionally any additional layers described elsewhere herein, in the waved configuration.

Additionally, while two support layers 14 and 16 are shown in FIG. 6A, filter media that are waved and/or pleated need not include both support layers. Where only one support layer is provided, the support layer can be disposed upstream or downstream of the other layer(s) and/or non-woven fiber web(s) present in the filter media.

Filter media described herein can also optionally include one or more outer or cover layers located on the upstream-most and/or downstream-most sides thereof. FIG. 6A illustrates a top layer 18 disposed on the upstream side of the filter media 110 to function, for example, as an upstream dust holding layer. Top layers can also function as aesthetic layers. The layers in the embodiment shown in FIG. 6A are arranged so that the top layer 18 is disposed on the air entering side, labeled I, the second support layer 16 is just downstream of the top layer 18, the non-woven fiber web 12 is disposed just downstream of the second support layer 16, and the first support layer 14 is disposed downstream of the non-woven fiber web 12 on the air outflow side, labeled O. The direction of air flow, i.e., from air entering I to air outflow O, is indicated by the arrows marked with reference A.

Outer and/or cover layers can alternatively or additionally be bottom layers disposed on the downstream side of filter media to function as strengthening component(s) that provide structural integrity to the filter media and/or help maintain the waved configuration. The outer or cover layer(s) can also function to offer abrasion resistance. FIG. 6B illustrates another embodiment of a filter media 110B that is similar to filter media 110 of FIG. 6A. In this embodiment, the filter media 110B does not include a top layer, but rather has a non-woven fiber web 12B, a first support layer 14B disposed just downstream of the non-woven fiber web 12B, a second support layer 16B disposed just upstream of the non-woven fiber web 12B on the air entering side I, and a bottom layer 18B disposed just downstream of the first support layer 14B on the air exiting side O. Further layers may be positioned between the non-woven fiber web and the support layers shown in FIG. 6B, such as nanofiber layer(s), meltblown layer(s), and/or scrims. Furthermore, as shown in the exemplary embodiments of FIGS. 6A and 6B, the outer and/or cover layer(s) can have topography/topographies different from the topographies of the non-woven fiber web and/or any support layers. For example, in either a pleated or non-pleated configuration, the outer or cover layer(s) may be non-pleated (e.g., substantially planar, lacking undulations), whereas some or all of the non-woven fiber webs, any support layers, and/or any layer(s) positioned between the non-woven fiber web and the support layer(s) may have a waved configuration.

It should be understood that while some embodiments relate to waved and/or pleated filter media, like those shown in FIGS. 6A and 6B, some filter media that are not waved may have one or more of the features shown in FIGS. 6A and/or 6B.

As described elsewhere herein, some embodiments relate to methods of manufacturing filter media with the assistance of a creper, such as a microcreper. The method may comprise passing a non-woven fiber web through the creper to form a creped non-woven fiber web. The non-woven fiber web may be passed through the creper when in the form of a single, stand-alone layer, or the non-woven fiber web may be positioned in a stack of layers that are together creped. After passing through the creper, the non-woven fiber web may be assembled with one or more further layers (e.g., that may comprise creped layers and/or uncreped layers) and/or positioned in a filter element.

Crepers are instruments that form undulations in articles passed therethrough. Crepers may include a drive roll, a pressing member, and a retarding member. The filter media being creped may be pressed onto the drive roll by the pressing member and retarded by a retarding member. The pressing member may advance the roll and the filter media disposed thereon forward, and the retarding member may resist forward motion of the article. The interplay between the pressing member and the retarding member may cause the filter media disposed on the drive roll to wrinkle and/or develop undulations, such as undulations having one or more of the features described herein. In some embodiments, filter media formed by a creping process comprise one or more portions that are compressed through their thicknesses (e.g., troughs in a plurality of undulations). Suitable crepers include microcrepers that may be obtained from Micrex corporation. Additionally, further details regarding some types of microcrepers are provided in U.S. Pat. Nos. 7,854,046, 3,260,778, 3,810,280, 4,090,385, 4,894,196, 4,717,329, 5,969,349, 5,666,703, and 5,678,288, each of which are incorporated herein by reference in their entirety.

Filter media that are waved and/or pleated may undergo one or more further manufacturing steps to form the waves and/or pleats. These steps may take place directly after fabrication of the filter media for filter media lacking undulations or after undergoing a creping process for filter media that are creped. In an exemplary embodiment, one or more layers in the filter media are waved. The layer(s) to be waved may be positioned adjacent to one another in a desired arrangement from air entering side to air outflow side, and the combined layers may be conveyed between first and second moving surfaces that are traveling at different speeds, such as with the second surface traveling at a speed that is slower than the speed of the first surface. A suction force, such as a vacuum force, can be used to pull the layers toward the first moving surface, and then toward the second moving surface as the layers travel from the first to the second moving surfaces. The speed difference may cause the layers to form z-direction waves as they pass onto the second moving surface, thus forming peaks and troughs in the layers. The speed of each surface can be altered to obtain the desired number of waves per inch. The distance between the surfaces can also be altered to determine the amplitude of the peaks and troughs, and in an exemplary embodiment the distance is adjusted between 0.025 inches to 4 inches.

In some embodiments, the amplitude of the waves formed by a waving process may be between 0.1 inch and 4.0 inches, e.g., between 0.1 inch and 1.0 inch, between 0.1 inch and 2.0 inches, or between 3.0 inches and 4.0 inches. For certain applications, the amplitude of the waves may be between 0.1 inch and 1.0 inch, between 0.1 inch and 0.5 inches, or between 0.1 inch and 0.3 inches. The properties of the different layers can also be altered to obtain a desired filter media configuration. In an exemplary embodiment, the filter media has 2 to 6 waves per inch, with a height (overall thickness) in the range of between 0.025 inches and 2 inches, however this can vary significantly depending on the intended application. For instance, in other embodiments, the filter media may have 2 to 4 waves per inch, e.g., 3 waves per inch. As shown in FIG. 6A, in some embodiments, a single wave W extends from the middle of one peak to the middle of an adjacent peak.

In the embodiment shown in FIG. 6A, when the non-woven fiber web 12 and the support layers 14, 16 are waved, the resulting non-woven fiber web 12 will have a plurality of peaks P and troughs T on each surface thereof (i.e., air entering side I and air outflow side O), as shown in FIG. 6C. The support layers 14, 16 will extend across the peaks P and into the troughs T so that the support layers 14, 16 also have waved configurations. A person skilled in the art will appreciate that a peak P on the air entering side I of the non-woven fiber web 12 will have a corresponding trough T on the air outflow side O. Thus, the downstream support layer 14 will extend into a trough T, and exactly opposite that same trough T is a peak P, across which the upstream support layer 16 will extend. Since the downstream support layer 14 extends into the troughs T on the air outflow side O of the non-woven fiber web 12, the downstream coarse layer 14 will maintain adjacent peaks P on the air outflow side O at a distance apart from one another and will maintain adjacent troughs T on the air outflow side O at a distance apart from one another. The upstream support layer 16, if provided, can likewise maintain adjacent peaks P on the air entering side I of the non-woven fiber web 12 at a distance apart from one another and can maintain adjacent troughs T on the air entry side I of the non-woven fiber web 12 at a distance apart from one another. As a result, the non-woven fiber web 12 has a surface area that is significantly increased, as compared to a surface area of the fiber filtration layer in the planar configuration.

In certain exemplary embodiments, the surface area in the waved configuration is increased by at least 50%, and in some instances as much as 120%, as compared to the surface area of the same layer in a planar configuration. In other words, the waved configuration may comprise at least 50% more, or at least 120% more, of filter media area per footprint of the filter media than an otherwise equivalent unwaved filter media.

In embodiments in which the upstream and/or downstream support layers hold the one or more other layers in a waved configuration, it may be desirable to reduce the amount of free volume (e.g., volume that is unoccupied by any fibers) in the troughs. That is, a relatively high percentage of the volume in the troughs may be occupied by the support layer(s) to give the other layer(s) structural support. For example, at least 95% or substantially all of the available volume in the troughs may be filled with the support layer. The support layer may have a solidity of greater than or equal to 1%, greater than or equal to 1.25%, greater than or equal to 1.5%, greater than or equal to 2%, greater than or equal to 2.5%, greater than or equal to 3%, greater than or equal to 4%, greater than or equal to 5%, greater than or equal to 7.5%, greater than or equal to 10%, greater than or equal to 12.5%, greater than or equal to 15%, greater than or equal to 20%, or greater than or equal to 25%. The support layer may have a solidity of less than or equal to 30%, less than or equal to 25%, less than or equal to 20%, less than or equal to 15%, less than or equal to 12.5%, less than or equal to 10%, less than or equal to 7.5%, less than or equal to 5%, less than or equal to 4%, less than or equal to 3%, less than or equal to 2.5%, less than or equal to 2%, less than or equal to 1.5%, or less than or equal to 1.25%. Combinations of the above-referenced ranges are also possible (e.g., greater than or equal to 1% and less than or equal to 30%, greater than or equal to 4% and less than or equal to 20%, or greater than or equal to 5% and less than or equal to 15%). Other ranges are also possible.

The solidity of a support layer may be determined by using the following formula: solidity=[basis weight/(fiber density*thickness)]*100%. The basis weight and thickness may be determined as described elsewhere herein. The fiber density is equivalent to the average density of the material or material(s) forming the fiber, which is typically specified by the fiber manufacturer. The average density of the materials forming the fibers may be determined by: (1) determining the total volume of all of the fibers in the filter media; and (2) dividing the total mass of all of the fibers in the filter media by the total volume of all of the fibers in the filter media. If the mass and density of each type of fiber in the filter media are known, the volume of all the fibers in the filter media may be determined by: (1) for each type of fiber, dividing the total mass of the type of fiber in the filter media by the density of the type of fiber; and (2) summing the volumes of each fiber type. If the mass and density of each type of fiber in the filter media are not known, the volume of all the fibers in the filter media may be determined in accordance with Archimedes' principle.

Additionally, as shown in the exemplary embodiments of FIG. 6A, the extension of the support layer(s) across the peaks and into the troughs may be such that the surface area of the support layer in contact with a top layer 18A is similar across the peaks as it is across the troughs. Similarly, the surface area of the support layer in contact with a bottom layer 18B (FIG. 6B) may be similar across the peaks as it is across the troughs. For example, the surface area of the support layer in contact with a top or bottom layer across a peak may differ from the surface area of the support layer in contact with the top or bottom layer across a trough by less than 70%, less than 50%, less than 30%, less than 20%, less than 10%, or less than 5%.

In certain exemplary embodiments, the downstream and/or upstream support layers 14, 16 can have a fiber density that is greater at the peaks than it is in the troughs; and, in some embodiments, a fiber mass that is less at the peaks than it is in the troughs. This can result from the coarseness of the downstream and/or upstream support layers 14, 16 relative to the non-woven fiber web 12. In particular, as the layers are passed from the first moving surface to the second moving surface, the relatively fine nature of the non-woven fiber web 12 may allow the downstream and/or upstream support layers 14, 16 to conform around the waves formed in the non-woven fiber web 12. As the support layers 14, 16 extend across a peak P, the distance traveled will be less than the distance that each layer 14, 16 travels to fill a trough. As a result, the support layers 14, 16 will compact at the peaks, thus having an increased fiber density at the peaks as compared to the troughs, through which the layers will travel to form a loop-shaped configuration.

Once the layers are formed into a waved configuration, the waved shape can be maintained by activating binder fibers (e.g., binder fibers in one or both of the support layers) to effect bonding of the fibers. A variety of techniques can be used to activate the binder fibers. For example, if multicomponent fibers, such as bicomponent binder fibers having a core and sheath, are used, the binder fibers can be activated upon the application of heat. If monocomponent binder fibers are used, the binder fibers can be activated upon the application of heat, steam and/or some other form of warm moisture. A top layer 18 (FIG. 6A) and/or bottom layer 18B (FIG. 6B) can also be positioned on top of the upstream support layer 16 (FIG. 6A) or on the bottom of the downstream support layer 14B (FIG. 6B), respectively, and mated, such as by bonding, to the upstream support layer 16 or downstream support layer 14B simultaneously or subsequently. A person skilled in the art will also appreciate that the layers can optionally be mated to one another using various techniques other than using binder fibers. The layers can also be individually bonded layers, and/or they can be mated, including bonded, to one another prior to being waved.

As described above, in some embodiments, a filter media comprises a non-woven fiber web and/or a layer comprising two or more pluralities of undulations. In some such embodiments, a second plurality of undulations may be positioned within the first plurality of undulations. In some embodiments, a filter media comprises a first plurality of undulations for which, for an appreciable fraction of the undulations, a second plurality of undulations is positioned therein. In some embodiments, second pluralities of undulations are positioned within greater than or equal to 1%, greater than or equal to 2%, greater than or equal to 5%, greater than or equal to 7.5%, greater than or equal to 10%, greater than or equal to 15%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, or greater than or equal to 95% of the undulations within a first plurality of undulations. In some embodiments second pluralities of undulations are positioned within less than or equal to 99%, less than or equal to 95%, less than or equal to 90%, less than or equal to 80%, less than or equal to 70%, less than or equal to 60%, less than or equal to 50%, less than or equal to 40%, less than or equal to 30%, less than or equal to 20%, less than or equal to 15%, less than or equal to 10%, less than or equal to 7.5%, less than or equal to 5%, or less than or equal to 2% of the undulations in a first plurality of undulations. Combinations of the above-referenced ranges are also possible (e.g., greater than or equal to 1% and less than or equal to 99%, or greater than or equal to 1% and less than or equal to 80%). Other ranges are also possible.

Undulations in a first plurality of undulations may have a variety of suitable heights. In some embodiments, a filter media, non-woven fiber web, and/or layer comprises a first plurality of undulations comprising undulations having an average height of greater than or equal to 0.05 mm, greater than or equal to 0.075 mm, greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, greater than or equal to 7.5 mm, greater than or equal to 10 mm, greater than or equal to 15 mm, or greater than or equal to 20 mm. In some embodiments, a filter media, non-woven fiber web, and/or layer comprises a first plurality of undulations comprising undulations having an average height of less than or equal to 25 mm, less than or equal to 20 mm, less than or equal to 15 mm, less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, less than or equal to 0.2 mm, less than or equal to 0.1 mm, or less than or equal to 0.075 mm. Combinations of the above-referenced ranges are also possible (e.g., greater than or equal to 0.05 mm and less than or equal to 25 mm). Other ranges are also possible.

The height of an undulation in a first plurality of undulations may be determined by: (1) drawing a first line segment connecting two directly adjacent troughs in a first plurality of undulations; (2) drawing a second line segment connecting the peak positioned between the two troughs with the first line segment that is also perpendicular to the first line segment; and (3) measuring the length of the second line segment. The average height of the undulations in a first plurality of undulations may be determined by averaging the individual heights for each undulation in the first plurality of undulations.

Undulations in a second plurality of undulations may also have a variety of suitable heights. Such undulations may have smaller heights than the undulations in which they are positioned (e.g., a first plurality of undulations). In some embodiments, a filter media, non-woven fiber web, and/or layer comprises a second plurality of undulations comprising undulations having an average height of greater than or equal to 0.01 mm, greater than or equal to 0.02 mm, greater than or equal to 0.05 mm, greater than or equal to 0.075 mm, greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, greater than or equal to 7.5 mm, greater than or equal to 10 mm, greater than or equal to 15 mm, or greater than or equal to 20 mm. In some embodiments, a filter media, non-woven fiber web, and/or layer comprises a second plurality of undulations comprising undulations having an average height of less than or equal to 24.99 mm, less than or equal to 20 mm, less than or equal to 15 mm, less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, less than or equal to 0.2 mm, less than or equal to 0.1 mm, less than or equal to 0.075 mm, less than or equal to 0.05 mm, or less than or equal to 0.02 mm. Combinations of the above-referenced ranges are also possible (e.g., greater than or equal to 0.01 mm and less than or equal to 24.99 mm). Other ranges are also possible.

The height of an undulation in a second plurality of undulations may be determined by: (1) drawing a first line segment connecting a peak in the first plurality of undulations and a directly adjacent trough in the first plurality of undulations within which the second plurality of undulations is positioned; (2) drawing a second line segment connecting a point in the plurality of second undulations having a local maximum distance from the first line segment with the first line segment that is also perpendicular to the first line segment; and (3) measuring the length of the second line segment. In step (3), the length will always be considered to be a positive value (i.e., second line segments connecting portions of the second undulation on one side of the first line segment thereto and second line segments connecting portions of the second undulation on the opposite side of the first line segment thereto will be considered to have lengths having positive values). This set of heights for each undulation is indexed with respect to the first line segment. Accordingly, the average height for the undulations in a second plurality of undulations may be determined by averaging the individual heights for each undulation in the second plurality of undulations and then multiplying the resultant value by 2.

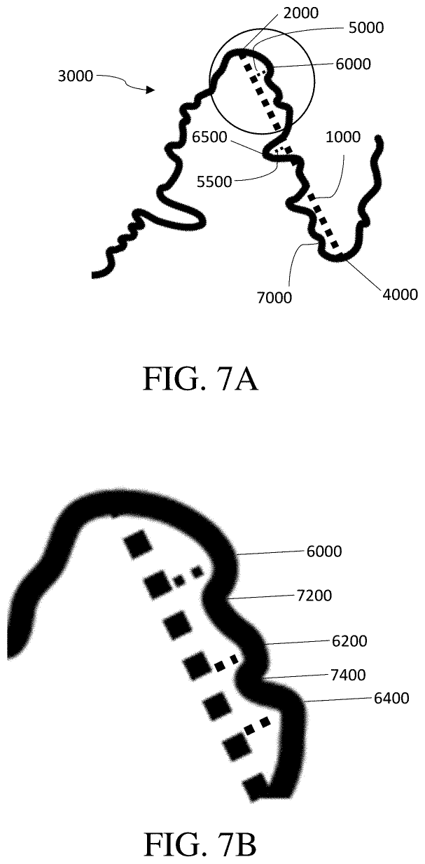

This calculation method can be understood further with reference to FIGS. 7A and 7B. In FIG. 7A, a first line segment 1000 connects a peak 2000 in a first plurality of undulations 3000 with a trough 4000. FIG. 7A also shows two examples of second line segments: the second line segment 5000 connecting the first line segment 1000 with a first point 6000 in the plurality of second undulations having a local maximum distance from the first line segment; and the second line segment 5500 connecting the first line segment 1000 with a second point 6500 in the plurality of second undulations having a local maximum distance from the first line segment. It should be noted that there may be some local minima in distances between the first line segment and the second line segment (e.g., like the local minimum 7000). Such local minima are not included in the calculations for the average height of the undulations.

FIG. 7B shows an enlarged portion of the area enclosed in the circle in FIG. 7A. As shown in FIG. 7B, the points 6000, 6200, and 6400 having local maximum distances from the first line segment are each considered to be undulations having heights for the purposes of the above-described calculation. Accordingly, second line segments are drawn between these points and the first line segment and employed in the calculation of the average height of the undulations in the second plurality of undulations. Additionally, as also shown in FIG. 7B, the points 7200 and 7400 having local minimum distances from the first line segment are not factored into this calculation.

The second pluralities of undulations described herein may comprise a variety of suitable numbers of undulations within a first plurality of undulations. In some embodiments, the average number of undulations in a second plurality undulations positioned within an undulation in a first plurality of undulations (i.e., the average number of undulations in the second plurality of undulations positioned between a peak in a first plurality of undulations and an adjacent trough) is greater than or equal to 1, greater than or equal to 2, greater than or equal to 3, greater than or equal to 4, greater than or equal to 5, greater than or equal to 6, greater than or equal to 7, greater than or equal to 8, greater than or equal to 10, greater than or equal to 12, greater than or equal to 14, greater than or equal to 16, or greater than or equal to 18. In some embodiments, the average number of undulations in a second plurality undulations positioned within an undulation in a first plurality of undulations is less than or equal to 20, less than or equal to 18, less than or equal to 16, less than or equal to 14, less than or equal to 12, less than or equal to 10, less than or equal to 8, less than or equal to 7, less than or equal to 6, less than or equal to 5, less than or equal to 4, less than or equal to 3, or less than or equal to 2. Combinations of the above-referenced ranges are also possible (e.g., greater than or equal to 1 and less than or equal to 20, or greater than or equal to 8 and less than or equal to 20). Other ranges are also possible.

For the purpose of the ranges in the preceding paragraph, the number of undulations positioned in a second plurality of undulations is equivalent to the sum of the numbers of peaks and troughs in the second plurality of undulations divided by two.

A variety of suitable types of non-woven fiber webs may be employed in the filter media described herein. In some embodiments, a filter media comprises a non-woven fiber web of a first type. The non-woven fiber web of the first type may serve as an efficiency layer. Non-woven fiber webs of the first type may, as described elsewhere herein, comprise two or more pluralities of undulations, comprise exactly one plurality of undulations, or lack undulations. Non-limiting examples of suitable structures for non-woven fiber webs of the first type include wet laid non-woven fiber webs, carded non-woven fiber webs, and/or spunmelt non-woven fiber webs. In some embodiments, a filter media comprises a non-woven fiber web of the first type that is collated and/or bonded to one or more further layers present in the filter media. The other layer(s) may include one or more additional non-woven fiber webs of the first type (e.g., one or more of the previously-identified non-woven fiber webs) and/or one or more other layers described herein (e.g., a nanofiber layer described elsewhere herein). The collation and/or bonding may comprise the use of an adhesive, thermal bonding, and/or lamination.

The non-woven fiber webs of the first type described herein may comprise a variety of suitable types of fibers. Some non-woven fiber webs of the first type comprise exactly one type of fiber. Some non-woven fiber webs of the first type comprise two or more types of fibers. For instance, a non-woven fiber web may comprise three or more types of fibers, four or more types of fibers, five or more types of fibers, or even more types of fibers. When a non-woven fiber web comprises two or more types of fibers, the types of fibers may differ in a variety of ways, such as average fiber diameter, average fiber length, structure (e.g., fibrillation, number and/or arrangement of components), and/or chemical composition. Fibers of different types may have no features in common or may have both some features that are the same as each other (e.g., chemical composition) and some features that are different (e.g., average fiber diameter).

The non-woven fiber webs of the first type may comprise fibers having a variety of suitable average fiber diameters. In some embodiments, a non-woven fiber web of the first type comprises fibers having an average fiber diameter of greater than or equal to 0.1 micron, greater than or equal to 0.2 microns, greater than or equal to 0.3 microns, greater than or equal to 0.4 microns, greater than or equal to 0.5 microns, greater than or equal to 0.6 microns, greater than or equal to 0.8 microns, greater than or equal to 1 micron, greater than or equal to 2 microns, greater than or equal to 5 microns, greater than or equal to 7.5 microns, greater than or equal to 10 microns, greater than or equal to 12.5 microns, greater than or equal to 15 microns, or greater than or equal to 17.5 microns. In some embodiments, a non-woven fiber web of the first type comprises fibers having an average fiber diameter of less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 2 microns, less than or equal to 1 micron, less than or equal to 0.8 microns, less than or equal to 0.6 microns, less than or equal to 0.5 microns, less than or equal to 0.4 microns, less than or equal to 0.3 microns, or less than or equal to 0.2 microns. Combinations of the above-referenced ranges are also possible (e.g., greater than or equal to 0.1 micron and less than or equal to 20 microns, or greater than or equal to 0.4 microns and less than or equal to 15 microns). Other ranges are also possible.

When a non-woven fiber web of the first type comprises two or more types of fibers, each type of fiber may independently have an average fiber diameter in one or more of the ranges described above and/or all of the fibers in a non-woven fiber web of the first type may together have an average fiber length in one or more of the ranges described above. Similarly, when a filter media comprises two or more non-woven fiber webs of the first type, each non-woven fiber web of the first type may independently comprise one or more types of fibers having an average fiber length in one or more of the ranges described above and/or may comprise fibers that overall have an average fiber length in one or more of the ranges described above.

The non-woven fiber webs of the first type described herein may comprise synthetic fibers. In some embodiments, synthetic fibers make up greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 20 wt %, greater than or equal to 30 wt %, greater than or equal to 50 wt %, greater than or equal to 70 wt %, greater than or equal to 80 wt %, greater than or equal to 85 wt %, greater than or equal to 90 wt %, or greater than or equal to 95 wt % of the fibers in a non-woven fiber web of the first type. In some embodiments, synthetic fibers make up less than or equal to 100 wt %, less than or equal to 95 wt %, less than or equal to 90 wt %, less than or equal to 85 wt %, less than or equal to 80 wt %, less than or equal to 70 wt %, less than or equal to 50 wt %, less than or equal to 30 wt %, less than or equal to 20 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, or less than or equal to 0.1 wt % of the fibers in a non-woven fiber web of the first type. Combinations of the above-referenced ranges are also possible (e.g., greater than or equal to 0 wt % and less than or equal to 100 wt %, greater than or equal to 0.1 wt % and less than or equal to 100 wt %, or greater than or equal to 80 wt % and less than or equal to 100 wt %). Other ranges are also possible. In some embodiments, synthetic fibers make up 0 wt % of the fibers in a non-woven fiber web of the first type. In some embodiments, synthetic fibers make up 100 wt % of the fibers in a non-woven fiber web of the first type.

When a non-woven fiber web of the first type comprises two or more types of synthetic fibers, each type of synthetic fiber may independently make up an amount of the fibers in the non-woven fiber web of the first type in one or more of the ranges described above and/or all of the synthetic fibers in a non-woven fiber web may together make up an amount of the fibers in the non-woven fiber web of the first type in one or more of the ranges described above. Similarly, when a filter media comprises two or more non-woven fiber webs of the first type, each non-woven fiber web of the first type may independently comprise an amount of any particular type of synthetic fiber in one or more of the ranges described above and/or may comprise a total amount of synthetic fibers in one or more of the ranges described above.

Synthetic fibers included in the non-woven fiber webs of the first type described herein may have a variety of compositions and morphologies. For instance, non-limiting examples of suitable materials that may be included in synthetic fibers include poly(ester)s (e.g., poly(ethylene terephthalate), poly(butylene terephthalate)), poly(carbonate), poly(amide)s (e.g., various nylon polymers), poly(aramid)s, poly(imide)s, poly(olefin)s (e.g., poly(ethylene), poly(propylene)), poly(ether ether ketone), poly(acrylic)s (e.g., poly(acrylonitrile), dryspun poly(acrylic)), poly(vinyl alcohol), regenerated cellulose (e.g., synthetic cellulose such cellulose acetate, rayon), fluorinated polymers (e.g., poly(vinylidene difluoride) (PVDF)), copolymers of poly(ethylene) and PVDF, and poly(ether sulfone)s. Additionally, non-woven fiber webs of the first type may comprise monocomponent synthetic fibers (e.g., monocomponent non-binder synthetic fibers, monocomponent binder synthetic fibers) and/or multicomponent synthetic fibers.

When a filter media comprises two or more non-woven fiber webs of the first type, each non-woven fiber web of the first type may independently comprise some or all of the above types of synthetic fibers.

In some embodiments, a non-woven fiber web of the first type comprises synthetic fibers that are staple fibers. The staple fibers may be fibers that are cut (e.g., from a filament) or formed as non-continuous discrete fibers to have a particular length or a range of lengths. The staple fibers may comprise fibers that are fibrillated and/or fibers that are unfibrillated. It is also possible for the staple fibers to comprise single component staple fibers (e.g., single component staple fibers that are also binder fibers, single component staple fibers that are not binder fibers) and/or multicomponent staple fibers.

In some embodiments, a non-woven fiber web of the first type comprises two or more types of staple fibers. Each type of staple fibers may differ from the other types in one or more ways. For instance, in some embodiments, a non-woven fiber web of the first type comprises one type of staple fiber that has a relatively small average fiber diameter and one type of staple fiber that has a relatively large average fiber diameter.

In some embodiments, a non-woven fiber web of the first type comprises an appreciable number of staple fibers having a relatively small average fiber diameter. The staple fibers having the relatively small average fiber diameter may make up greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % of the fibers in a non-woven fiber web of the first type. The staple fibers having the relatively small average fiber diameter may make up less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, or less than or equal to 0.1 wt % of the fibers in a non-woven fiber web of the first type. Combinations of the above-referenced ranges are also possible (e.g., greater than or equal to 0 wt % and less than or equal to 100 wt %, greater than or equal to 0.1 wt % and less than or equal to 100 wt %, or greater than or equal to 1 wt % and less than or equal to 80 wt %). Other ranges are also possible. In some embodiments, staple fibers having a relatively small average fiber diameter make up 0 wt % of the fibers in a non-woven fiber web of the first type. In some embodiments, staple fibers having a relatively small average fiber diameter make up 100 wt % of the fibers in a non-woven fiber web of the first type.

When a filter media comprises two or more non-woven fiber webs of the first type, each non-woven fiber web of the first type may independently comprise an amount of staple fibers having a relatively small average fiber diameter in one or more of the above-referenced ranges.

Staple fibers having a relatively small average fiber diameter may have an average fiber diameter of less than or equal to 3 microns, less than or equal to 2 microns, less than or equal to 1 micron, less than or equal to 0.75 microns, less than or equal to 0.5 microns, or less than or equal to 0.2 microns. Staple fibers having a relatively small average fiber diameter may have an average fiber diameter of greater than or equal to 0.1 micron, greater than or equal to 0.2 microns, greater than or equal to 0.5 microns, greater than or equal to 0.75 microns, greater than or equal to 1 micron, or greater than or equal to 2 microns. Combinations of the above-referenced ranges are also possible (e.g., less than or equal to 3 microns and greater than or equal to 0.1 micron). Other ranges are also possible.

When a filter media comprises two or more non-woven fiber webs of the first type, each non-woven fiber web of the first type may independently comprise staple fibers having a relatively small average fiber diameter having an average fiber diameter in one or more of the above-referenced ranges.

In some embodiments, a non-woven fiber web of the first type comprises an appreciable number of staple fibers having a relatively large average fiber diameter. The staple fibers having the relatively large average fiber diameter may make up greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % of the fibers in a non-woven fiber web of the first type. The staple fibers having the relatively large average fiber diameter may make up less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, or less than or equal to 0.1 wt % of the fibers in a non-woven fiber web of the first type. Combinations of the above-referenced ranges are also possible (e.g., greater than or equal to 0 wt % and less than or equal to 100 wt %, greater than or equal to 0.1 wt % and less than or equal to 100 wt %, greater than or equal to 0.1 wt % and less than or equal to 10 wt %, or greater than or equal to 80 wt % and less than or equal to 100 wt %). Other ranges are also possible. In some embodiments, staple fibers having a relatively large average fiber diameter make up 0 wt % of the fibers in a non-woven fiber web of the first type. In some embodiments, staple fibers having a relatively large average fiber diameter make up 100 wt % of the fibers in a non-woven fiber web of the first type.

When a filter media comprises two or more non-woven fiber webs of the first type, each non-woven fiber web of the first type may independently comprise an amount of staple fibers having a relatively large average fiber diameter in one or more of the above-referenced ranges.

Staple fibers having a relatively large average fiber diameter may have an average fiber diameter of less than or equal to 50 microns, less than or equal to 40 microns, less than or equal to 30 microns, less than or equal to 20 microns, less than or equal to 15 microns, less than or equal to 10 microns, less than or equal to 7.5 microns, or less than or equal to 5 microns. Staple fibers having a relatively large average fiber diameter may have an average fiber diameter of greater than or equal to 3 microns, greater than or equal to 5 microns, greater than or equal to 7.5 microns, greater than or equal to 10 microns, greater than or equal to 15 microns, greater than or equal to 20 microns, greater than or equal to 30 microns, or greater than or equal to 40 microns. Combinations of the above-referenced ranges are also possible (e.g., less than or equal to 50 microns and greater than or equal to 3 microns). Other ranges are also possible.

When a filter media comprises two or more non-woven fiber webs of the first type, each non-woven fiber web of the first type may independently comprise staple fibers having a relatively large average fiber diameter having an average fiber diameter in one or more of the above-referenced ranges.

Staple fibers (of either and/or both of the above-referenced types) may have a variety of suitable lengths. In some embodiments, a non-woven fiber web of the first type comprises staple fibers having an average fiber length of greater than or equal to 0.5 mm, greater than or equal to 1 mm, greater than or equal to 2 mm, greater than or equal to 5 mm, greater than or equal to 7.5 mm, greater than or equal to 10 mm, greater than or equal to 12.5 mm, greater than or equal to 15 mm, greater than or equal to 17.5 mm, greater than or equal to 20 mm, greater than or equal to 25 mm, greater than or equal to 30 mm, greater than or equal to 40 mm, greater than or equal to 50 mm, greater than or equal to 60 mm, greater than or equal to 70 mm, greater than or equal to 80 mm, greater than or equal to 100 mm, or greater than or equal to 125 mm. In some embodiments, a non-woven fiber web of the first type comprises staple fibers having an average fiber length of less than or equal to 150 mm, less than or equal to 125 mm, less than or equal to 100 mm, less than or equal to 80 mm, less than or equal to 70 mm, less than or equal to 60 mm, less than or equal to 50 mm, less than or equal to 40 mm, less than or equal to 30 mm, less than or equal to 25 mm, less than or equal to 20 mm, less than or equal to 17.5 mm, less than or equal to 15 mm, less than or equal to 12.5 mm, less than or equal to 10 mm, less than or equal to 7.5 mm, less than or equal to 5 mm, less than or equal to 2 mm, or less than or equal to 1 mm. Combinations of the above-referenced ranges are also possible (e.g., greater than or equal to 0.5 mm and less than or equal to 150 mm, greater than or equal to 1 mm and less than or equal to 150 mm, greater than or equal to 1 mm and less than or equal to 80 mm, or greater than or equal to 1 mm and less than or equal to 20 mm). Other ranges are also possible.

When a non-woven fiber web of the first type comprises two or more types of staple fibers, each type of staple fiber may independently have an average fiber length in one or more of the ranges described above and/or all of the staple fibers in a non-woven fiber web of the first type may together have an average fiber length in one or more of the ranges described above. Similarly, when a filter media comprises two or more non-woven fiber webs of the first type, each non-woven fiber web of the first type may independently comprise one or more types of staple fibers having an average fiber length in one or more of the ranges described above and/or may comprise staple fibers that overall have an average fiber length in one or more of the ranges described above.

In some embodiments, a non-woven fiber web of the first type comprises fibrillated fibers. A fibrillated fiber may include a parent fiber that branches into smaller diameter fibrils, which can, in some instances, branch further out into even smaller diameter fibrils with further branching also being possible. The branched nature of the fibrils may enhance the surface area of a non-woven fiber web in which the fibrillated fibers are employed, and can increase the number of contact points between the fibrillated fibers and other fibers in the non-woven fiber web. Such an increase in points of contact between the fibrillated fibers and other fibers in the non-woven fiber web may enhance the mechanical properties (e.g., flexibility, strength) of the non-woven fiber web.

Fibrillated fibers may make up a variety of suitable amounts of the non-woven fiber webs of the first type described herein. In some embodiments, fibrillated fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % of the fibers in a non-woven fiber web of the first type. In some embodiments, fibrillated fibers make up less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in a non-woven fiber web of the first type. Combinations of the above-referenced ranges are also possible (e.g., greater than or equal to 0 wt % and less than or equal to 100 wt %, or greater than or equal to 10 wt % and less than or equal to 90 wt %). Other ranges are also possible. In some embodiments, fibrillated fibers make up 0 wt % of the fibers in a non-woven fiber web of the first type. In some embodiments, fibrillated fibers make up 100 wt % of the fibers in a non-woven fiber web of the first type.

When a non-woven fiber web of the first type comprises two or more types of fibrillated fibers, each type of fibrillated fiber may independently make up an amount of the fibers in the non-woven fiber web of the first type in one or more of the ranges described above and/or all of the fibrillated fibers in a non-woven fiber web of the first type may together make up an amount of the fibers in the non-woven fiber web of the first type in one or more of the ranges described above. Similarly, when a filter media comprises two or more non-woven fiber webs of the first type, each non-woven fiber web of the first type may independently comprise an amount of any particular type of fibrillated fiber in one or more of the ranges described above and/or may comprise a total amount of fibrillated fibers in one or more of the ranges described above.

Some fibrillated fibers comprise synthetic fibrillated fibers, non-limiting examples of which include poly(ester) fibers, poly(acrylonitrile) fibers, nylon fibers, poly(aramid) fibers (e.g., para-poly(aramid) fibers, meta-poly(aramid) fibers), poly(imide) fibers, poly(olefin) fibers (e.g., poly(ethylene) fibers, poly(propylene) fibers), poly(ether ether ketone) fibers, poly(ethylene terephthalate) fibers, acrylic fibers, liquid crystal polymeric fibers (e.g., poly(p-phenylene-2,6-benzobisoxazole fibers; poly(ester)-based liquid crystal polymers, such as fibers produced by the polycondensation of 4-hydroxybenzoic acid and 6-hydroxynaphthalene-2-carboxylic acid), nano-cellulose, regenerated cellulose (e.g., lyocell, rayon), celluloid, cellulose acetate, and carboxymethylcellulose. Such synthetic fibrillated fibers may also be considered to be a type of synthetic fiber as described elsewhere herein.

It is also possible for the fibrillated fibers to, alternatively or additionally, comprise natural fibers, such as natural cellulose fibers, cotton fibers, and/or wool. When a fiber web comprises natural cellulose fibers, the natural cellulose fibers may be wood (e.g., cedar) fibers, such as softwood fibers and/or hardwood fibers. It is also possible for the natural cellulose fibers to be non-wood fibers.

Exemplary softwood fibers include fibers obtained from mercerized southern pine (“mercerized southern pine fibers or HPZ fibers”), northern bleached softwood kraft (e.g., fibers obtained from Robur Flash (“Robur Flash fibers”)), southern bleached softwood kraft (e.g., fibers obtained from Brunswick pine (“Brunswick pine fibers”)), and/or chemically treated mechanical pulps (“CTMP fibers”). For example, HPZ fibers can be obtained from Buckeye Technologies, Inc., Memphis, Tenn.; Robur Flash fibers can be obtained from Rottneros AB, Stockholm, Sweden; and Brunswick pine fibers can be obtained from Georgia-Pacific, Atlanta, Ga.

Exemplary hardwood fibers include fibers obtained from Eucalyptus (“Eucalyptus fibers”). Eucalyptus fibers are commercially available from, e.g., (1) Suzano Group, Suzano, Brazil (“Suzano fibers”), (2) Group Portucel Soporcel, Cacia, Portugal (“Cacia fibers”), (3) Tembec, Inc., Temiscaming, QC, Canada (“Tarascon fibers”), (4) Kartonimex Intercell, Duesseldorf, Germany, (“Acacia fibers”), (5) Mead-Westvaco, Stamford, Conn. (“Westvaco fibers”), and (6) Georgia-Pacific, Atlanta, Ga. (“Leaf River fibers”).

When a filter media comprises two or more non-woven fiber webs of the first type, each non-woven fiber web of the first type may independently comprise one or more of the above-described types of fibrillated fibers.

Fibrillated fibers may comprise parent fibers having a variety of suitable average fiber diameters. In some embodiments, a non-woven fiber web comprises fibrillated fibers comprising parent fibers having an average fiber diameter of greater than or equal to 0.01 micron, greater than or equal to 0.02 microns, greater than or equal to 0.05 microns, greater than or equal to 0.075 microns, greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 30 microns, greater than or equal to 40 microns, greater than or equal to 50 microns, greater than or equal to 60 microns, or greater than or equal to 80 microns. In some embodiments, a non-woven fiber web comprises fibrillated fibers comprising parent fibers having an average fiber diameter of less than or equal to 100 microns, less than or equal to 80 microns, less than or equal to 60 microns, less than or equal to 50 microns, less than or equal to 40 microns, less than or equal to 30 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.2 microns, less than or equal to 0.1 micron, less than or equal to 0.075 microns, less than or equal to 0.05 microns, or less than or equal to 0.02 microns. Combinations of the above-referenced ranges are also possible (e.g., greater than or equal to 0.01 micron and less than or equal to 100 microns, greater than or equal to 0.1 micron and less than or equal to 20 microns, or greater than or equal to 0.1 micron and less than or equal to 10 microns). Other ranges are also possible.

When a non-woven fiber web of the first type comprises two or more types of fibrillated fibers, each type of fibrillated fiber may independently comprise parent fibers have an average fiber diameter in one or more of the ranges described above and/or all of the fibrillated fibers in a non-woven fiber web of the first type may together comprise parent fibers that have an average fiber diameter in one or more of the ranges described above. Similarly, when a filter media comprises two or more non-woven fiber webs of the first type, each non-woven fiber web of the first type may independently comprise one or more types of fibrillated fibers comprising parent fibers having an average fiber diameter in one or more of the ranges described above and/or may comprise fibrillated fibers comprising parent fibers that overall have an average fiber diameter in one or more of the ranges described above.

Fibrillated fibers may comprise fibrils having a variety of suitable average fiber diameters. In some embodiments, a non-woven fiber web comprises fibrillated fibers comprising fibrils having an average fiber diameter of greater than or equal to 0.01 micron, greater than or equal to 0.02 microns, greater than or equal to 0.05 microns, greater than or equal to 0.075 microns, greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 30 microns, greater than or equal to 40 microns, greater than or equal to 50 microns, greater than or equal to 60 microns, or greater than or equal to 80 microns. In some embodiments, a non-woven fiber web comprises fibrillated fibers comprising fibrils having an average fiber diameter of less than or equal to 99.99 microns, less than or equal to 80 microns, less than or equal to 60 microns, less than or equal to 50 microns, less than or equal to 40 microns, less than or equal to 30 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.2 microns, less than or equal to 0.1 micron, less than or equal to 0.075 microns, less than or equal to 0.05 microns, or less than or equal to 0.02 microns. Combinations of the above-referenced ranges are also possible (e.g., greater than or equal to 0.01 micron and less than or equal to 99.99 microns, or greater than or equal to 0.1 micron and less than or equal to 90 microns). Other ranges are also possible.

When a non-woven fiber web of the first type comprises two or more types of fibrillated fibers, each type of fibrillated fiber may independently comprise fibrils have an average fiber diameter in one or more of the ranges described above and/or all of the fibrillated fibers in a non-woven fiber web of the first type may together comprise fibrils that have an average fiber diameter in one or more of the ranges described above. Similarly, when a filter media comprises two or more non-woven fiber webs of the first type, each non-woven fiber web of the first type may independently comprise one or more types of fibrillated fibers comprising fibrils having an average fiber diameter in one or more of the ranges described above and/or may comprise fibrillated fibers comprising fibrils that overall have an average fiber diameter in one or more of the ranges described above.

Fibrillated fibers may have a variety of suitable average lengths. In some embodiments, a non-woven fiber web of the first type comprise fibrillated fibers having an average length of greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, greater than or equal to 7.5 mm, greater than or equal to 10 mm, greater than or equal to 15 mm, greater than or equal to 20 mm, greater than or equal to 30 mm, greater than or equal to 40 mm, greater than or equal to 50 mm, greater than or equal to 60 mm, greater than or equal to 70 mm, greater than or equal to 80 mm, greater than or equal to 100 mm, or greater than or equal to 125 mm. In some embodiments, a non-woven fiber web of the first type comprises fibrillated fibers having an average length of less than or equal to 150 mm, less than or equal to 125 mm, less than or equal to 100 mm, less than or equal to 80 mm, less than or equal to 70 mm, less than or equal to 60 mm, less than or equal to 50 mm, less than or equal to 40 mm, less than or equal to 30 mm, less than or equal to 20 mm, less than or equal to 15 mm, less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, or less than or equal to 0.2 mm. Combinations of the above-referenced ranges are also possible (e.g., greater than or equal to 0.1 mm and less than or equal to 150 mm, or greater than or equal to 1 mm and less than or equal to 80 mm). Other ranges are also possible.

When a non-woven fiber web of the first type comprises two or more types of fibrillated fibers, each type of fibrillated fiber may independently have an average fiber length in one or more of the ranges described above and/or all of the fibrillated fibers in a non-woven fiber web of the first type may together have an average fiber length in one or more of the ranges described above. Similarly, when a filter media comprises two or more non-woven fiber webs of the first type, each non-woven fiber web of the first type may independently comprise one or more types of fibrillated fibers having an average fiber length in one or more of the ranges described above and/or may comprise fibrillated fibers that overall have an average fiber length in one or more of the ranges described above.

Fibrillated fibers may have a variety of suitable average levels of fibrillation. In some embodiments, a non-woven fiber web of the first type comprises fibrillated fibers having an average level of fibrillation of greater than or equal to 0.1 mL, greater than or equal to 0.2 mL, greater than or equal to 0.5 mL, greater than or equal to 0.75 mL, greater than or equal to 1 mL, greater than or equal to 2 mL, greater than or equal to 5 mL, greater than or equal to 7.5 mL, greater than or equal to 10 mL, greater than or equal to 20 mL, greater than or equal to 50 mL, greater than or equal to 75 mL, greater than or equal to 100 mL, greater than or equal to 125 mL, greater than or equal to 150 mL, greater than or equal to 175 mL, greater than or equal to 200 mL, greater than or equal to 250 mL, greater than or equal to 300 mL, greater than or equal to 400 mL, greater than or equal to 500 mL, greater than or equal to 600 mL, or greater than or equal to 700 mL. In some embodiments, a non-woven fiber web of the first type comprises fibrillated fibers having an average level of fibrillation of less than or equal to 800 mL, less than or equal to 700 mL, less than or equal to 600 mL, less than or equal to 500 mL, less than or equal to 400 mL, less than or equal to 300 mL, less than or equal to 250 mL, less than or equal to 200 mL, less than or equal to 175 mL, less than or equal to 150 mL, less than or equal to 125 mL, less than or equal to 100 mL, less than or equal to 75 mL, less than or equal to 50 mL, less than or equal to 20 mL, less than or equal to 10 mL, less than or equal to 7.5 mL, less than or equal to 5 mL, less than or equal to 2 mL, less than or equal to 1 mL, less than or equal to 0.75 mL, less than or equal to 0.5 mL, or less than or equal to 0.2 mL. Combinations of the above-referenced ranges are also possible (e.g., greater than or equal to 0.1 mL and less than or equal to 800 mL, greater than or equal to 50 mL and less than or equal to 500 mL, or greater than or equal to 100 mL and less than or equal to 200 mL). Other ranges are also possible.

The average level of fibrillation of fibrillated fibers can be measured according to a Canadian Standard Freeness test, specified by TAPPI test method T-227-om-09 Freeness of pulp (2009). The test can provide an average CSF value in mL. This average level of fibrillation is a characteristic of the plurality of fibers being measured. In other words, a plurality of fibers having a certain average level of fibrillation may comprise some fibers that have a higher degree of fibrillation than that average and some fibers that have a lower degree of fibrillation than that average. It is also possible for a plurality of fibers to comprise, consist essentially of, and/or consist of, fibers having a level of fibrillation that is identical to the average level of fibrillation for the plurality.

When a non-woven fiber web of the first type comprises two or more types of fibrillated fibers, each type of fibrillated fiber may independently have an average level of fibrillation in one or more of the ranges described above and/or all of the fibrillated fibers in a non-woven fiber web of the first type may together have an average level of fibrillation in one or more of the ranges described above. Similarly, when a filter media comprises two or more non-woven fiber webs of the first type, each non-woven fiber web of the first type may independently comprise one or more types of fibrillated fibers having an average level of fibrillation in one or more of the ranges described above and/or may comprise fibrillated fibers that overall have an average level of fibrillation in one or more of the ranges described above.

In some embodiments, a non-woven fiber web of the first type comprises binder fibers. The binder fibers may comprise monocomponent binder fibers and/or multicomponent fibers. In some embodiments, binder fibers make up greater than or equal to 0 wt %, greater than or equal to 1 wt %, greater than or equal to 1.25 wt %, greater than or equal to 1.5 wt %, greater than or equal to 1.75 wt %, greater than or equal to 2 wt %, greater than or equal to 2.25 wt %, greater than or equal to 2.5 wt %, greater than or equal to 3 wt %, greater than or equal to 4 wt %, greater than or equal to 5 wt %, greater than or equal to 6 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, greater than or equal to 35 wt %, greater than or equal to 40 wt %, greater than or equal to 45 wt %, greater than or equal to 50 wt %, greater than or equal to 60 wt %, greater than or equal to 70 wt %, greater than or equal to 80 wt %, or greater than or equal to 90 wt % of the fibers in a non-woven fiber web of the first type. In some embodiments, binder fibers make up less than or equal to 100 wt %, less than or equal to 90 wt %, less than or equal to 80 wt %, less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 6 wt %, less than or equal to 5 wt %, less than or equal to 4 wt %, less than or equal to 3 wt %, less than or equal to 2.5 wt %, less than or equal to 2.25 wt %, less than or equal to 2 wt %, less than or equal to 1.75 wt %, less than or equal to 1.5 wt %, less than or equal to 1.25 wt %, or less than or equal to 1 wt % of the fibers in a non-woven fiber web of the first type. Combinations of the above-referenced ranges are also possible (e.g., greater than or equal to 0 wt % and less than or equal to 100 wt %, greater than or equal to 1 wt % and less than or equal to 50 wt %, or greater than or equal to 2 wt % and less than or equal to 10 wt %). Other ranges are also possible. In some embodiments, binder fibers make up 0 wt % of the fibers in a non-woven fiber web of the first type. In some embodiments, binder fibers make up 100 wt % of the fibers in a non-woven fiber web of the first type.

When a non-woven fiber web of the first type comprises two or more types of binder fibers, each type of binder fiber may independently make up an amount of the fibers in the non-woven fiber web of the first type in one or more of the ranges described above and/or all of the binder fibers in a non-woven fiber web of the first type may together make up an amount of the fibers in the non-woven fiber web in one or more of the ranges described above. Similarly, when a filter media comprises two or more non-woven fiber webs of the first type, each non-woven fiber web of the first type may independently comprise an amount of any particular type of binder fiber in one or more of the ranges described above and/or may comprise a total amount of binder fibers in one or more of the ranges described above.

Binder fibers that are multicomponent fibers may comprise bicomponent fibers (i.e., fibers including two components), may comprise tricomponent fibers (i.e., fibers including three components), and/or may comprise fibers comprising four or more components. Multicomponent fibers may have a variety of suitable structures. For instance, a non-woven fiber web may comprise one or more of the following types of bicomponent fibers: core/sheath fibers (e.g., concentric core/sheath fibers, non-concentric core-sheath fibers), segmented pie fibers, side-by-side fibers, tip-trilobal fibers, split fibers, and “island in the sea” fibers. Core-sheath bicomponent fibers may comprise a sheath that has a lower melting point than that of the core. When heated (e.g., during a binding step), the sheath may melt prior to the core, binding the fibers together while the core remains solid. In such embodiments, the multicomponent fibers may serve as a binder for the non-woven fiber web of the first type.

Non-limiting examples of suitable materials that may be included in binder fibers include poly(olefin)s such as poly(ethylene), poly(propylene), and poly(butylene); poly(ester)s and co-poly(ester)s such as poly(ethylene terephthalate), co-poly(ethylene terephthalate), poly(butylene terephthalate), and poly(ethylene isophthalate); poly(amide)s and co-poly(amides) such as nylons and aramids; halogenated polymers such as poly(tetrafluoroethylene); epoxy; phenolic resins; and melamine. Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

As can be seen from the preceding paragraph, binder fibers may comprise one or more components that are synthetic. In such embodiments, the binder fibers may be considered to be a type of synthetic fiber.

Non-limiting examples of suitable pairs of materials that may be included in binder fibers that are multicomponent fibers include poly(ethylene)/poly(ester) (e.g., poly(ethylene)/poly(ethylene terephthalate)), poly(propylene)/poly(ester) (e.g., poly(propylene)/poly(ethylene terephthalate)), co-poly(ester)/poly(ester) (e.g., co-poly(ethylene terephthalate)/poly(ethylene terephthalate)), poly(butylene terephthalate)/poly(ethylene terephthalate), co-poly(amide)/poly(amide), poly(amide)/poly(propylene), and poly(ethylene)/poly(propylene). In the preceding list, the material having the lower melting point is listed first and the material having the higher melting point is listed second. Core-sheath bicomponent fibers comprising one of the above such pairs may have a sheath comprising the first material and a core comprising the second material. In some embodiments, core-sheath bicomponent fibers comprise a core that comprises a thermoset polymer and a sheath that comprises a thermoplastic polymer.

The binder fibers described herein may comprise components having a variety of suitable melting points. In some embodiments, a binder fiber comprises a component having a melting point of greater than or equal to 70° C., greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., greater than or equal to 220° C., greater than or equal to 250° C., greater than or equal to 300° C., greater than or equal to 250° C., greater than or equal to 300° C., greater than or equal to 350° C., or greater than or equal to 400° C. In some embodiments, a binder fiber comprises a component having a melting point less than or equal to 450° C., less than or equal to 400° C., less than or equal to 350° C., less than or equal to 300° C., less than or equal to 250° C., less than or equal to 230° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., less than or equal to 90° C., or less than or equal to 80° C. Combinations of the above-referenced ranges are also possible (e.g., greater than or equal to 70° C. and less than or equal to 450° C., greater than or equal to 80° C. and less than or equal to 450° C., greater than or equal to 80° C. and less than or equal to 230° C., or greater than or equal to 110° C. and less than or equal to 230° C.). Other ranges are also possible. In some embodiments, a binder fiber comprises a component having a melting point of less than or equal to 100° C.

The melting point of the components of a binder fiber may be determined by performing differential scanning calorimetry. The differential scanning calorimetry measurement may be carried out by heating the binder fiber to 500° C. at 20° C./minute, cooling the binder fiber to room temperature, and then determining the melting point during a reheating to 500° C. at 20° C./minute.

When a binder fiber comprises two components, each component may independently have a melting point in one or more of the above-referenced ranges. Binder fibers comprising two or more components may comprise exclusively components having the same melting point, exclusively components having different melting points, or at least one pair of components that have the same melting point and at least one pair of components that have different melting points.

In some embodiments, a binder fiber comprises two components that have melting points that differ by greater than or equal to 50° C., greater than or equal to 75° C., greater than or equal to 100° C., greater than or equal to 125° C., greater than or equal to 150° C., greater than or equal to 175° C., greater than or equal to 200° C., greater than or equal to 225° C., greater than or equal to 250° C., greater than or equal to 275° C., greater than or equal to 300° C., greater than or equal to 325° C., or greater than or equal to 350° C. In some embodiments, a binder fiber comprises two components that have melting points that differ by less than or equal to 380° C., less than or equal to 350° C., less than or equal to 325° C., less than or equal to 300° C., less than or equal to 275° C., less than or equal to 250° C., less than or equal to 225° C., less than or equal to 200° C., less than or equal to 175° C., less than or equal to 150° C., less than or equal to 125° C., less than or equal to 100° C., or less than or equal to 75° C. Combinations of the above-referenced ranges are also possible (e.g., greater than or equal to 50° C. and less than or equal to 75° C.). Other ranges are also possible.

When a filter media comprises two or more non-woven fiber webs of the first type, each non-woven fiber web of the first type may independently comprise one or more of the above-described types of binder fibers.

Binder fibers may have a variety of suitable average fiber diameters. In some embodiments, a non-woven fiber web of the first type comprises binder fibers having an average fiber diameter of greater than or equal to 0.01 micron, greater than or equal to 0.02 microns, greater than or equal to 0.05 microns, greater than or equal to 0.075 microns, greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 30 microns, greater than or equal to 35 microns, greater than or equal to 40 microns, or greater than or equal to 45 microns. In some embodiments, a non-woven fiber web of the first type comprises binder fibers having an average fiber diameter of less than or equal to 50 microns, less than or equal to 45 microns, less than or equal to 40 microns, less than or equal to 35 microns, less than or equal to 30 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2 microns, less than or equal to 1 micron, less than or equal to 0.75 microns, less than or equal to 0.5 microns, less than or equal to 0.2 microns, less than or equal to 0.1 micron, less than or equal to 0.075 microns, less than or equal to 0.05 microns, or less than or equal to 0.02 microns. Combinations of the above-referenced ranges are also possible (e.g., greater than or equal to 0.01 micron and less than or equal to 50 microns, greater than or equal to 1 micron and less than or equal to 20 microns, or greater than or equal to 5 microns and less than or equal to 20 microns). Other ranges are also possible.

When a non-woven fiber web of the first type comprises two or more types of binder fibers, each type of binder fiber may independently have an average fiber diameter in one or more of the ranges described above and/or all of the binder fibers in a non-woven fiber web of the first type may together have an average fiber diameter in one or more of the ranges described above. Similarly, when a filter media comprises two or more non-woven fiber webs of the first type, each non-woven fiber web of the first type may independently comprise one or more types of binder fibers having an average fiber diameter in one or more of the ranges described above and/or may comprise binder fibers that overall have an average fiber diameter in one or more of the ranges described above.

Binder fibers may have a variety of suitable average fiber lengths. In some embodiments, a non-woven fiber web of the first type comprises binder fibers having an average fiber length of greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 3 mm, greater than or equal to 4 mm, greater than or equal to 5 mm, greater than or equal to 7.5 mm, greater than or equal to 10 mm, greater than or equal to 12.5 mm, greater than or equal to 15 mm, greater than or equal to 17.5 mm, greater than or equal to 20 mm, greater than or equal to 25 mm, greater than or equal to 30 mm, greater than or equal to 40 mm, greater than or equal to 50 mm, greater than or equal to 60 mm, greater than or equal to 70 mm, greater than or equal to 80 mm, greater than or equal to 100 mm, or greater than or equal to 125 mm. In some embodiments, a non-woven fiber web of the first type comprises binder fibers having an average fiber length of less than or equal to 150 mm, less than or equal to 125 mm, less than or equal to 100 mm, less than or equal to 80 mm, less than or equal to 70 mm, less than or equal to 60 mm, less than or equal to 50 mm, less than or equal to 40 mm, less than or equal to 30 mm, less than or equal to 25 mm, less than or equal to 20 mm, less than or equal to 17.5 mm, less than or equal to 15 mm, less than or equal to 12.5 mm, less than or equal to 10 mm, less than or equal to 7.5 mm, less than or equal to 5 mm, less than or equal to 4 mm, less than or equal to 3 mm, less than or equal to 2 mm, less than or equal to 1 mm, less than or equal to 0.75 mm, less than or equal to 0.5 mm, or less than or equal to 0.2 mm. Combinations of the above-referenced ranges are also possible (e.g., greater than or equal to 0.1 mm and less than or equal to 150 mm, greater than or equal to 1 mm and less than or equal to 80 mm, or greater than or equal to 3 mm and less than or equal to 20 mm). Other ranges are also possible.

When a non-woven fiber web of the first type comprises two or more types of binder fibers, each type of binder fiber may independently have an average fiber length in one or more of the ranges described above and/or all of the binder fibers in a non-woven fiber web of the first type may together have an average fiber length in one or more of the ranges described above. Similarly, when a filter media comprises two or more non-woven fiber webs of the first type, each non-woven fiber web of the first type may independently comprise one or more types of binder fibers having an average fiber length in one or more of the ranges described above and/or may comprise binder fibers that overall have an average fiber length in one or more of the ranges described above.

In some embodiments, a non-woven fiber web of the first type comprises glass fibers. In some embodiments, glass fibers make up greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 60 wt %, greater than or equal to 70 wt %, greater than or equal to 80 wt %, or greater than or equal to 90 wt % of the fibers in a non-woven fiber web of the first type. In some embodiments, glass fibers make up less than or equal to 100 wt %, less than or equal to 90 wt %, less than or equal to 80 wt %, less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, or less than or equal to 0.1 wt % of the fibers in a non-woven fiber web of the first type. Combinations of the above-referenced ranges are also possible (e.g., greater than or equal to 0 wt % and less than or equal to 100 wt %, greater than or equal to 0.1 wt % and less than or equal to 50 wt %, or greater than or equal to 1 wt % and less than or equal to 20 wt %). Other ranges are also possible. In some embodiments, glass fibers make up 0 wt % of the fibers in a non-woven fiber web of the first type. In some embodiments, glass fibers make up 100 wt % of the fibers in a non-woven fiber web of the first type.

When a non-woven fiber web of the first type comprises two or more types of glass fibers, each type of glass fiber may independently make up an amount of the fibers in the non-woven fiber web of the first type in one or more of the ranges described above and/or all of the glass fibers in a non-woven fiber web of the first type may together make up an amount of the fibers in the non-woven fiber web of the first type in one or more of the ranges described above. Similarly, when a filter media comprises two or more non-woven fiber webs of the first type, each non-woven fiber web of the first type may independently comprise an amount of any particular type of glass fiber in one or more of the ranges described above and/or may comprise a total amount of glass fibers in one or more of the ranges described above.

Glass fibers may have a variety of suitable average fiber diameters. In some embodiments, a non-woven fiber web of the first type comprises glass fibers having an average fiber diameter of greater than or equal to 0.01 micron, greater than or equal to 0.02 microns, greater than or equal to 0.05 microns, greater than or equal to 0.075 microns, greater than or equal to 0.1 micron, greater than or equal to 0.25 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 25 microns, greater than or equal to 30 microns, or greater than or equal to 35 microns. In some embodiments, a non-woven fiber web of the first type comprises glass fibers having an average fiber diameter of less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.25 microns, less than or equal to 0.1 micron, less than or equal to 0.075 microns, less than or equal to 0.05 microns, or less than or equal to 0.02 microns. Combinations of the above-referenced ranges are also possible (e.g., greater than or equal to 0.01 micron and less than or equal to 40 microns, greater than or equal to 0.1 micron and less than or equal to 20 microns, or greater than or equal to 0.1 micron and less than or equal to 20 microns). Other ranges are also possible.

When a non-woven fiber web of the first type comprises two or more types of glass fibers, each type of glass fiber may independently have an average fiber diameter in one or more of the ranges described above and/or all of the glass fibers in a non-woven fiber web of the first type may together have an average fiber diameter in one or more of the ranges described above. Similarly, when a filter media comprises two or more non-woven fiber webs of the first type, each non-woven fiber web of the first type may independently comprise one or more types of glass fibers having an average fiber diameter in one or more of the ranges described above and/or may comprise glass fibers that overall have an average fiber diameter in one or more of the ranges described above.

Glass fibers may have a variety of suitable average fiber lengths. In some embodiments, a non-woven fiber web of the first type comprises glass fibers having an average fiber length of greater than or equal to 0.01 mm, greater than or equal to 0.02 mm, greater than or equal to 0.05 mm, greater than or equal to 0.075 mm, greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, greater than or equal to 7.5 mm, greater than or equal to 10 mm, greater than or equal to 20 mm, greater than or equal to 30 mm, greater than or equal to 40 mm, greater than or equal to 50 mm, greater than or equal to 75 mm, or greater than or equal to 100 mm. In some embodiments, a non-woven fiber web of the first type comprises glass fibers having an average fiber length of less than or equal to 125 mm, less than or equal to 100 mm, less than or equal to 75 mm, less than or equal to 50 mm, less than or equal to 40 mm, less than or equal to 30 mm, less than or equal to 20 mm, less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, less than or equal to 0.2 mm, less than or equal to 0.1 mm, less than or equal to 0.075 mm, less than or equal to 0.05 mm, or less than or equal to 0.02 mm. Combinations of the above-referenced ranges are also possible (e.g., greater than or equal to 0.01 mm and less than or equal to 125 mm, greater than or equal to 0.01 mm and less than or equal to 125 mm, greater than or equal to 1 mm and less than or equal to 50 mm, or greater than or equal to 1 mm and less than or equal to 50 mm). Other ranges are also possible.

When a non-woven fiber web of the first type comprises two or more types of glass fibers, each type of glass fiber may independently have an average fiber length in one or more of the ranges described above and/or all of the glass fibers in a non-woven fiber web of the first type may together have an average fiber length in one or more of the ranges described above. Similarly, when a filter media comprises two or more non-woven fiber webs of the first type, each non-woven fiber web of the first type may independently comprise one or more types of glass fibers having an average fiber length in one or more of the ranges described above and/or may comprise glass fibers that overall have an average fiber length in one or more of the ranges described above.

In some embodiments, a non-woven fiber web of the first type comprises glass fibers that are microglass fibers. In some embodiments, microglass fibers make up greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 60 wt %, greater than or equal to 70 wt %, greater than or equal to 80 wt %, or greater than or equal to 90 wt % of the fibers in a non-woven fiber web of the first type. In some embodiments, microglass fibers make up less than or equal to 100 wt %, less than or equal to 90 wt %, less than or equal to 80 wt %, less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, or less than or equal to 0.1 wt % of the fibers in a non-woven fiber web of the first type. Combinations of the above-referenced ranges are also possible (e.g., greater than or equal to 0 wt % and less than or equal to 100 wt %, greater than or equal to 0.1 wt % and less than or equal to 50 wt %, or greater than or equal to 1 wt % and less than or equal to 20 wt %). Other ranges are also possible. In some embodiments, microglass fibers make up 0 wt % of the fibers in a non-woven fiber web of the first type. In some embodiments, microglass fibers make up 100 wt % of the fibers in a non-woven fiber web of the first type.

When a non-woven fiber web of the first type comprises two or more types of microglass fibers, each type of microglass fiber may independently make up an amount of the fibers in the non-woven fiber web of the first type in one or more of the ranges described above and/or all of the microglass fibers in a non-woven fiber web of the first type may together make up an amount of the fibers in the non-woven fiber web of the first type in one or more of the ranges described above. Similarly, when a filter media comprises two or more non-woven fiber webs of the first type, each non-woven fiber web of the first type may independently comprise an amount of any particular type of microglass fiber in one or more of the ranges described above and/or may comprise a total amount of microglass fibers in one or more of the ranges described above.

Suitable microglass fibers may be fibers drawn from bushing tips and further subjected to flame blowing or rotary spinning processes. In some cases, microglass fibers may be made using a remelting process. The microglass fibers may be microglass fibers for which alkali metal oxides (e.g., sodium oxides, magnesium oxides) make up 10-20 wt % of the fibers. Such fibers may have relatively lower melting and processing temperatures. Non-limiting examples of microglass fibers are M glass fibers according to Man Made Vitreous Fibers by Nomenclature Committee of TIMA Inc. March 1993, Page 45, C glass fibers (e.g., Lauscha C glass fibers, JM 253 C glass fibers), and non-persistent glass fibers (e.g., fibers that are configured to dissolve completely in the fluid present in human lungs in less than or equal to 40 days, such as Johns Manville 481 fibers). It should be understood that a plurality of microglass fibers may comprise one or more of the types of microglass fibers described herein.

Microglass may have a variety of suitable average fiber diameters. In some embodiments, a non-woven fiber web of the first type comprises microglass fibers having an average fiber diameter of greater than or equal to 0.01 micron, greater than or equal to 0.02 microns, greater than or equal to 0.05 microns, greater than or equal to 0.075 microns, greater than or equal to 0.1 micron, greater than or equal to 0.15 microns, greater than or equal to 0.2 microns, greater than or equal to 0.25 microns, greater than or equal to 0.3 microns, greater than or equal to 0.35 microns, greater than or equal to 0.4 microns, greater than or equal to 0.5 microns, greater than or equal to 0.6 microns, greater than or equal to 0.8 microns, greater than or equal to 1 micron, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 6 microns, or greater than or equal to 8 microns. In some embodiments, a non-woven fiber web of the first type comprises microglass fibers having an average fiber diameter of less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, less than or equal to 1.5 microns, less than or equal to 1 micron, less than or equal to 0.8 microns, less than or equal to 0.6 microns, less than or equal to 0.5 microns, less than or equal to 0.4 microns, less than or equal to 0.35 microns, less than or equal to 0.3 microns, less than or equal to 0.25 microns, less than or equal to 0.2 microns, less than or equal to 0.15 microns, less than or equal to 0.1 micron, less than or equal to 0.075 microns, less than or equal to 0.05 microns, or less than or equal to 0.02 microns. Combinations of the above-referenced ranges are also possible (e.g., greater than or equal to 0.01 micron and less than or equal to 10 microns, greater than or equal to 0.01 micron and less than or equal to 6 microns, greater than or equal to 0.1 micron and less than or equal to 10 microns, greater than or equal to 0.2 microns and less than or equal to 6 microns, or greater than or equal to 0.3 microns and less than or equal to 2 microns). Other ranges are also possible.

When a non-woven fiber web of the first type comprises two or more types of microglass fibers, each type of microglass fiber may independently have an average fiber diameter in one or more of the ranges described above and/or all of the microglass fibers in a non-woven fiber web of the first type may together have an average fiber diameter in one or more of the ranges described above. Similarly, when a filter media comprises two or more non-woven fiber webs of the first type, each non-woven fiber web of the first type may independently comprise one or more types of microglass fibers having an average fiber diameter in one or more of the ranges described above and/or may comprise microglass fibers that overall have an average fiber diameter in one or more of the ranges described above.

Microglass fibers may have a variety of suitable lengths. In some embodiments, a non-woven fiber web of the first type comprises microglass fibers having an average fiber length in one or more of the ranges described elsewhere herein with respect to the average lengths of glass fibers.

In some embodiments, a non-woven fiber web of the first type comprises glass fibers that are chopped strand glass fibers. In some embodiments, chopped strand glass fibers make up greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 60 wt %, greater than or equal to 70 wt %, greater than or equal to 80 wt %, or greater than or equal to 90 wt % of the fibers in a non-woven fiber web of the first type. In some embodiments, chopped strand glass fibers make up less than or equal to 100 wt %, less than or equal to 90 wt %, less than or equal to 80 wt %, less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, or less than or equal to 0.1 wt % of the fibers in a non-woven fiber web of the first type. Combinations of the above-referenced ranges are also possible (e.g., greater than or equal to 0 wt % and less than or equal to 100 wt %, greater than or equal to 0.1 wt % and less than or equal to 50 wt %, or greater than or equal to 1 wt % and less than or equal to 20 wt %). Other ranges are also possible. In some embodiments, chopped strand glass fibers make up 0 wt % of the fibers in a non-woven fiber web of the first type. In some embodiments, chopped strand glass fibers make up 100 wt % of the fibers in a non-woven fiber web of the first type.

When a non-woven fiber web of the first type comprises two or more types of chopped strand glass fibers, each type of chopped strand glass fiber may independently make up an amount of the fibers in the non-woven fiber web of the first type in one or more of the ranges described above and/or all of the chopped strand glass fibers in a non-woven fiber web of the first type may together make up an amount of the fibers in the non-woven fiber web of the first type in one or more of the ranges described above. Similarly, when a filter media comprises two or more non-woven fiber webs of the first type, each non-woven fiber web of the first type may independently comprise an amount of any particular type of chopped strand glass fiber in one or more of the ranges described above and/or may comprise a total amount of chopped strand glass fibers in one or more of the ranges described above.

Suitable chopped strand glass fibers may comprise chopped strand glass fibers which were produced by drawing a melt of glass from bushing tips into continuous fibers and then cutting the continuous fibers into short fibers. In some embodiments, a non-woven fiber web of the first type comprises chopped strand glass fibers for which alkali metal oxides (e.g., sodium oxides, magnesium oxides) make up a relatively low amount of the fibers. It is also possible for a non-woven fiber web of the first type to comprise chopped strand glass fibers that include relatively large amounts of calcium oxide and/or alumina (Al₂O₃). In some embodiments, a porous layer comprises S-glass fibers, which include approximately 10 wt % magnesium oxide. It should be understood that chopped strand glass fibers present in a non-woven fiber web of the first type may comprise one or more of the types of chopped strand glass fibers described herein.

Chopped strand glass fibers may have a variety of suitable average fiber diameters. In some embodiments, a non-woven fiber web of the first type comprises chopped strand glass fibers having an average fiber diameter of greater than or equal to 5 microns, greater than or equal to 6 microns, greater than or equal to 6.5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, or greater than or equal to 35 microns. In some embodiments, a non-woven fiber web of the first type comprises chopped strand glass fibers having an average fiber diameter of less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 6.5 microns, or less than or equal to 6 microns. Combinations of the above-referenced ranges are also possible (e.g., greater than or equal to 5 microns and less than or equal to 40 microns). Other ranges are also possible.

When a non-woven fiber web of the first type comprises two or more types of chopped strand glass fibers, each type of chopped strand glass fiber may independently have an average fiber diameter in one or more of the ranges described above and/or all of the chopped strand glass fibers in a non-woven fiber web of the first type may together have an average fiber diameter in one or more of the ranges described above. Similarly, when a filter media comprises two or more non-woven fiber webs of the first type, each non-woven fiber web of the first type may independently comprise one or more types of chopped strand glass fibers having an average fiber diameter in one or more of the ranges described above and/or may comprise chopped strand glass fibers that overall have an average fiber diameter in one or more of the ranges described above.

Chopped strand glass fibers may have a variety of suitable lengths. In some embodiments, a non-woven fiber web of the first type comprises chopped strand glass fibers having an average fiber length of greater than or equal to 0.125 inches, greater than or equal to 0.15 inches, greater than or equal to 0.2 inches, greater than or equal to 0.25 inches, greater than or equal to 0.3 inches, greater than or equal to 0.4 inches, greater than or equal to 0.5 inches, greater than or equal to 0.6 inches, or greater than or equal to 0.8 inches. In some embodiments, a non-woven fiber web of the first type comprises chopped strand glass fibers having an average fiber length of less than or equal to 1 inch, less than or equal to 0.8 inches, less than or equal to 0.6 inches, less than or equal to 0.5 inches, less than or equal to 0.4 inches, less than or equal to 0.3 inches, less than or equal to 0.25 inches, less than or equal to 0.2 inches, or less than or equal to 0.15 inches. Combinations of the above-referenced ranges are also possible (e.g., greater than or equal to 0.125 inches and less than or equal to 1 inch, or greater than or equal to 0.25 inches and less than or equal to 0.5 inches). Other ranges are also possible.

When a non-woven fiber web of the first type comprises two or more types of chopped strand glass fibers, each type of chopped strand glass fiber may independently have an average fiber length in one or more of the ranges described above and/or all of the chopped strand glass fibers in a non-woven fiber web of the first type may together have an average fiber length in one or more of the ranges described above. Similarly, when a filter media comprises two or more non-woven fiber webs of the first type, each non-woven fiber web of the first type may independently comprise one or more types of chopped strand glass fibers having an average fiber length in one or more of the ranges described above and/or may comprise chopped strand glass fibers that overall have an average fiber length in one or more of the ranges described above.

In some embodiments, a non-woven fiber web of the first type comprises a binder resin. In some embodiments, the binder resin makes up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, or greater than or equal to 40 wt % of a non-woven fiber web of the first type. In some embodiments, the binder resin makes up less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of a non-woven fiber web of the first type. Combinations of the above-referenced ranges are also possible (e.g., greater than or equal to 0 wt % and less than or equal to 45 wt %, greater than or equal to 0 wt % and less than or equal to 40 wt %, or greater than or equal to 0 wt % and less than or equal to 30 wt %). Other ranges are also possible. In some embodiments, the binder resin makes up 0 wt % of a non-woven fiber web of the first type.

When a non-woven fiber web of the first type comprises two or more types of binder resins, each type of binder resin may independently make up an amount of the non-woven fiber web of the first type in one or more of the ranges described above and/or all of the binder resins in a non-woven fiber web of the first type may together make up an amount of the non-woven fiber web of the first type in one or more of the ranges described above. Similarly, when a filter media comprises two or more non-woven fiber webs of the first type, each non-woven fiber web of the first type may independently comprise an amount of any particular type of binder resin in one or more of the ranges described above and/or may comprise a total amount of binder resin in one or more of the ranges described above.

Non-limiting examples of suitable binder resins include thermoplastic polymers (e.g., acrylics, poly(vinylacetate), poly(ester)s, poly(amide)s), thermosetting polymers (e.g., epoxy, phenolic resin, melamine), and combinations thereof. In some cases, a binder resin includes one or more of a vinyl acetate resin, an epoxy resin, a poly(ester) resin, a copoly(ester) resin, a poly(vinyl alcohol) resin, an acrylic resin (e.g., a styrene acrylic resin), and a phenolic resin. Other resins are also possible.

When a filter media comprises two or more non-woven fiber webs of the first type, each non-woven fiber web of the first type may independently comprise some or all of the above types of binder resins.

The non-woven fiber webs of the first type described herein may have a variety of suitable basis weights. In some embodiments, a non-woven fiber web of the first type has a basis weight of greater than or equal to 10 gsm, greater than or equal to 15 gsm, greater than or equal to 20 gsm, greater than or equal to 25 gsm, greater than or equal to 30 gsm, greater than or equal to 40 gsm, greater than or equal to 50 gsm, greater than or equal to 75 gsm, greater than or equal to 100 gsm, greater than or equal to 125 gsm, greater than or equal to 150 gsm, greater than or equal to 175 gsm, greater than or equal to 200 gsm, greater than or equal to 225 gsm, greater than or equal to 250 gsm, greater than or equal to 275 gsm, greater than or equal to 300 gsm, greater than or equal to 325 gsm, greater than or equal to 350 gsm, greater than or equal to 375 gsm, greater than or equal to 400 gsm, greater than or equal to 425 gsm, greater than or equal to 450 gsm, greater than or equal to 475 gsm, greater than or equal to 500 gsm, greater than or equal to 550 gsm, greater than or equal to 600 gsm, greater than or equal to 700 gsm, greater than or equal to 800 gsm, or greater than or equal to 900 gsm. In some embodiments, a non-woven fiber web of the first type has a basis weight of less than or equal to 1000 gsm, less than or equal to 900 gsm, less than or equal to 800 gsm, less than or equal to 700 gsm, less than or equal to 600 gsm, less than or equal to 550 gsm, less than or equal to 500 gsm, less than or equal to 475 gsm, less than or equal to 450 gsm, less than or equal to 425 gsm, less than or equal to 400 gsm, less than or equal to 375 gsm, less than or equal to 350 gsm, less than or equal to 325 gsm, less than or equal to 300 gsm, less than or equal to 275 gsm, less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 75 gsm, less than or equal to 50 gsm, less than or equal to 40 gsm, less than or equal to 30 gsm, less than or equal to 25 gsm, less than or equal to 20 gsm, or less than or equal to 15 gsm. Combinations of the above-referenced ranges are also possible (e.g., greater than or equal to 10 gsm and less than or equal to 1000 gsm, greater than or equal to 10 gsm and less than or equal to 500 gsm, greater than or equal to 20 gsm and less than or equal to 500 gsm, or greater than or equal to 30 gsm and less than or equal to 400 gsm). Other ranges are also possible.

The basis weight of a non-woven fiber web of the first type may be determined in accordance with ISO 536:2012. The basis weight of a non-woven fiber web of the first type may be determined when the non-woven fiber web of the first type is in the form that it takes in the filter media (e.g., in a form that comprises one or more pluralities of undulations, such as a second plurality of undulations positioned within a first plurality of undulations).

When a filter media comprises two or more non-woven fiber webs of the first type, each non-woven fiber web of the first type may independently have a basis weight in one or more of the above-referenced ranges.

The non-woven fiber webs of the first type described herein may have a variety of suitable thicknesses. In some embodiments, a non-woven fiber web of the first type has a thickness of greater than or equal to 0.1 mm, greater than or equal to 0.15 mm, greater than or equal to 0.2 mm, greater than or equal to 0.25 mm, greater than or equal to 0.3 mm, greater than or equal to 0.4 mm, greater than or equal to 0.5 mm, greater than or equal to 0.75 mm, greater than or equal to 1 mm, greater than or equal to 1.5 mm, greater than or equal to 2 mm, greater than or equal to 2.5 mm, greater than or equal to 3 mm, greater than or equal to 3.5 mm, greater than or equal to 4 mm, greater than or equal to 4.5 mm, greater than or equal to 5 mm, greater than or equal to 6 mm, greater than or equal to 7 mm, greater than or equal to 8 mm, or greater than or equal to 9 mm. In some embodiments, a non-woven fiber web of the first type has a thickness of less than or equal to 10 mm, less than or equal to 9 mm, less than or equal to 8 mm, less than or equal to 7 mm, less than or equal to 6 mm, less than or equal to 5 mm, less than or equal to 4.5 mm, less than or equal to 4 mm, less than or equal to 3.5 mm, less than or equal to 3 mm, less than or equal to 2.5 mm, less than or equal to 2 mm, less than or equal to 1.5 mm, less than or equal to 1 mm, less than or equal to 0.75 mm, less than or equal to 0.5 mm, less than or equal to 0.4 mm, less than or equal to 0.3 m, less than or equal to 0.2 mm, or less than or equal to 0.15 mm. Combinations of the above-referenced ranges are also possible (e.g., greater than or equal to 0.1 mm and less than or equal to 10 mm, or greater than or equal to 0.3 mm and less than or equal to 5 mm). Other ranges are also possible.

The thickness of a non-woven fiber web of the first type may be determined in accordance with ASTM D1777 (2015) under an applied pressure of 0.2 kPa. The thickness of a non-woven fiber web of the first type may be determined when the non-woven fiber web of the first type is in the form that it takes in the filter media (e.g., in a form that comprises one or more pluralities of undulations, such as a second plurality of undulations positioned within a first plurality of undulations).

When a filter media comprises two or more non-woven fiber webs of the first type, each non-woven fiber web of the first type may independently have a thickness in one or more of the above-referenced ranges.

The non-woven fiber webs of the first type described herein may have a variety of suitable beta 200 micron ratings. Beta values are one way of expressing the efficiency of a filter media, where beta(x)=y, where y is the ratio of upstream count (C₀) to downstream count (C) for particles in a fluid passing through the filter media, and where x is the minimum particle size that will achieve the actual ratio of C₀ to C that is equal to y. The penetration fraction of the filter media at a particular value of beta(x) is 1 divided by y. The efficiency fraction is 1−penetration fraction. Accordingly, the efficiency percentage of the filter media is 100% times the efficiency fraction, and 100%*(1−1/beta(x))=efficiency percentage. For example, a filter media having a beta(x)=200 (also referred to as “beta 200”) has an efficiency percentage of [1−(1/200)]*100%, or 99.5% for x micron or larger particles.

A beta 200 micron rating may be determined by performing a Multipass Filter Test following the ISO 16889 (2008) procedure (modified by testing a flat sheet sample). This test may be performed on a Multipass Filter Test Stand manufactured by FTI. The measurement may be made by flowing a test fluid comprising ISO A3 Medium test dust manufactured by PTI, Inc. at an upstream gravimetric dust level of 10 mg/liter in Aviation Hydraulic Fluid AERO HFA MIL H-5606A manufactured by Mobil through the fiber web having a cross-sectional area of 110 cm² at a face velocity of 24.55 cm/min until a terminal pressure drop of 200 kPa is reached.

In some embodiments, a non-woven fiber web of the first type has a beta 200 micron rating of greater than or equal to 1 micron, greater than or equal to 1.5 microns, greater than or equal to 2 microns, greater than or equal to 2.5 microns, greater than or equal to 3 microns, greater than or equal to 3.5 microns, greater than or equal to 4 microns, greater than or equal to 5 microns, greater than or equal to 7.5 microns, greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a non-woven fiber web of the first type has a beta 200 micron rating of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 4 microns, less than or equal to 3.5 microns, less than or equal to 3 microns, less than or equal to 2.5 microns, less than or equal to 2 microns, or less than or equal to 1.5 microns. Combinations of the above-referenced ranges are also possible (e.g., greater than or equal to 1 micron and less than or equal to 50 microns, or greater than or equal to 3 microns and less than or equal to 40 microns). Other ranges are also possible.

When a filter media comprises two or more non-woven fiber webs of the first type, each non-woven fiber web of the first type may independently have a beta 200 micron rating in one or more of the above-referenced ranges.

In some embodiments, a non-woven fiber web of the first type has a relatively low apparent density. The apparent density may be less than or equal to 300 gsm/mm, less than or equal to 275 gsm/mm, less than or equal to 250 gsm/mm, less than or equal to 225 gsm/mm, less than or equal to 200 gsm/mm, less than or equal to 170 gsm/mm, less than or equal to 150 gsm/mm, less than or equal to 125 gsm/mm, less than or equal to 100 gsm/mm, less than or equal to 90 gsm/mm, less than or equal to 80 gsm/mm, or less than or equal to 70 gsm/mm. The apparent density may be greater than or equal to 60 gsm/mm, greater than or equal to 70 gsm/mm, greater than or equal to 80 gsm/mm, greater than or equal to 90 gsm/mm, greater than or equal to 100 gsm/mm, greater than or equal to 125 gsm/mm, greater than or equal to 150 gsm/mm, greater than or equal to 170 gsm/mm, greater than or equal to 200 gsm/mm, greater than or equal to 225 gsm/mm, greater than or equal to 250 gsm/mm, or greater than or equal to 275 gsm/mm. Combinations of the above-referenced ranges are also possible (e.g., less than or equal to 300 gsm/mm and greater than or equal to 60 gsm/mm, or less than or equal to 170 gsm/mm and greater than or equal to 60 gsm/mm). Other ranges are also possible.

The apparent density of a non-woven fiber web of the first type may be determined by dividing the density of the non-woven fiber web of the first type by the thickness of the non-woven fiber web of the first type. The apparent density of a non-woven fiber web of the first type may be determined when the non-woven fiber web of the first type is in the form that it takes in the filter media (e.g., in a form that comprises one or more pluralities of undulations, such as a second plurality of undulations positioned within a first plurality of undulations).

When a filter media comprises two or more non-woven fiber webs of the first type, each non-woven fiber web of the first type may independently have an apparent density in one or more of the above-referenced ranges.

Some non-woven fiber webs of the first type described herein may have a relatively high dust holding capacity. The dust holding capacity may be greater than or equal to 10 gsm, greater than or equal to 15 gsm, greater than or equal to 20 gsm, greater than or equal to 25 gsm, greater than or equal to 30 gsm, greater than or equal to 50 gsm, greater than or equal to 75 gsm, greater than or equal to 100 gsm, greater than or equal to 150 gsm, greater than or equal to 200 gsm, greater than or equal to 250 gsm, greater than or equal to 300 gsm, greater than or equal to 350 gsm, greater than or equal to 400 gsm, or greater than or equal to 450 gsm. The dust holding capacity may be less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 100 gsm, less than or equal to 75 gsm, less than or equal to 50 gsm, less than or equal to 30 gsm, less than or equal to 25 gsm, less than or equal to 20 gsm, or less than or equal to 15 gsm. Combinations of the above-referenced ranges are also possible (e.g., greater than or equal to 10 gsm and less than or equal to 500 gsm, or greater than or equal to 20 gsm and less than or equal to 450 gsm). Other ranges are also possible.

The dust holding capacity of a non-woven fiber web of the first type may be determined by performing the Multipass Filter Test based on ISO 16889 (2008) as described elsewhere herein. The relevant dust holding capacity is the injected dust holding capacity (i.e., a non-woven fiber web of the first type may have an injected dust holding capacity in one or more of the ranges described above).

When a filter media comprises two or more non-woven fiber webs of the first type, each non-woven fiber web of the first type may independently have an dust holding capacity in one or more of the above-referenced ranges.

Some non-woven fiber webs of the first type may have a relatively high ratio of dust holding capacity (i.e., injected dust holding capacity) to beta 200 micron rating. The ratio of dust holding capacity to beta 200 micron rating may be greater than or equal to 10 gsm/micron, greater than or equal to 20 gsm/micron, greater than or equal to 30 gsm/micron, greater than or equal to 40 gsm/micron, greater than or equal to 50 gsm/micron, greater than or equal to 60 gsm/micron, greater than or equal to 70 gsm/micron, greater than or equal to 80 gsm/micron, or greater than or equal to 90 gsm/micron. The ratio of dust holding capacity to beta 200 micron rating may be less than or equal to 100 gsm/micron, less than or equal to 90 gsm/micron, less than or equal to 80 gsm/micron, less than or equal to 70 gsm/micron, less than or equal to 60 gsm/micron, less than or equal to 50 gsm/micron, less than or equal to 40 gsm/micron, less than or equal to 30 gsm/micron, or less than or equal to 20 gsm/micron. Combinations of the above-referenced ranges are also possible (e.g., greater than or equal to 10 gsm/micron and less than or equal to 100 gsm/micron). Other ranges are also possible.

The non-woven fiber webs of the first type described herein may have relatively low mean flow pore sizes. The mean flow pore size may be greater than or equal to 0.1 micron, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 20 microns, greater than or equal to 50 microns, greater than or equal to 75 microns, greater than or equal to 100 microns, greater than or equal to 150 microns, greater than or equal to 200 microns, or greater than or equal to 250 microns. The mean flow pore size may be less than or equal to 300 microns, less than or equal to 250 microns, less than or equal to 200 microns, less than or equal to 150 microns, less than or equal to 100 microns, less than or equal to 75 microns, less than or equal to 50 microns, less than or equal to 20 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 micron and less than or equal to 300 microns, or greater than or equal to 0.3 microns and less than or equal to 200 microns). Other ranges are also possible.

The mean flow pore size of a non-woven fiber web of the first type may be determined in accordance with ASTM F316 (2003). The mean flow pore size of a non-woven fiber web of the first type may be determined when the non-woven fiber web of the first type is in the form that it takes in the filter media (e.g., in a form that comprises one or more pluralities of undulations, such as a second plurality of undulations positioned within a first plurality of undulations).

When a filter media comprises two or more non-woven fiber webs of the first type, each non-woven fiber web of the first type may independently have a mean flow pore size in one or more of the above-referenced ranges.

The non-woven fiber webs of the first type described herein may have a relatively high ratio of average fiber diameter to mean flow pore size. The ratio of average fiber diameter to mean flow pore size may be greater than or equal to 0.8, greater than or equal to 1, greater than or equal to 1.25, greater than or equal to 1.5, greater than or equal to 1.75, greater than or equal to 2, greater than or equal to 2.25, greater than or equal to 2.5, greater than or equal to 2.75, greater than or equal to 3, greater than or equal to 3.25, greater than or equal to 3.5, greater than or equal to 3.75, greater than or equal to 4, greater than or equal to 4.5, greater than or equal to 5, greater than or equal to 5.5, greater than or equal to 6, greater than or equal to 6.5, greater than or equal to 7, greater than or equal to 7.5, greater than or equal to 8, greater than or equal to 8.5, greater than or equal to 9, or greater than or equal to 9.5. The ratio of average fiber diameter to mean flow pore size may be less than or equal to 10, less than or equal to 9.5, less than or equal to 9, less than or equal to 8.5, less than or equal to 8, less than or equal to 7.5, less than or equal to 7, less than or equal to 6.5, less than or equal to 6, less than or equal to 5.5, less than or equal to 5, less than or equal to 4.5, less than or equal to 4, less than or equal to 3.75, less than or equal to 3.5, less than or equal to 3.25, less than or equal to 3, less than or equal to 2.75, less than or equal to 2.5, less than or equal to 2.25, less than or equal to 2, less than or equal to 1.75, less than or equal to 1.5, less than or equal to 1.25, or less than or equal to 1. Combinations of the above-referenced ranges are also possible (e.g., greater than or equal to 0.8 and less than or equal to 10, or greater than or equal to 0.8 and less than or equal to 4). Other ranges are also possible.

The ratio of average fiber diameter to mean flow pore size of a non-woven fiber web of the first type may be determined when the non-woven fiber web of the first type is in the form that it takes in the filter media (e.g., in a form that comprises one or more pluralities of undulations, such as a second plurality of undulations positioned within a first plurality of undulations).

When a filter media comprises two or more non-woven fiber webs of the first type, each non-woven fiber web of the first type may independently have a ratio of average fiber diameter to mean flow pore size in one or more of the above-referenced ranges.

The non-woven fiber webs of the first type described herein may have a variety of suitable maximum pore sizes. In some embodiments, a non-woven fiber web of the first type has a maximum pore size of greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 20 microns, greater than or equal to 50 microns, greater than or equal to 75 microns, greater than or equal to 100 microns, greater than or equal to 125 microns, greater than or equal to 150 microns, greater than or equal to 175 microns, greater than or equal to 200 microns, greater than or equal to 225 microns, greater than or equal to 250 microns, greater than or equal to 275 microns, greater than or equal to 300 microns, greater than or equal to 325 microns, greater than or equal to 350 microns, or greater than or equal to 375 microns. In some embodiments, a non-woven fiber web of the first type has a maximum pore size of less than or equal to 400 microns, less than or equal to 375 microns, less than or equal to 350 microns, less than or equal to 325 microns, less than or equal to 300 microns, less than or equal to 275 microns, less than or equal to 250 microns, less than or equal to 225 microns, less than or equal to 200 microns, less than or equal to 175 microns, less than or equal to 150 microns, less than or equal to 125 microns, less than or equal to 100 microns, less than or equal to 75 microns, less than or equal to 50 microns, less than or equal to 20 microns, less than or equal to 10 microns, less than or equal to 7.5 microns, less than or equal to 5 microns, less than or equal to 2 microns, less than or equal to 1 micron, or less than or equal to 0.75 microns. Combinations of the above-referenced ranges are also possible (e.g., greater than or equal to 0.5 microns and less than or equal to 400 microns, or greater than or equal to 1 micron and less than or equal to 200 microns). Other ranges are also possible.

The maximum pore size of a non-woven fiber web of the first type may be determined in accordance with ASTM F316 (2003). The maximum pore size of a non-woven fiber web of the first type may be determined when the non-woven fiber web of the first type is in the form that it takes in the filter media (e.g., in a form that comprises one or more pluralities of undulations, such as a second plurality of undulations positioned within a first plurality of undulations).

When a filter media comprises two or more non-woven fiber webs of the first type, each non-woven fiber web of the first type may independently have a maximum pore size in one or more of the above-referenced ranges.

The non-woven fiber webs of the first type described herein may have a variety of suitable air permeabilities. In some embodiments, a non-woven fiber web of the first type has an air permeability of greater than or equal to 0.1 CFM, greater than or equal to 0.2 CFM, greater than or equal to 0.5 CFM, greater than or equal to 0.75 CFM, greater than or equal to 1 CFM, greater than or equal to 2 CFM, greater than or equal to 5 CFM, greater than or equal to 7.5 CFM, greater than or equal to 10 CFM, greater than or equal to 20 CFM, greater than or equal to 50 CFM, greater than or equal to 75 CFM, greater than or equal to 100 CFM, greater than or equal to 125 CFM, greater than or equal to 150 CFM, greater than or equal to 175 CFM, greater than or equal to 200 CFM, greater than or equal to 225 CFM, greater than or equal to 250 CFM, greater than or equal to 275 CFM, greater than or equal to 300 CFM, greater than or equal to 325 CFM, greater than or equal to 350 CFM, greater than or equal to 375 CFM, greater than or equal to 400 CFM, greater than or equal to 425 CFM, greater than or equal to 450 CFM, greater than or equal to 475 CFM, greater than or equal to 500 CFM, greater than or equal to 550 CFM, greater than or equal to 600 CFM, or greater than or equal to 700 CFM. In some embodiments, a non-woven fiber web of the first type has an air permeability of less than or equal to 800 CFM, less than or equal to 700 CFM, less than or equal to 600 CFM, less than or equal to 550 CFM, less than or equal to 500 CFM, less than or equal to 475 CFM, less than or equal to 450 CFM, less than or equal to 425 CFM, less than or equal to 400 CFM, less than or equal to 375 CFM, less than or equal to 350 CFM, less than or equal to 325 CFM, less than or equal to 300 CFM, less than or equal to 275 CFM, less than or equal to 250 CFM, less than or equal to 225 CFM, less than or equal to 200 CFM, less than or equal to 175 CFM, less than or equal to 150 CFM, less than or equal to 125 CFM, less than or equal to 100 CFM, less than or equal to 75 CFM, less than or equal to 50 CFM, less than or equal to 20 CFM, less than or equal to 10 CFM, less than or equal to 7.5 CFM, less than or equal to 5 CFM, less than or equal to 2 CFM, less than or equal to 1 CFM, less than or equal to 0.75 CFM, less than or equal to 0.5 CFM, or less than or equal to 0.2 CFM. Combinations of the above-referenced ranges are also possible (e.g., greater than or equal to 0.1 CFM and less than or equal to 800 CFM, greater than or equal to 0.1 CFM and less than or equal to 500 CFM, greater than or equal to 1 CFM and less than or equal to 400 CFM, or greater than or equal to 5 CFM and less than or equal to 200 CFM). Other ranges are also possible.

As would be known to one of ordinary skill in the art, the unit CFM is equivalent to the unit cfm/sf or ft/min.

The air permeability of a non-woven fiber web of the first type may be determined in accordance with ASTM D737-04 (2016) at a pressure of 125 Pa. The air permeability of a non-woven fiber web of the first type may be determined when the non-woven fiber web of the first type is in the form that it takes in the filter media (e.g., in a form that comprises one or more pluralities of undulations, such as a second plurality of undulations positioned within a first plurality of undulations).

When a filter media comprises two or more non-woven fiber webs of the first type, each non-woven fiber web of the first type may independently have an air permeability in one or more of the above-referenced ranges.

The non-woven fiber webs of the first type described herein may have a variety of suitable ratios of mean flow pore size to square root of air permeability. In some embodiments, a non-woven fiber web of the first type has a ratio of mean flow pore size to square root of air permeability of greater than or equal to 0.3 microns/(CFM)^{0.5}, greater than or equal to 0.35 microns/(CFM)^{0.5}, greater than or equal to 0.4 microns/(CFM)^{0.5}, greater than or equal to 0.45 microns/(CFM)^{0.5}, greater than or equal to 0.5 microns/(CFM)^{0.5}, greater than or equal to 0.55 microns/(CFM)^{0.5}, greater than or equal to 0.6 microns/(CFM)^{0.5}, greater than or equal to 0.7 microns/(CFM)^{0.5}, greater than or equal to 0.8 microns/(CFM)^{0.5}, greater than or equal to 1 micron/(CFM)^{0.5}, greater than or equal to 1.25 microns/(CFM)^{0.5}, greater than or equal to 1.5 microns/(CFM)^{0.5}, greater than or equal to 1.75 microns/(CFM)^{0.5}, greater than or equal to 2 microns/(CFM)^{0.5}, greater than or equal to 2.25 microns/(CFM)^{0.5}, greater than or equal to 2.5 microns/(CFM)^{0.5}, greater than or equal to 2.75 microns/(CFM)^{0.5}, greater than or equal to 3 microns/(CFM)^{0.5}, greater than or equal to 3.25 microns/(CFM)^{0.5}, greater than or equal to 3.5 microns/(CFM)^{0.5}, greater than or equal to 4 microns/(CFM)^{0.5}, greater than or equal to 4.5 microns/(CFM)^{0.5}, greater than or equal to 5 microns/(CFM)^{0.5}, or greater than or equal to 5.5 microns/(CFM)^{0.5}. In some embodiments, a non-woven fiber web of the first type has a ratio of mean flow pore size to square root of air permeability of less than or equal to 6 microns/(CFM)^{0.5}, less than or equal to 5.5 microns/(CFM)^{0.5}, less than or equal to 5 microns/(CFM)^{0.5}, less than or equal to 4.5 microns/(CFM)^{0.5}, less than or equal to 4 microns/(CFM)^{0.5}, less than or equal to 3.5 microns/(CFM)^{0.5}, less than or equal to 3.25 microns/(CFM)^{0.5}, less than or equal to 3 microns/(CFM)^{0.5}, less than or equal to 2.75 microns/(CFM)^{0.5}, less than or equal to 2.5 microns/(CFM)^{0.5}, less than or equal to 2.25 microns/(CFM)^{0.5}, less than or equal to 2 microns/(CFM)^{0.5}, less than or equal to 1.75 microns/(CFM)^{0.5}, less than or equal to 1.5 microns/(CFM)^{0.5}, less than or equal to 1.25 microns/(CFM)^{0.5}, less than or equal to 1 micron/(CFM)^{0.5}, less than or equal to 0.8 microns/(CFM)^{0.5}, less than or equal to 0.7 microns/(CFM)^{0.5}, less than or equal to 0.6 microns/(CFM)^{0.5}, less than or equal to 0.55 microns/(CFM)^{0.5}, less than or equal to 0.5 microns/(CFM)^{0.5}, less than or equal to 0.45 microns/(CFM)^{0.5}, less than or equal to 0.4 microns/(CFM)^{0.5}, or less than or equal to 0.35 microns/(CFM)^{0.5}. Combinations of the above-referenced ranges are also possible (e.g., greater than or equal to 0.3 microns/(CFM)^{0.5} and less than or equal to 6 microns/(CFM)^{0.5}, or greater than or equal to 0.5 microns/(CFM)^{0.5} and less than or equal to 3 microns/(CFM)^{0.5}). Other ranges are also possible.

The ratio of mean flow pore size to square root of air permeability of a non-woven fiber web of the first type may be determined when the non-woven fiber web of the first type is in the form that it takes in the filter media (e.g., in a form that comprises one or more pluralities of undulations, such as a second plurality of undulations positioned within a first plurality of undulations).

When a filter media comprises two or more non-woven fiber webs of the first type, each non-woven fiber web of the first type may independently have a ratio of mean flow pore size to square root of air permeability in one or more of the above-referenced ranges.

In some embodiments, a filter media comprises a non-woven fiber web of a second type. A filter media may comprise both a non-woven fiber web of the first type described elsewhere herein and a non-woven fiber web of the second type or may comprise one but not the other. The filter media may comprise a non-woven fiber web of the second type that serves as an efficiency layer. Non-woven fiber webs of the second type may, as described elsewhere herein, comprise two or more pluralities of undulations, comprise exactly one plurality of undulations, or lack undulations. Non-limiting examples of suitable structures for non-woven fiber webs of the second type include wet laid non-woven fiber webs and carded non-woven fiber webs. In some embodiments, a filter media may comprise a non-woven fiber web of the second type that is a composite of two or more non-woven fiber webs (e.g., two or more of the previously-identified non-woven fiber webs).

The non-woven fiber webs of the second type described herein may comprise a variety of suitable types of fibers. Some non-woven fiber webs of the second type comprise exactly one type of fiber. Some non-woven fiber webs of the second type comprise two or more types of fibers. For instance, a non-woven fiber web of the second type may comprise three or more types of fibers, four or more types of fibers, five or more types of fibers, or even more types of fibers. When a non-woven fiber web of the second type comprises two or more types of fibers, the types of fibers may differ in a variety of ways, such as average fiber diameter, average fiber length, structure (e.g., fibrillation, number and/or arrangement of components), and/or chemical composition. Fibers of different types may have no features in common or may have both some features that are the same as each other (e.g., chemical composition) and some features that are different (e.g., average fiber diameter).

In some embodiments, a non-woven fiber web of the second type comprises fibrillated fibers. Fibrillated fibers may make up a variety of suitable amounts of the non-woven fiber webs of the second type described herein. In some embodiments, fibrillated fibers make up greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, or greater than or equal to 65 wt % of a non-woven fiber web of the second type (inclusive of fibers and any other components present therein). In some embodiments, fibrillated fibers make up less than or equal to 69 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % a non-woven fiber web of the second type. Combinations of the above-referenced ranges are also possible (e.g., greater than or equal to 1 wt % and less than or equal to 69 wt %, or greater than or equal to 10 wt % and less than or equal to 50 wt %, or greater than or equal to 20 wt % and less than or equal to 40 wt %). Other ranges are also possible.

When a non-woven fiber web of the second type comprises two or more types of fibrillated fibers, each type of fibrillated fiber may independently make up an amount of the non-woven fiber web of the second type in one or more of the ranges described above and/or all of the fibrillated fibers in a non-woven fiber web of the second type may together make up an amount of the non-woven fiber web of the second type in one or more of the ranges described above. Similarly, when a filter media comprises two or more non-woven fiber webs of the second type, each non-woven fiber web of the second type may independently comprise an amount of any particular type of fibrillated fiber in one or more of the ranges described above and/or may comprise a total amount of fibrillated fibers in one or more of the ranges described above.

A non-woven fiber web of the second type may comprise fibrillated fibers having one or more of the compositions described above with respect to fibrillated fibers that may be present in a non-woven fiber web of the second type.

Fibrillated fibers in a non-woven fiber web of the second type may have a variety of suitable dimensions. In some embodiments, a non-woven fiber web of the second type comprises fibrillated fibers for which the parent fibers have an average fiber diameter of greater than or equal to 1 micron, greater than or equal to 2 microns, greater than or equal to 3 microns, greater than or equal to 5 microns, greater than or equal to 7.5 microns, greater than or equal to 10 microns, greater than or equal to 12.5 microns, greater than or equal to 15 microns, or greater than or equal to 17.5 microns. In some embodiments, a non-woven fiber web of the second type comprises fibrillated fibers for which the parent fibers have an average fiber diameter of less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 3 microns, or less than or equal to 2 microns. Combinations of the above-referenced ranges are also possible (e.g., greater than or equal to 1 micron and less than or equal to 20 microns). Other ranges are also possible.

When a non-woven fiber web of the second type comprises two or more types of fibrillated fibers, each type of fibrillated fiber may independently have an average fiber diameter for the parent fibers in one or more of the ranges described above and/or all of the fibrillated fibers in a non-woven fiber web of the second type may together have an average fiber diameter for the parent fibers in one or more of the ranges described above. Similarly, when a filter media comprises two or more non-woven fiber webs of the second type, each non-woven fiber web of the second type may independently comprise one or more types of fibrillated fibers having an average fiber diameter for the parent fibers in one or more of the ranges described above and/or may comprise fibrillated fibers that overall have an average fiber diameter for the parent fibers in one or more of the ranges described above.

In some embodiments, fibrillated fibers present in a non-woven fiber web of the second type comprise fibrils having an average fiber diameter of greater than or equal to 0.1 micron, greater than or equal to 0.2 microns, greater than or equal to 0.3 microns, greater than or equal to 0.4 microns, greater than or equal to 0.5 microns, greater than or equal to 0.6 microns, greater than or equal to 0.8 microns, greater than or equal to 1 micron, greater than or equal to 1.2 microns, greater than or equal to 1.4 microns, greater than or equal to 1.6 microns, greater than or equal to 1.8 microns, greater than or equal to 2 microns, greater than or equal to 2.5 microns, greater than or equal to 3 microns, or greater than or equal to 3.5 microns. In some embodiments, the fibrils may have an average fiber diameter of less than or equal to 4 microns, less than or equal to 3.5 microns, less than or equal to 3 microns, less than or equal to 2.5 microns, less than or equal to 2 microns, less than or equal to 1.8 microns, less than or equal to 1.6 microns, less than or equal to 1.4 microns, less than or equal to 1.2 microns, less than or equal to 1 micron, less than or equal to 0.8 microns, less than or equal to 0.6 microns, less than or equal to 0.5 microns, less than or equal to 0.4 microns, less than or equal to 0.3 microns, or less than or equal to 0.2 microns. Combinations of the above-referenced ranges are also possible (e.g., greater than or equal to 0.1 micron and less than or equal to 4 microns, or greater than or equal to 0.1 micron and less than or equal to 2 microns). Other ranges are also possible.

When a non-woven fiber web of the second type comprises two or more types of fibrillated fibers, each type of fibrillated fiber may independently have an average fiber diameter for the fibrils in one or more of the ranges described above and/or all of the fibrillated fibers in a non-woven fiber web of the second type may together have an average fiber diameter for the fibrils in one or more of the ranges described above. Similarly, when a filter media comprises two or more non-woven fiber webs of the second type, each non-woven fiber web of the second type may independently comprise one or more types of fibrillated fibers having an average fiber diameter for the fibrils in one or more of the ranges described above and/or may comprise fibrillated fibers that overall have an average fiber diameter for the and fibrils in one or more of the ranges described above.

Fibrillated fibers may have a variety of suitable average lengths. In some embodiments, a non-woven fiber web of the second type comprises fibrillated fibers having an average length of greater than or equal to 0.01 inch, greater than or equal to 0.03 inches, greater than or equal to 0.05 inches, greater than or equal to 0.1 inch, greater than or equal to 0.2 inches, greater than or equal to 0.3 inches, greater than or equal to 0.4 inches, greater than or equal to 0.5 inches, greater than or equal to 0.6 inches, greater than or equal to 0.7 inches, greater than or equal to 0.8 inches, or greater than or equal to 0.9 inches. In some embodiments, a non-woven fiber web of the second type comprises fibrillated fibers having an average length of less than or equal to 1 inch, less than or equal to 0.9 inches, less than or equal to 0.8 inches, less than or equal to 0.7 inches, less than or equal to 0.6 inches, less than or equal to 0.5 inches, less than or equal to 0.4 inches, less than or equal to 0.3 inches, less than or equal to 0.2 inches, less than or equal to 0.1 inch, less than or equal to 0.05 inches, less than or equal to 0.03 inches, or less than or equal to 0.02 inches. Combinations of the above-referenced ranges are also possible (e.g., greater than or equal to 0.01 inch and less than or equal to 1 inch, greater than or equal to 0.1 inch and less than or equal to 0.5 inches, or greater than or equal to 0.1 inches and less than or equal to 0.3 inches). Other ranges are also possible.

When a non-woven fiber web of the second type comprises two or more types of fibrillated fibers, each type of fibrillated fiber may independently have an average fiber length in one or more of the ranges described above and/or all of the fibrillated fibers in a non-woven fiber web of the second type may together have an average fiber length in one or more of the ranges described above. Similarly, when a filter media comprises two or more non-woven fiber webs of the second type, each non-woven fiber web of the second type may independently comprise one or more types of fibrillated fibers having an average fiber length in one or more of the ranges described above and/or may comprise fibrillated fibers that overall have an average fiber length in one or more of the ranges described above.

Fibrillated fibers may have a variety of suitable average levels of fibrillation. In some embodiments, a non-woven fiber web of the second type comprises fibrillated fibers having an average level of fibrillation of greater than or equal to 10 mL, greater than or equal to 15 mL, greater than or equal to 20 mL, greater than or equal to 50 mL, greater than or equal to 75 mL, greater than or equal to 100 mL, greater than or equal to 105 mL, greater than or equal to 110 mL, greater than or equal to 115 mL, greater than or equal to 120 mL, greater than or equal to 125 mL, greater than or equal to 150 mL, greater than or equal to 175 mL, greater than or equal to 200 mL, greater than or equal to 250 mL, greater than or equal to 300 mL, greater than or equal to 400 mL, greater than or equal to 500 mL, greater than or equal to 600 mL, or greater than or equal to 700 mL. In some embodiments, a non-woven fiber web of the second type comprises fibrillated fibers having an average level of fibrillation of less than or equal to 800 mL, less than or equal to 700 mL, less than or equal to 600 mL, less than or equal to 500 mL, less than or equal to 400 mL, less than or equal to 300 mL, less than or equal to 250 mL, less than or equal to 200 mL, less than or equal to 175 mL, less than or equal to 150 mL, less than or equal to 125 mL, less than or equal to 120 mL, less than or equal to 115 mL, less than or equal to 110 mL, less than or equal to 105 mL, less than or equal to 100 mL, less than or equal to 75 mL, less than or equal to 50 mL, less than or equal to 20 mL, less than or equal to 15 mL, or less than or equal to 10 mL. Combinations of the above-referenced ranges are also possible (e.g., greater than or equal to 10 mL and less than or equal to 800 mL, greater than or equal to 50 mL and less than or equal to 500 mL, or greater than or equal to 100 mL and less than or equal to 300 mL). Other ranges are also possible.

The average level of fibrillation of fibrillated fibers can be measured according to a Canadian Standard Freeness test, specified by TAPPI test method T-227-om-09 Freeness of pulp (2009). The test can provide an average CSF value in mL.

When a non-woven fiber web of the second type comprises two or more types of fibrillated fibers, each type of fibrillated fiber may independently have an average level of fibrillation in one or more of the ranges described above and/or all of the fibrillated fibers in a non-woven fiber web of the second type may together have an average level of fibrillation in one or more of the ranges described above. Similarly, when a filter media comprises two or more non-woven fiber webs of the second type, each non-woven fiber web of the second type may independently comprise one or more types of fibrillated fibers having an average level of fibrillation in one or more of the ranges described above and/or may comprise fibrillated fibers that overall have an average level of fibrillation in one or more of the ranges described above.

In some embodiments, a non-woven fiber web of the second type includes glass fibers. Such glass fibers may include chopped strand glass fibers and/or microglass fibers as described elsewhere herein.

Glass fibers may be present in the non-woven fiber webs of the second type described herein in a variety of suitable amounts. In some embodiments, glass fibers make up greater than or equal to 20 wt %, greater than or equal to 22.5 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, or greater than or equal to 85 wt % of a non-woven fiber web of the second type (inclusive of fibers and any other components present therein). In some embodiments, glass fibers make up less than or equal to 88 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 22.5 wt %, or less than or equal to 20 wt % of a non-woven fiber web of the second type. Combinations of the above-referenced ranges are also possible (e.g., greater than or equal to 20 wt % and less than or equal to 88 wt %, greater than or equal to 20 wt % and less than or equal to 60 wt %, or greater than or equal to 20 wt % and less than or equal 40 wt %). Other ranges are also possible.

When a non-woven fiber web of the second type comprises two or more types of glass fibers, each type of glass fiber may independently make up an amount of the non-woven fiber web of the second type in one or more of the ranges described above and/or all of the glass fibers in a non-woven fiber web of the second type may together make up an amount of the non-woven fiber web of the second type in one or more of the ranges described above. Similarly, when a filter media comprises two or more non-woven fiber webs of the second type, each non-woven fiber web of the second type may independently comprise an amount of any particular type of glass fiber in one or more of the ranges described above and/or may comprise a total amount of glass fibers in one or more of the ranges described above.

Glass fibers present in non-woven fiber webs of the second type may have a variety of suitable average fiber diameters. In some embodiments, a non-woven fiber web of the second type comprises glass fibers having an average fiber diameter of greater than or equal to 0.1 micron, greater than or equal to 0.15 microns, greater than or equal to 0.20 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, or greater than or equal to 25 microns. In some embodiments, a non-woven fiber web of the second type comprises glass fibers having an average fiber diameter of less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, or less than or equal to 0.1 micron. Combinations of the above-referenced ranges are also possible (e.g., greater than or equal to 0.1 micron and less than or equal to 30 microns, greater than or equal to 0.25 microns and less than or equal to 10 microns, greater than or equal to 0.4 microns and less than or equal to 5 microns, or greater than or equal to 0.2 microns and less than or equal to 2 microns). Other ranges are also possible.

When a non-woven fiber web of the second type comprises two or more types of glass fibers, each type of glass fiber may independently have an average fiber diameter in one or more of the ranges described above and/or all of the glass fibers in a non-woven fiber web of the second type may together have an average fiber diameter in one or more of the ranges described above. Similarly, when a filter media comprises two or more non-woven fiber webs of the second type, each non-woven fiber web of the second type may independently comprise one or more types of glass fibers having an average fiber diameter in one or more of the ranges described above and/or may comprise glass fibers that overall have an average fiber diameter in one or more of the ranges described above.

Glass fibers present in non-woven fiber webs of the second type described herein may have a variety of suitable average fiber lengths. In some embodiments, a non-woven fiber web of the second type comprises glass fibers having an average fiber length of greater than or equal to 0.001 inch, greater than or equal to 0.002 inches, greater than or equal to 0.003 inches, greater than or equal to 0.004 inches, greater than or equal to 0.006 inches, greater than or equal to 0.008 inches, greater than or equal to 0.01 inch, greater than or equal to 0.025 inches, greater than or equal to 0.05 inches, greater than or equal to 0.075 inches, greater than or equal to 0.1 inch, greater than or equal to 0.2 inches, greater than or equal to 0.3 inches, greater than or equal to 0.4 inches, greater than or equal to 0.5 inches, greater than or equal to 0.6 inches, greater than or equal to 0.75 inches, or greater than or equal to 0.9 inches. In some embodiments, a non-woven fiber web of the second type comprises glass fibers having an average fiber length of less than or equal to 1 inch, less than or equal to 0.9 inches, less than or equal to 0.75 inches, less than or equal to 0.6 inches, less than or equal to 0.5 inches, less than or equal to 0.4 inches, less than or equal to 0.3 inches, less than or equal to 0.2 inches, less than or equal to 0.1 inch, less than or equal to 0.075 inches, less than or equal to 0.05 inches, less than or equal to 0.025 inches, less than or equal to 0.01 inch, less than or equal to 0.008 inches, less than or equal to 0.006 inches, less than or equal to 0.004 inches, less than or equal to 0.003 inches, less than or equal to 0.002 inches, or less than or equal to 0.001 inch. Combinations of the above-referenced ranges are also possible (e.g., greater than or equal to 0.001 inch and less than or equal to 1 inch, greater than or equal to 0.003 inches and less than or equal to 0.75 inches, or greater than or equal to 0.01 inch and less than or equal to 0.5 inches). Other ranges are also possible.

When a non-woven fiber web of the second type comprises two or more types of glass fibers, each type of glass fiber may independently have an average fiber length in one or more of the ranges described above and/or all of the glass fibers in a non-woven fiber web of the second type may together have an average fiber length in one or more of the ranges described above. Similarly, when a filter media comprises two or more non-woven fiber webs of the second type, each non-woven fiber web of the second type may independently comprise one or more types of glass fibers having an average fiber length in one or more of the ranges described above and/or may comprise glass fibers that overall have an average fiber length in one or more of the ranges described above.

Glass fibers present in non-woven fiber webs of the second type described herein may have a variety of suitable aspect ratios. In some embodiments, a non-woven fiber web of the second type comprises glass fibers having an aspect ratio of greater than or equal to 100, greater than or equal to 150, greater than or equal to 200, greater than or equal to 300, greater than or equal to 400, greater than or equal to 500, greater than or equal to 750, greater than or equal to 1000, greater than or equal to 1500, greater than or equal to 2000, greater than or equal to 2500, greater than or equal to 3000, greater than or equal to 3500, greater than or equal to 4000, greater than or equal to 5000, greater than or equal to 6000, greater than or equal to 7000, greater than or equal to 8000, greater than or equal to 9000, greater than or equal to 10000, greater than or equal to 20000, greater than or equal to 30000, greater than or equal to 40000, greater than or equal to 50000, greater than or equal to 60000, greater than or equal to 70000, greater than or equal to 80000, or greater than or equal to 90000. In some embodiments, a non-woven fiber web of the second type comprises glass fibers having an aspect ratio of less than or equal to 100000, less than or equal to 90000, less than or equal to 80000, less than or equal to 70000, less than or equal to 60000, less than or equal to 50000, less than or equal to 40000, less than or equal to 30000, less than or equal to 20000, less than or equal to 10000, less than or equal to 9000, less than or equal to 8000, less than or equal to 7000, less than or equal to 6000, less than or equal to 5000, less than or equal to 4000, less than or equal to 3500, less than or equal to 3000, less than or equal to 2500, less than or equal to 2000, less than or equal to 1500, less than or equal to 1000, less than or equal to 750, less than or equal to 500, less than or equal to 400, less than or equal to 300, less than or equal to 200, or less than or equal to 150. Combinations of the above-referenced ranges are also possible (e.g., greater than or equal to 100 and less than or equal to 100000, greater than or equal to 100 and less than or equal to 10000, greater than or equal to 200 and less than or equal to 2500, or greater than or equal to 300 and less than or equal to 1000). Other ranges are also possible.

When a non-woven fiber web of the second type comprises two or more types of glass fibers, each type of glass fiber may independently have an aspect ratio in one or more of the ranges described above and/or all of the glass fibers in a non-woven fiber web of the second type may together have an aspect ratio in one or more of the ranges described above. Similarly, when a filter media comprises two or more non-woven fiber webs of the second type, each non-woven fiber web of the second type may independently comprise one or more types of glass fibers having an aspect ratio in one or more of the ranges described above and/or may comprise glass fibers that overall have an aspect ratio in one or more of the ranges described above.

In some embodiments, a non-woven fiber web of the second type comprises microglass fibers. A non-woven fiber web of the second type may comprise microglass fibers in variety of suitable amounts. In some embodiments, microglass fibers make up greater than or equal to 10 wt %, greater than or equal to 20 wt %, greater than or equal to 22.5 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, or greater than or equal to 85 wt % of the non-woven fiber web of the second type (inclusive of fibers and any other components present therein). In some embodiments, microglass fibers make up less than or equal to 88 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 22.5 wt %, or less than or equal to 20 wt % of the non-woven fiber web of the second type. Combinations of the above-referenced ranges are also possible (e.g., greater than or equal to 10 wt % and less than or equal to 88 wt %, greater than or equal to 20 wt % and less than or equal to 88 wt %, greater than or equal to 20 wt % and less than or equal to 60 wt %, or greater than or equal to 20 wt % and less than or equal 40 wt %). Other ranges are also possible.

When a non-woven fiber web of the second type comprises two or more types of microglass fibers, each type of microglass fiber may independently make up an amount of the non-woven fiber web of the second type in one or more of the ranges described above and/or all of the microglass fibers in a non-woven fiber web of the second type may together make up an amount of the non-woven fiber web of the second type in one or more of the ranges described above. Similarly, when a filter media comprises two or more non-woven fiber webs of the second type, each non-woven fiber web of the second type may independently comprise an amount of any particular type of microglass fiber in one or more of the ranges described above and/or may comprise a total amount of microglass fibers in one or more of the ranges described above.

In some embodiments, microglass fibers make up greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, or greater than or equal to 95 wt % of the glass fibers in a non-woven fiber web of the second type. In some embodiments, microglass fibers make up less than or equal to 100 wt %, less than or equal to 95 wt %, less than or equal to 90 wt %, less than or equal to less than or equal to 85 wt %, less than or equal to 80 wt %, less than or equal to 75 wt %, less than or equal to 70 wt %, less than or equal to 65 wt %, less than or equal to 60 wt %, or less than or equal to 55 wt % of the glass fibers in a non-woven fiber web of the second type. Combinations of the above-referenced ranges are also possible (e.g., greater than or equal to 50 wt % and less than or equal to 100 wt %). Other ranges are also possible. In some embodiments, microglass fibers make up exactly 100 wt % of the glass fibers in a non-woven fiber web of the second type.

When a non-woven fiber web of the second type comprises two or more types of microglass fibers, each type of microglass fiber may independently make up an amount of the non-woven fiber web of the second type in one or more of the ranges described above and/or all of the microglass fibers in a non-woven fiber web of the second type may together make up an amount of the non-woven fiber web of the second type in one or more of the ranges described above. Similarly, when a filter media comprises two or more non-woven fiber webs of the second type, each non-woven fiber web of the second type may independently comprise an amount of any particular type of microglass fiber in one or more of the ranges described above and/or may comprise a total amount of microglass fibers in one or more of the ranges described above.

Microglass fibers present in non-woven fiber webs of the second type described herein may have a variety of suitable average fiber diameters. In some embodiments, a non-woven fiber web of the second type comprises microglass fibers having an average fiber diameter of greater than or equal to 0.1 micron, greater than or equal to 0.15 microns, greater than or equal to 0.2 microns, greater than or equal to 0.25 microns, greater than or equal to 0.3 microns, greater than or equal to 0.35 microns, greater than or equal to 0.4 microns, greater than or equal to 0.5 microns, greater than or equal to 0.6 microns, greater than or equal to 0.8 microns, greater than or equal to 1 micron, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 6 microns, or greater than or equal to 8 microns. In some embodiments, a non-woven fiber web of the second type comprises microglass fibers having an average fiber diameter of less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, less than or equal to 1.5 microns, less than or equal to 1 micron, less than or equal to 0.8 microns, less than or equal to 0.6 microns, less than or equal to 0.5 microns, less than or equal to 0.4 microns, less than or equal to 0.35 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 micron and less than or equal to 10 microns, greater than or equal to 0.2 microns and less than or equal to 6 microns, or greater than or equal to 0.3 microns and less than or equal to 2 microns). Other ranges are also possible.

When a non-woven fiber web of the second type comprises two or more types of microglass fibers, each type of microglass fiber may independently have an average fiber diameter in one or more of the ranges described above and/or all of the microglass fibers in a non-woven fiber web of the second type may together have an average fiber diameter in one or more of the ranges described above. Similarly, when a filter media comprises two or more non-woven fiber webs of the second type, each non-woven fiber web of the second type may independently comprise one or more types of microglass fibers having an average fiber diameter in one or more of the ranges described above and/or may comprise microglass fibers that overall have an average fiber diameter in one or more of the ranges described above.

Microglass fibers present in the non-woven fiber webs of the second type described herein may have a variety of suitable aspect ratios. In some embodiments, a non-woven fiber web of the second type comprises microglass fibers having an average aspect ratio in one or more of the ranges described elsewhere herein with respect to the average aspect ratios of glass fibers.

In some embodiments, a non-woven fiber web of the second type comprises chopped strand glass fibers. A non-woven fiber web of the second type may comprise chopped strand glass fibers in variety of suitable amounts. In some embodiments, chopped strand glass fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 22.5 wt %, greater than or equal to 25 wt %, greater than or equal to 30 wt %, greater than or equal to 35 wt %, or greater than or equal to 40 wt % of a non-woven fiber web of the second type (inclusive of fibers and any other components present therein). In some embodiments, chopped strand glass fibers make up less than or equal to 45 wt %, less than or equal to 40 wt %, less than or equal to 35 wt %, less than or equal to 30 wt %, less than or equal to 25 wt %, less than or equal to 22.5 wt %, less than or equal to 20 wt %, or less than or equal to 15 wt %, less than or equal to 10 wt %, less than or equal to 7.5 wt %, less than or equal to 5 wt %, less than or equal to 2 wt %, or less than or equal to 1 wt % of the non-woven fiber web of the second type. Combinations of the above-referenced ranges are also possible (e.g., greater than or equal to 20 wt % and less than or equal to 45 wt %, greater than or equal to 20 wt % and less than or equal to 45 wt %, or greater than or equal to 20 wt % and less than or equal 40 wt %). Other ranges are also possible. In some embodiments, chopped strand glass fibers make up exactly 0 wt % of a non-woven fiber web of the first type

When a non-woven fiber web of the second type comprises two or more types of chopped strand glass fibers, each type of chopped strand glass fiber may independently make up an amount of the non-woven fiber web of the second type in one or more of the ranges described above and/or all of the chopped strand glass fibers in a non-woven fiber web of the second type may together make up an amount of the non-woven fiber web of the second type in one or more of the ranges described above. Similarly, when a filter media comprises two or more non-woven fiber webs of the second type, each non-woven fiber web of the second type may independently comprise an amount of any particular type of chopped strand glass fiber in one or more of the ranges described above and/or may comprise a total amount of chopped strand glass fibers in one or more of the ranges described above.

In some embodiments, chopped strand glass fibers make up greater than or equal to 0 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, or greater than or equal to 45 wt % of the glass fibers in a non-woven fiber web of the second type. In some embodiments, chopped strand glass fibers make up less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, or less than or equal to 5 wt % of the glass fibers in a non-woven fiber web of the second type. Combinations of the above-referenced ranges are also possible (e.g., greater than or equal to 0 wt % and less than or equal to 50 wt %). Other ranges are also possible. In some embodiments, chopped strand glass fibers make up exactly 0 wt % of the glass fibers in a non-woven fiber web of the first type.

When a non-woven fiber web of the second type comprises two or more types of chopped strand glass fibers, each type of chopped strand glass fiber may independently make up an amount of the non-woven fiber web of the second type in one or more of the ranges described above and/or all of the chopped strand glass fibers in a non-woven fiber web of the second type may together make up an amount of the non-woven fiber web of the second type in one or more of the ranges described above. Similarly, when a filter media comprises two or more non-woven fiber webs of the second type, each non-woven fiber web of the second type may independently comprise an amount of any particular type of chopped strand glass fiber in one or more of the ranges described above and/or may comprise a total amount of chopped strand glass fibers in one or more of the ranges described above.

Chopped strand glass fibers present in non-woven fiber webs of the second type may have a variety of suitable average fiber diameters. In some embodiments, a non-woven fiber web of the second type comprises chopped strand glass fibers having an average fiber diameter of greater than or equal to 5 microns, greater than or equal to 6 microns, greater than or equal to 6.5 microns, greater than or equal to 7.5 microns, greater than or equal to 10 microns, greater than or equal to 12.5 microns, greater than or equal to 15 microns, greater than or equal to 20 microns, or greater than or equal to 25 microns. In some embodiments, a non-woven fiber web of the second type comprises chopped strand glass fibers having an average fiber diameter of less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 6.5 microns, or less than or equal to 6 microns. Combinations of the above-referenced ranges are also possible (e.g., greater than or equal to 5 microns and less than or equal to 30 microns). Other ranges are also possible.

When a non-woven fiber web of the second type comprises two or more types of chopped strand glass fibers, each type of chopped strand glass fiber may independently have an average fiber diameter in one or more of the ranges described above and/or all of the chopped strand glass fibers in a non-woven fiber web of the second type may together have an average fiber diameter in one or more of the ranges described above. Similarly, when a filter media comprises two or more non-woven fiber webs of the second type, each non-woven fiber web of the second type may independently comprise one or more types of chopped strand glass fibers having an average fiber diameter in one or more of the ranges described above and/or may comprise chopped strand glass fibers that overall have an average fiber diameter in one or more of the ranges described above.

Chopped strand glass fibers present in the non-woven fiber webs of the second type described herein may have a variety of suitable lengths. In some embodiments, a non-woven fiber web of the second type comprises chopped strand glass fibers having an average fiber length of greater than or equal to 0.1 inch, greater than or equal to 0.125 inches, greater than or equal to 0.150 inches, greater than or equal to 0.175 inches, greater than or equal to 0.2 inches, greater than or equal to 0.225 inches, greater than or equal to 0.25 inches, greater than or equal to 0.275 inches, greater than or equal to 0.3 inches, greater than or equal to 0.35 inches, greater than or equal to 0.4 inches, greater than or equal to 0.45 inches, greater than or equal to 0.5 inches, greater than or equal to 0.6 inches, greater than or equal to 0.7 inches, greater than or equal to 0.8 inches, or greater than or equal to 0.9 inches. In some embodiments, a non-woven fiber web of the second type comprises chopped strand glass fibers having an average fiber length of less than or equal to 1 inch, less than or equal to 0.9 inches, less than or equal to 0.8 inches, less than or equal to 0.7 inches, less than or equal to 0.6 inches, less than or equal to 0.5 inches, less than or equal to 0.45 inches, less than or equal to 0.4 inches, less than or equal to 0.35 inches, less than or equal to 0.3 inches, less than or equal to 0.275 inches, less than or equal to 0.25 inches, less than or equal to 0.225 inches, less than or equal to 0.2 inches, less than or equal to 0.175 inches, less than or equal to 0.15 inches, or less than or equal to 0.125 inches. Combinations of the above-referenced ranges are also possible (e.g., greater than or equal to 0.1 inch and less than or equal to 1 inch, greater than or equal to 0.125 inches and less than or equal to 1 inch, or greater than or equal to 0.25 inches and less than or equal to 0.5 inches). Other ranges are also possible.

When a non-woven fiber web of the second type comprises two or more types of chopped strand glass fibers, each type of chopped strand glass fiber may independently have an average fiber length in one or more of the ranges described above and/or all of the chopped strand glass fibers in a non-woven fiber web of the second type may together have an average fiber length in one or more of the ranges described above. Similarly, when a filter media comprises two or more non-woven fiber webs of the second type, each non-woven fiber web of the second type may independently comprise one or more types of chopped strand glass fibers having an average fiber length in one or more of the ranges described above and/or may comprise chopped strand glass fibers that overall have an average fiber length in one or more of the ranges described above.

In some embodiments, a non-woven fiber web of the second type comprises binder fibers. In some such embodiments, the binder fibers may include one type of binder fibers (e.g., monocomponent fibers, multicomponent fibers) or more than one type of binder fibers (e.g., both monocomponent fibers and multicomponent fibers, two types of monocomponent fibers, two types of multicomponent fibers). In some such embodiments, the binder fibers may serve as a binder for the non-woven fiber web that binds fibers within the web together, as disclosed elsewhere herein.

The non-woven fiber webs of the second type described herein may comprise binder fibers in a variety of suitable amounts. In some embodiments, binder fibers make up greater than or equal to 11 wt %, greater than or equal to 11.5 wt %, greater than or equal to 12 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, or greater than or equal to 75 wt % of the non-woven fiber web of the second type (inclusive of fibers and any other components present therein). In some embodiments, binder fibers make up less than or equal to 79 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 12 wt %, less than or equal to 11.5 wt %, or less than or equal to 11 wt % of the non-woven fiber web of the second type. Combinations of the above-referenced ranges are also possible (e.g., greater than or equal to 11 wt % and less than or equal to 79 wt %, greater than or equal to 20 wt % and less than or equal to 60 wt %, or greater than or equal to 20 wt % and less than or equal to 40 wt %). Other ranges are also possible.

When a non-woven fiber web of the second type comprises two or more types of binder fibers, each type of binder fiber may independently make up an amount of the non-woven fiber web of the second type in one or more of the ranges described above and/or all of the binder fibers in a non-woven fiber web of the second type may together make up an amount of the non-woven fiber web of the second type in one or more of the ranges described above. Similarly, when a filter media comprises two or more non-woven fiber webs of the second type, each non-woven fiber web of the second type may independently comprise an amount of any particular type of binder fiber in one or more of the ranges described above and/or may comprise a total amount of binder fibers in one or more of the ranges described above.

In some embodiments, a non-woven fiber web of the second type comprises binder fibers that are multicomponent fibers. Such multicomponent fibers may have compositions having one or more features of the compositions of multicomponent fibers described elsewhere herein with respect to non-woven fiber webs of the first type. It is also possible for a non-woven fiber web of the second type to comprise monocomponent binder fibers. Such binder fibers may comprise one or more of the polymers described elsewhere herein as suitable for inclusion in a component of a multicomponent fiber.

Binder fibers may have a variety of suitable average fiber diameters. In some embodiments, a non-woven fiber web of the second type comprises binder fibers having an average fiber diameter of greater than or equal to 1 micron, greater than or equal to 2 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 30 microns, greater than or equal to 40 microns, greater than or equal to 50 microns, greater than or equal to 60 microns, greater than or equal to 70 microns, greater than or equal to 80 microns, or greater than or equal to 90 microns. In some embodiments, a non-woven fiber web of the second type comprises binder fibers having an average fiber diameter of less than or equal to 100 microns, less than or equal to 90 microns, less than or equal to 80 microns, less than or equal to 70 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2 microns, or less than or equal to 1 micron. Combinations of the above-referenced ranges are also possible (e.g., greater than or equal to 1 micron and less than or equal to 100 microns, greater than or equal to 2 microns and less than or equal to 50 microns, greater than or equal to 5 microns and less than or equal to 20 microns, or greater than or equal to 1 micron and less than or equal to 20 microns). Other ranges are also possible.

When a non-woven fiber web of the second type comprises two or more types of binder fibers, each type of binder fiber may independently have an average fiber diameter in one or more of the ranges described above and/or all of the binder fibers in a non-woven fiber web of the second type may together have an average fiber diameter in one or more of the ranges described above. Similarly, when a filter media comprises two or more non-woven fiber webs of the second type, each non-woven fiber web of the second type may independently comprise one or more types of binder fibers having an average fiber diameter in one or more of the ranges described above and/or may comprise binder fibers that overall have an average fiber diameter in one or more of the ranges described above.

Binder fibers may have a variety of suitable average fiber lengths. In some embodiments, a non-woven fiber web of the second type comprises binder fibers having an average fiber length of greater than or equal to 0.02 inches, greater than or equal to 0.04 inches, greater than or equal to 0.06 inches, greater than or equal to 0.08 inches, greater than or equal to 0.1 inch, greater than or equal to 0.12 inches, greater than or equal to 0.16 inches, greater than or equal to 0.18 inches, greater than or equal to 0.2 inches, greater than or equal to 0.25 inches, greater than or equal to 0.3 inches, greater than or equal to 0.35 inches, greater than or equal to 0.4 inches, greater than or equal to 0.45 inches, greater than or equal to 0.5 inches, greater than or equal to 0.6 inches, greater than or equal to 0.7 inches, greater than or equal to 0.8 inches, greater than or equal to 0.9 inches, greater than or equal to 1 inch, greater than or equal to 1.1 inches, greater than or equal to 1.2 inches, greater than or equal to 1.3 inches, or greater than or equal to 1.4 inches. In some embodiments, a non-woven fiber web of the second type comprises binder fibers having an average fiber length of less than or equal to 1.5 inches, less than or equal to 1.4 inches, less than or equal to 1.3 inches, less than or equal to 1.2 inches, less than or equal to 1.1 inches, less than or equal to 1 inch, less than or equal to 0.9 inches, less than or equal to 0.8 inches, less than or equal to 0.7 inches, less than or equal to 0.6 inches, less than or equal to 0.5 inches, less than or equal to 0.4 inches, less than or equal to 0.3 inches, less than or equal to 0.2 inches, less than or equal to 0.15 inches, less than or equal to 0.1 inch, less than or equal to 0.08 inches, less than or equal to 0.06 inches, less than or equal to 0.04 inches, or less than or equal to 0.03 inches. Combinations of the above-referenced ranges are also possible (e.g., greater than or equal to 0.02 inches and less than or equal to 1.5 inches, greater than or equal to 0.1 inch and less than or equal to 1 inch, or greater than or equal to 0.2 inches and less than or equal to 0.5 inches). Other ranges are also possible.

When a non-woven fiber web of the second type comprises two or more types of binder fibers, each type of binder fiber may independently have an average fiber length in one or more of the ranges described above and/or all of the binder fibers in a non-woven fiber web of the second type may together have an average fiber length in one or more of the ranges described above. Similarly, when a filter media comprises two or more non-woven fiber webs of the second type, each non-woven fiber web of the second type may independently comprise one or more types of binder fibers having an average fiber length in one or more of the ranges described above and/or may comprise binder fibers that overall have an average fiber length in one or more of the ranges described above.

In some embodiments, a non-woven fiber web of the second type comprises both fibrillated fibers and glass fibers. In such embodiments, the relative amounts of both of these types of fibers may generally be selected as desired. In some embodiments, the weight ratio of fibrillated fibers to glass fibers may be greater than or equal to 1:50, greater than or equal to 1:45, greater than or equal to 1:40, greater than or equal to 1:30, greater than or equal to 1:20, greater than or equal to 1:15, greater than or equal to 1:10, greater than or equal to 1:7, greater than or equal to 1:6, greater than or equal to 1:5, greater than or equal to 1:4, greater than or equal to 1:3, greater than or equal to 2:5, greater than or equal to 1:2, greater than or equal to 3:4, greater than or equal to 1:1, greater than or equal to 4:3, greater than or equal to 2:1, greater than or equal to 5:2, greater than or equal to 3:1, greater than or equal to 4:1, greater than or equal to 5:1, greater than or equal to 6:1, greater than or equal to 7:1, greater than or equal to 8:1, greater than or equal to 10:1, greater than or equal to 15:1, greater than or equal to 20:1, greater than or equal to 30:1, greater than or equal to 40:1, or greater than or equal to 45:1. In some embodiments, the weight ratio of fibrillated fibers to glass fibers may be less than or equal to 50:1, less than or equal to 45:1, less than or equal to 40:1, less than or equal to 30:1, less than or equal to 20:1, less than or equal to 15:1, less than or equal to 10:1, less than or equal to 7:1, less than or equal to 6:1, less than or equal to 5:1, less than or equal to 4:1, less than or equal to 3:1, less than or equal to 5:2, less than or equal to 2:1, less than or equal to 4:3, less than or equal to 1:1, less than or equal to 3:4, less than or equal to 1:2, less than or equal to 2:5, less than or equal to 1:3, less than or equal to 1:4, less than or equal to 1:5, less than or equal to 1:6, less than or equal to 1:7, less than or equal to 1:8, less than or equal to 1:10, less than or equal to 1:15, less than or equal to 1:20, less than or equal to 1:25, less than or equal to 1:30, or less than or equal to 1:40. Combinations of the above-referenced ranges are also possible (e.g., greater than or equal to 1:50 and less than or equal to 50:1, greater than or equal to 1:20 and less than or equal to 20:1, or greater than or equal to 1:5 and less than or equal to 5:1). Other ranges are also possible.

When a filter media comprises two or more non-woven fiber webs of the second type, each non-woven fiber web of the second type may have a weight ratio of fibrillated fibers to glass fibers in one or more of the ranges described above.

In some embodiments, binder resins may be included in the non-woven fiber webs of the second type described herein. In some embodiments, a binder resin makes up greater than or equal to 0 wt %, greater than or equal to 1 wt %, greater than or equal to 2 wt %, greater than or equal to 3 wt %, greater than or equal to 5 wt %, greater than or equal to 7.5 wt %, greater than or equal to 10 wt %, greater than or equal to 12.5 wt %, greater than or equal to 15 wt %, or greater than or equal to 17.5 wt % of a non-woven fiber web of the second type. In some embodiments, a binder resin makes up less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 3 wt %, less than or equal to 2 wt %, or less than or equal to 1 wt % of a non-woven fiber web of the second type. Combinations of the above-referenced ranges are also possible (e.g., greater than or equal to 0 wt % and less than or equal to 20 wt %). Other ranges are also possible. In some embodiments, a binder resin makes up 0 wt % of a non-woven fiber web of the second type.

When a non-woven fiber web of the second type comprises two or more types of binder resin, each type of binder resin may independently make up an amount of the non-woven fiber web of the second type in one or more of the ranges described above and/or all of the binder resin in a non-woven fiber web of the second type may together make up an amount of the non-woven fiber web in one or more of the ranges described above. Similarly, when a filter media comprises two or more non-woven fiber webs of the second type, each non-woven fiber web of the second type may independently comprise an amount of any particular type of binder resin in one or more of the ranges described above and/or may comprise a total amount of binder resin in one or more of the ranges described above.

The non-woven fiber webs of the second type described herein may have a variety of suitable basis weights. In some embodiments, a non-woven fiber web of the second type has a basis weight of greater than or equal to 10 gsm, greater than or equal to 15 gsm, greater than or equal to 20 gsm, greater than or equal to 25 gsm, greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 125 gsm, greater than or equal to 150 gsm, greater than or equal to 175 gsm, greater than or equal to 200 gsm, greater than or equal to 225 gsm, greater than or equal to 250 gsm, greater than or equal to 275 gsm, greater than or equal to 300 gsm, greater than or equal to 350 gsm, greater than or equal to 400 gsm, greater than or equal to 500 gsm, or greater than or equal to 750 gsm. In some embodiments, a non-woven fiber web of the second type has a basis weight of less than or equal to 1000 gsm, less than or equal to 750 gsm, less than or equal to 500 gsm, less than or equal to 400 gsm, less than or equal to 450 gsm, less than or equal to 300 gsm, less than or equal to 275 gsm, less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, less than or equal to 30 gsm, less than or equal to 25 gsm, less than or equal to 20 gsm, less than or equal to 15 gsm, or less than or equal to 10 gsm. Combinations of the above-referenced ranges are also possible (e.g., greater than or equal to 10 gsm and less than or equal to 1000 gsm, greater than or equal to 20 gsm and less than or equal to 500 gsm, or greater than or equal to 40 gsm and less than or equal to 300 gsm). Other ranges are also possible.

The basis weight of a non-woven fiber web of the second type may be determined in accordance with ISO 536:2012. The basis weight of the non-woven fiber web of a second type may be determined when the non-woven fiber web of the second type is in the form that it takes in the filter media (e.g., in a form that comprises one or more pluralities of undulations, such as a second plurality of undulations positioned within a first plurality of undulations).

When a filter media comprises two or more non-woven fiber webs of the second type, each non-woven fiber web of the second type may independently have a basis weight in one or more of the above-referenced ranges.

The non-woven fiber webs of the second type described herein may have a variety of suitable thicknesses. In some embodiments, a non-woven fiber web of the second type has a thickness of greater than or equal to 0.1 mm, greater than or equal to 0.15 mm, greater than or equal to 0.2 mm, greater than or equal to 0.25 mm, greater than or equal to 0.3 mm, greater than or equal to 0.4 mm, greater than or equal to 0.5 mm, greater than or equal to 0.6 mm, greater than or equal to 0.7 mm, greater than or equal to 0.8 mm, greater than or equal to 0.9 mm, greater than or equal to 1 mm, greater than or equal to 1.1 mm, greater than or equal to 1.2 mm, greater than or equal to 1.3 mm, greater than or equal to 1.4 mm, greater than or equal to 1.5 mm, greater than or equal to 1.6 mm, greater than or equal to 1.7 mm, greater than or equal to 1.8 mm, greater than or equal to 1.9 mm, greater than or equal to 2 mm, greater than or equal to 2.25 mm, greater than or equal to 2.5 mm, greater than or equal to 3 mm, greater than or equal to 4 mm, greater than or equal to 5 mm, or greater than or equal to 7.5 mm. In some embodiments, a non-woven fiber web of the second type has a thickness of less than or equal to 10 mm, less than or equal to 7.5 mm, less than or equal to 5 mm, less than or equal to 4 mm, less than or equal to 3 mm, less than or equal to 2.5 mm, less than or equal to 2.25 mm, less than or equal to 2 mm, less than or equal to 1.9 mm, less than or equal to 1.8 mm, less than or equal to 1.7 mm, less than or equal to 1.6 mm, less than or equal to 1.5 mm, less than or equal to 1.4 mm, less than or equal to 1.3 mm, less than or equal to 1.2 mm, less than or equal to 1.1 mm, less than or equal to 1 mm, less than or equal to 0.9 mm, less than or equal to 0.8 mm, less than or equal to 0.7 mm, less than or equal to 0.6 mm, less than or equal to 0.5 mm, less than or equal to 0.4 mm, less than or equal to 0.3 mm, less than or equal to 0.2 mm, or less than or equal to 0.15 mm. Combinations of the above-referenced ranges are also possible (e.g., greater than or equal to 0.1 mm and less than or equal to 10 mm, greater than or equal to 0.2 mm and less than or equal to 2 mm, or greater than or equal to 0.3 mm and less than or equal to 1.5 mm). Other ranges are also possible.

The thickness of a non-woven fiber web of the second type may be determined in accordance with ASTM D1777 (2015) under an applied pressure of 0.2 kPa. The thickness of a non-woven fiber web of the second type may be determined when the non-woven fiber web of the second type is in the form that it takes in the filter media (e.g., in a form that comprises one or more pluralities of undulations, such as a second plurality of undulations positioned within a first plurality of undulations).

When a filter media comprises two or more non-woven fiber webs of the second type, each non-woven fiber web of the second type may independently have a thickness in one or more of the above-referenced ranges.

In some embodiments, a non-woven fiber web of the second type has a variety of suitable apparent densities. The apparent density of a non-woven fiber web of the second type may be less than or equal to 3000 gsm/mm, less than or equal to 2500 gsm/mm, less than or equal to 2000 gsm/mm, less than or equal to 1500 gsm/mm, less than or equal to 1000 gsm/mm, less than or equal to 900 gsm/mm, less than or equal to 800 gsm/mm, less than or equal to 700 gsm/mm, less than or equal to 600 gsm/mm, less than or equal to 500 gsm/mm, less than or equal to 400 gsm/mm, less than or equal to 300 gsm/mm, less than or equal to 200 gsm/mm, less than or equal to 150 gsm/mm, less than or equal to 100 gsm/mm, less than or equal to 90 gsm/mm, less than or equal to 80 gsm/mm, less than or equal to 70 gsm/mm, less than or equal to 75 gsm/mm, less than or equal to 60 gsm/mm, less than or equal to 50 gsm/mm, less than or equal to 25 gsm/mm, or less than or equal to 10 gsm/mm. The apparent density of a non-woven fiber web of the second type may be greater than or equal to 5 gsm/mm, greater than or equal to 10 gsm/mm, greater than or equal to 10 gsm/mm, greater than or equal to 25 gsm/mm, greater than or equal to 50 gsm/mm, greater than or equal to 60 gsm/mm, greater than or equal to 70 gsm/mm, greater than or equal to 80 gsm/mm, greater than or equal to 90 gsm/mm, greater than or equal to 100 gsm/mm, greater than or equal to 150 gsm/mm, greater than or equal to 200 gsm/mm, greater than or equal to 300 gsm/mm, greater than or equal to 400 gsm/mm, greater than or equal to 500 gsm/mm, greater than or equal to 600 gsm/mm, greater than or equal to 700 gsm/mm, greater than or equal to 800 gsm/mm, greater than or equal to 900 gsm/mm, greater than or equal to 1000 gsm/mm, greater than or equal to 1500 gsm/mm, greater than or equal to 2000 gsm/mm, or greater than or equal to 2500 gsm/mm. Combinations of the above-referenced ranges are also possible (e.g., less than or equal to 3000 gsm/mm and greater than or equal to 5 gsm/mm, less than or equal to 1000 gsm/mm and greater than or equal to 100 gsm/mm, less than or equal to 800 gsm/mm and greater than or equal to 50 gsm/mm, less than or equal to 800 gsm/mm and greater than or equal to 150 gsm/mm, less than or equal to 500 gsm/mm and greater than or equal to 100 gsm/mm, or less than or equal to 300 gsm/mm and greater than or equal to 150 gsm/mm). Other ranges are also possible.

The apparent density of a non-woven fiber web of the second type may be determined by dividing the density of the non-woven fiber web of the second type by the thickness of the non-woven fiber web of the second type. The apparent density of a non-woven fiber web of the second type may be determined when the non-woven fiber web of the second type is in the form that it takes in the filter media (e.g., in a form that comprises one or more pluralities of undulations, such as a second plurality of undulations positioned within a first plurality of undulations).

When a filter media comprises two or more non-woven fiber webs of the second type, each non-woven fiber web of the second type may independently have an apparent density in one or more of the above-referenced ranges.

The non-woven fiber webs of the second type described herein may have a variety of suitable mean flow pore sizes. The mean flow pore size of a non-woven fiber web of the second type may be greater than or equal to 0.1 micron, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 20 microns, greater than or equal to 40 microns, greater than or equal to 60 microns, greater than or equal to 80 microns, greater than or equal to 100 microns, or greater than or equal to 125 microns. The mean flow pore size of a non-woven fiber web of the second type may be less than or equal to 150 microns, less than or equal to 100 microns, less than or equal to 80 microns, less than or equal to 60 microns, less than or equal to 40 microns, less than or equal to 20 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 micron and less than or equal to 150 microns, greater than or equal to 1 micron and less than or equal to 100 microns, or greater than or equal to 1 micron and less than or equal to 60 microns). Other ranges are also possible.

The mean flow pore size of a non-woven fiber web of the second type may be determined in accordance with ASTM F316 (2003). The mean flow pore size of a non-woven fiber web of the second type may be determined when the non-woven fiber web of the second type is in the form that it takes in the filter media (e.g., in a form that comprises one or more pluralities of undulations, such as a second plurality of undulations positioned within a first plurality of undulations).

When a filter media comprises two or more non-woven fiber webs of the second type, each non-woven fiber web of the second type may independently have a mean flow pore size in one or more of the above-referenced ranges.

The non-woven fiber webs of the second type described herein may have any suitable solidity values. In some embodiments, a non-woven fiber web of the second type has a solidity of greater than or equal to 0.001%, greater than or equal to 0.002%, greater than or equal to 0.004%, greater than or equal to 0.006%, greater than or equal to 0.008%, greater than or equal to 0.01%, greater than or equal to 0.02%, greater than or equal to 0.04%, greater than or equal to 0.06%, greater than or equal to 0.08%, greater than or equal to 0.1%, greater than or equal to 0.5%, greater than or equal to 1%, greater than or equal to 5%, greater than or equal to 10%, greater than or equal to 15%, greater than or equal to 20%, greater than or equal to 25%, greater than or equal to 30%, greater than or equal to 35%, greater than or equal to 40%, or greater than or equal to 45%. The solidity of a non-woven fiber web of the second type may be less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, less than or equal to 5%, less than or equal to 1%, less than or equal to 0.5%, less than or equal to 0.1%, less than or equal to 0.08%, less than or equal to 0.06%, less than or equal to 0.04%, less than or equal to 0.02%, less than or equal to 0.01%, less than or equal to 0.008%, less than or equal to 0.006%, less than or equal to 0.004%, or less than or equal to 0.002%. Combinations of the above-referenced ranges are also possible (e.g., greater than or equal to 0.001% and less than or equal to 50%, greater than or equal to 0.01% and less than or equal to 40%, or greater than or equal to 0.1% and less than or equal to 30%). Other ranges are also possible.

The solidity of a non-woven fiber web of the second type may be determined as described elsewhere herein with respect to the determination of the solidity of a support layer. The solidity of a non-woven fiber web of the second type may be determined when the non-woven fiber web of the second type is in the form that it takes in the filter media (e.g., in a form that comprises one or more pluralities of undulations, such as a second plurality of undulations positioned within a first plurality of undulations).

When a filter media comprises two or more non-woven fiber webs of the second type, each non-woven fiber web of the second type may independently have a solidity in one or more of the above-referenced ranges.

The non-woven fiber webs of the second type described herein may have a variety of suitable air permeabilities. In some embodiments, a non-woven fiber web of the second type has an air permeability of greater than or equal to 1 CFM, greater than or equal to 2 CFM, greater than or equal to 5 CFM, greater than or equal to 7.5 CFM, greater than or equal to 10 CFM, greater than or equal to 20 CFM, greater than or equal to 50 CFM, greater than or equal to 75 CFM, greater than or equal to 100 CFM, greater than or equal to 125 CFM, greater than or equal to 150 CFM, greater than or equal to 175 CFM, greater than or equal to 200 CFM, greater than or equal to 225 CFM, greater than or equal to 250 CFM, greater than or equal to 275 CFM, greater than or equal to 300 CFM, greater than or equal to 325 CFM, greater than or equal to 350 CFM, greater than or equal to 375 CFM, greater than or equal to 400 CFM, greater than or equal to 450 CFM, greater than or equal to 500 CFM, greater than or equal to 600 CFM, greater than or equal to 700 CFM, or greater than or equal to 800 CFM. In some embodiments, a non-woven fiber web of the second type has an air permeability of less than or equal to 1000 CFM, less than or equal to 800 CFM, less than or equal to 700 CFM, less than or equal to 600 CFM, less than or equal to 500 CFM, less than or equal to 450 CFM, less than or equal to 400 CFM, less than or equal to 375 CFM, less than or equal to 350 CFM, less than or equal to 325 CFM, less than or equal to 300 CFM, less than or equal to 275 CFM, less than or equal to 250 CFM, less than or equal to 225 CFM, less than or equal to 200 CFM, less than or equal to 175 CFM, less than or equal to 150 CFM, less than or equal to 125 CFM, less than or equal to 100 CFM, less than or equal to 75 CFM, less than or equal to 50 CFM, less than or equal to 20 CFM, less than or equal to 10 CFM, less than or equal to 7.5 CFM, less than or equal to 5 CFM, or less than or equal to 2 CFM. Combinations of the above-referenced ranges are also possible (e.g., greater than or equal to 1 CFM and less than or equal to 1000 CFM, greater than or equal to 2 CFM and less than or equal to 500 CFM, or greater than or equal to 5 CFM and less than or equal to 200 CFM). Other ranges are also possible.

The air permeability of a non-woven fiber web of the second type may be determined in accordance with ASTM D737-04 (2016) at a pressure of 125 Pa. The air permeability of a non-woven fiber web of the second type may be determined when the non-woven fiber web of the second type is in the form that it takes in the filter media (e.g., in a form that comprises one or more pluralities of undulations, such as a second plurality of undulations positioned within a first plurality of undulations).

When a filter media comprises two or more non-woven fiber webs of the second type, each non-woven fiber web of the second type may independently have an air permeability in one or more of the above-referenced ranges.

Some non-woven fiber webs of the second type described herein may have relatively high values of dry Mullen burst strength. The dry Mullen burst strength of a non-woven fiber web of the second type may be greater than or equal to 1 psi, greater than or equal to 2 psi, greater than or equal to 3 psi, greater than or equal to 4 psi, greater than or equal to 5 psi, greater than or equal to 6 psi, greater than or equal to 7 psi, greater than or equal to 8 psi, greater than or equal to 10 psi, greater than or equal to 15 psi, greater than or equal to 20 psi, greater than or equal to 30 psi, greater than or equal to 40 psi, greater than or equal to 50 psi, greater than or equal to 60 psi, greater than or equal to 70 psi, greater than or equal to 80 psi, greater than or equal to 90 psi, greater than or equal to 100 psi, or greater than or equal to 125 psi. The dry Mullen burst strength of a non-woven fiber web of the second type may be less than or equal to 150 psi, less than or equal to 125 psi, less than or equal to 100 psi, less than or equal to 90 psi, less than or equal to 80 psi, less than or equal to 70 psi, less than or equal to 60 psi, less than or equal to 50 psi, less than or equal to 40 psi, less than or equal to 30 psi, less than or equal to 20 psi, less than or equal to 15 psi, less than or equal to 10 psi, less than or equal to 8 psi, less than or equal to 7 psi, less than or equal to 6 psi, less than or equal to 5 psi, less than or equal to 4 psi, less than or equal to 3 psi, or less than or equal to 2 psi. Combinations of the above-referenced ranges are also possible (e.g., greater than or equal to 1 psi and less than or equal to 150 psi, greater than or equal to 5 psi and less than or equal to 100 psi, or greater than or equal to 8 psi and less than or equal to 60 psi). Other ranges are also possible.

The dry Mullen burst strength of a non-woven fiber web of the second type may be determined in accordance with the standard TAPPI T403 (1997) test. The dry Mullen burst strength of a non-woven fiber web of the second type may be determined when the non-woven fiber web of the second type is in the form that it takes in the filter media (e.g., in a form that comprises one or more pluralities of undulations, such as a second plurality of undulations positioned within a first plurality of undulations).

When a filter media comprises two or more non-woven fiber webs of the second type, each non-woven fiber web of the second type may independently have a dry Mullen burst strength in one or more of the above-referenced ranges.

The non-woven fiber webs of the second type described herein may have relatively high values of dry tensile strength in the machine direction. A non-woven fiber web of the second type may have a dry tensile strength in the machine direction of greater than or equal to 1 lb/in, greater than or equal to 2 lb/in, greater than or equal to 3 lb/in, greater than or equal to 4 lb/in, greater than or equal to 5 lb/in, greater than or equal to 7.5 lb/in, greater than or equal to 10 lb/in, greater than or equal to 15 lb/in, greater than or equal to 20 lb/in, greater than or equal to 25 lb/in, greater than or equal to 30 lb/in, greater than or equal to 35 lb/in, greater than or equal to 40 lb/in, greater than or equal to 45 lb/in, greater than or equal to 50 lb/in, greater than or equal to 60 lb/in, or greater than or equal to 70 lb/in. A non-woven fiber web of the second type may have a dry tensile strength in the machine direction of less than or equal to 80 lb/in, less than or equal to 70 lb/in, less than or equal to 60 lb/in, less than or equal to 50 lb/in, less than or equal to 45 lb/in, less than or equal to 40 lb/in, less than or equal to 35 lb/in, less than or equal to 30 lb/in, less than or equal to 25 lb/in, less than or equal to 20 lb/in, less than or equal to 15 lb/in, less than or equal to 10 lb/in, less than or equal to 7.5 lb/in, less than or equal to 5 lb/in, less than or equal to 4 lb/in, less than or equal to 3 lb/in, or less than or equal to 2 lb/in. Combinations of the above-referenced ranges are also possible (e.g., greater than or equal to 1 lb/in and less than or equal to 80 lb/in, greater than or equal to 1 lb/in and less than or equal to 40 lb/in, or greater than or equal to 4 lb/in and less than or equal to 20 lb/in). Other ranges are also possible.

The dry tensile strength in the machine direction of a non-woven fiber web of the second type may be determined in accordance with the standard T494 om-96 (1996) test using a test span of 5 inches and a jaw separation speed of 12 in/min. The dry tensile strengths of a non-woven fiber web of the second type may be determined when the non-woven fiber web of the second type is in the form that it takes in the filter media (e.g., in a form that comprises one or more pluralities of undulations, such as a second plurality of undulations positioned within a first plurality of undulations).

When a filter media comprises two or more non-woven fiber webs of the second type, each non-woven fiber web of the second type may independently have a dry tensile strength in the machine direction in one or more of the above-referenced ranges. Similarly, when a filter media comprises two or more non-woven fiber webs of the second type, each non-woven fiber web of the second type may independently have a dry tensile strength in the cross direction in one or more of the above-referenced ranges.

The non-woven fiber webs of the second type described herein may have relatively high values of dry tensile strength in the cross direction. A non-woven fiber web of the second type may have a dry tensile strength in the cross direction of greater than or equal to 1 lb/in, greater than or equal to 2 lb/in, greater than or equal to 3 lb/in, greater than or equal to 4 lb/in, greater than or equal to 5 lb/in, greater than or equal to 7.5 lb/in, greater than or equal to 10 lb/in, greater than or equal to 15 lb/in, greater than or equal to 20 lb/in, greater than or equal to 25 lb/in, greater than or equal to 30 lb/in, greater than or equal to 35 lb/in, greater than or equal to 40 lb/in, greater than or equal to 45 lb/in, or greater than or equal to 50 lb/in. A non-woven fiber web of the second type may have a dry tensile strength in the cross direction of less than or equal to 60 lb/in, less than or equal to 50 lb/in, less than or equal to 45 lb/in, less than or equal to 40 lb/in, less than or equal to 35 lb/in, less than or equal to 30 lb/in, less than or equal to 25 lb/in, less than or equal to 20 lb/in, less than or equal to 15 lb/in, less than or equal to 10 lb/in, less than or equal to 7.5 lb/in, less than or equal to 5 lb/in, less than or equal to 4 lb/in, less than or equal to 3 lb/in, or less than or equal to 2 lb/in. Combinations of the above-referenced ranges are also possible (e.g., greater than or equal to 1 lb/in and less than or equal to 60 lb/in, greater than or equal to 1 lb/in and less than or equal to 30 lb/in, or greater than or equal to 4 lb/in and less than or equal to 20 lb/in). Other ranges are also possible.

The dry tensile strengths in the cross direction of a non-woven fiber web of the second type may be determined in accordance with the standard T494 om-96 (1996) test using a test span of 5 inches and a jaw separation speed of 12 in/min.

When a filter media comprises two or more non-woven fiber webs of the second type, each non-woven fiber web of the second type may independently have a dry tensile strength in the cross direction in one or more of the above-referenced ranges.

The non-woven fiber webs of the second type described herein may have relatively high values of stiffness in the cross direction. A non-woven fiber web of the second type may have a stiffness in the cross direction of greater than or equal to 80 mg, greater than or equal to 90 mg, greater than or equal to 100 mg, greater than or equal to 125 mg, greater than or equal to 150 mg, greater than or equal to 175 mg, greater than or equal to 200 mg, greater than or equal to 250 mg, greater than or equal to 300 mg, greater than or equal to 400 mg, greater than or equal to 500 mg, greater than or equal to 750 mg, greater than or equal to 1000 mg, greater than or equal to 1250 mg, greater than or equal to 1500 mg, greater than or equal to 1750 mg, greater than or equal to 2000 mg, greater than or equal to 2500 mg, greater than or equal to 3000 mg, or greater than or equal to 4000 mg. A non-woven fiber web of the second type may have a stiffness in the cross direction of less than or equal to 5000 mg, less than or equal to 3000 mg, less than or equal to 2500 mg, less than or equal to 2000 mg, less than or equal to 1750 mg, less than or equal to 1500 mg, less than or equal to 1250 mg, less than or equal to 1000 mg, less than or equal to 750 mg, less than or equal to 500 mg, less than or equal to 400 mg, less than or equal to 300 mg, less than or equal to 250 mg, less than or equal to 200 mg, less than or equal to 175 mg, less than or equal to 150 mg, less than or equal to 125 mg, less than or equal to 100 mg, or less than or equal to 90 mg. Combinations of the above-referenced ranges are also possible (e.g., greater than or equal to 80 mg and less than or equal to 5000 mg, greater than or equal to 100 mg and less than or equal to 3000 mg, or greater than or equal to 300 mg and less than or equal to 2000 mg). Other ranges are also possible.

The stiffness in the cross direction of a non-woven fiber web of the second type may be determined in accordance with TAPPI T543 om-05 (2005) using a sample size of 2 in×2.5 in.

When a filter media comprises two or more non-woven fiber webs of the second type, each non-woven fiber web of the second type may independently have a stiffness in the cross direction one or more of the above-referenced ranges.

The non-woven fiber webs of the second type described herein may have a variety of suitable fuel gamma values. The fuel gamma value of a non-woven fiber web is a rating of liquid filtration performance that is based on the relationship between filtration efficiency, dust holding capacity, and air permeability of non-woven fiber web. Generally, higher fuel gamma values are indicative of better filter performance. Fuel gamma is a dimensionless value defined by the following formula:

$$Fuel Gamma = \frac{\{ - {log}_{10} [ ( 100 - Efficiency ) / 100 ] \} * ( Specific DHC / Apparent Density )}{( \frac{Face velocity}{Air Permeability} )}$$

where the efficiency is the efficiency at 4 microns, specific DHC is measured in kg/m³ and can be calculated by dividing the dust holding capacity by fiber web thickness, face velocity is measured in cm/s, air permeability is measured in cm/s, and density is the apparent density of the fiber web measured in units of kg/m³. The efficiency and dust holding capacity of a non-woven fiber web may be determined by performing a Multipass Filter Test in accordance with ISO 19438 (2013). The relevant dust holding capacity for this equation is the injected dust holding capacity. Additionally, the face velocity during this test is equivalent to the face velocity in the equation shown above. It should be noted that the non-woven fiber webs described herein may be characterized by both an initial fuel gamma and an overall fuel gamma. For the initial fuel gamma, the initial efficiency is employed in the equation above. For the overall fuel gamma, the overall efficiency is employed in the equation above.

The Multipass Filter Test comprises exposing the fiber web to Mobil Aero HFA Aviation Hydraulic Fluid in which ISO12103-A3 Medium grade test dust manufactured by FTI is suspended. The test may be performed at 50 mg/L base upstream gravimetric level (BUGL), a face velocity of 0.06 cm/s, and a flow rate of 1 L/min following the ISO 19438 (2013) procedure. This test may be performed until a 100 kPa terminal pressure drop is achieved. The initial efficiency is an average of the efficiencies measured at 4, 5, and 6 minutes after running the test. The overall efficiency is the average efficiency that is measured over the course of the entire test (i.e., from the beginning of the test until the 100 kPa terminal pressure drop is achieved).

In some embodiments, a fiber web of the second type described herein has a relatively high initial fuel gamma value. The initial fuel gamma value of a non-woven fiber web of the second type may be greater than or equal to 50, greater than or equal to 55, greater than or equal to 60, greater than or equal to 65, greater than or equal to 70, greater than or equal to 75, greater than or equal to 80, greater than or equal to 85, greater than or equal to 90, greater than or equal to 95, greater than or equal to 100, greater than or equal to 125, greater than or equal to 140, greater than or equal to 160, greater than or equal to 180, greater than or equal to 200, greater than or equal to 220, greater than or equal to 240, greater than or equal to 260, greater than or equal to 280, greater than or equal to 300, greater than or equal to 325, greater than or equal to 350, greater than or equal to 375, greater than or equal to 400, greater than or equal to 450, greater than or equal to 500, greater than or equal to 550, greater than or equal to 600, greater than or equal to 650, greater than or equal to 700, greater than or equal to 750, greater than or equal to 800, greater than or equal to 850, greater than or equal to 900, greater than or equal to 950, greater than or equal to 1000, greater than or equal to 2000, greater than or equal to 5000, or greater than or equal to 8000. The initial fuel gamma value of a non-woven fiber web of the second type may be less than or equal to 10000, less than or equal to 8000, less than or equal to 5000, less than or equal to 2000, less than or equal to 1000, less than or equal to 950, less than or equal to 900, less than or equal to 850, less than or equal to 800, less than or equal to 750, less than or equal to 700, less than or equal to 650, less than or equal to 600, less than or equal to 550, less than or equal to 500, less than or equal to 450, less than or equal to 400, less than or equal to 375, less than or equal to 350, less than or equal to 325, less than or equal to 300, less than or equal to 280, less than or equal to 260, less than or equal to 240, less than or equal to 220, less than or equal to 200, less than or equal to 180, less than or equal to 160, less than or equal to 140, less than or equal to 125, less than or equal to 100, less than or equal to 95, less than or equal to 90, less than or equal to 85, less than or equal to 80, less than or equal to 75, less than or equal to 70, less than or equal to 65, less than or equal to 60, or less than or equal to 55. Combinations of the above-referenced ranges are also possible (e.g., greater than or equal to 50 and less than or equal to 10000, greater than or equal to 75 and less than or equal to 8000, or greater than or equal to 125 and less than or equal to 5000). Other ranges are also possible.

When a filter media comprises two or more non-woven fiber webs of the second type, each non-woven fiber web of the second type may independently have an initial fuel gamma in one or more of the above-referenced ranges. The initial fuel gamma of a non-woven fiber web of the second type may be determined when the non-woven fiber web of the second type is in the form that it takes in the filter media (e.g., in a form that comprises one or more pluralities of undulations, such as a second plurality of undulations positioned within a first plurality of undulations).

In some embodiments, a fiber web of the second type described herein has a relatively high overall fuel gamma value. The overall fuel gamma value of a non-woven fiber web of the second type may be greater than or equal to 50, greater than or equal to 55, greater than or equal to 60, greater than or equal to 65, greater than or equal to 70, greater than or equal to 75, greater than or equal to 80, greater than or equal to 85, greater than or equal to 90, greater than or equal to 95, greater than or equal to 100, greater than or equal to 120, greater than or equal to 140, greater than or equal to 160, greater than or equal to 180, greater than or equal to 200, greater than or equal to 220, greater than or equal to 240, greater than or equal to 260, greater than or equal to 280, greater than or equal to 300, greater than or equal to 325, greater than or equal to 350, greater than or equal to 375, greater than or equal to 400, greater than or equal to 450, greater than or equal to 500, greater than or equal to 550, greater than or equal to 600, greater than or equal to 650, greater than or equal to 700, greater than or equal to 750, greater than or equal to 800, greater than or equal to 850, greater than or equal to 900, or greater than or equal to 950. The overall fuel gamma value of a non-woven fiber web of the second type may be less than or equal to 1000, less than or equal to 950, less than or equal to 900, less than or equal to 850, less than or equal to 800, less than or equal to 750, less than or equal to 700, less than or equal to 650, less than or equal to 600, less than or equal to 550, less than or equal to 500, less than or equal to 450, less than or equal to 400, less than or equal to 375, less than or equal to 350, less than or equal to 325, less than or equal to 300, less than or equal to 280, less than or equal to 260, less than or equal to 240, less than or equal to 220, less than or equal to 200, less than or equal to 180, less than or equal to 160, less than or equal to 140, less than or equal to 120, less than or equal to 100, less than or equal to 95, less than or equal to 90, less than or equal to 85, less than or equal to 80, less than or equal to 75, less than or equal to 70, less than or equal to 65, less than or equal to 60, or less than or equal to 55. Combinations of the above-referenced ranges are also possible (e.g., greater than or equal to 50 and less than or equal to 1000, greater than or equal to 75 and less than or equal to 500, or greater than or equal to 120 and less than or equal to 300). Other ranges are also possible.

When a filter media comprises two or more non-woven fiber webs of the second type, each non-woven fiber web of the second type may independently have an overall fuel gamma in one or more of the above-referenced ranges. The overall fuel gamma of a non-woven fiber web of the second type may be determined when the non-woven fiber web of the second type is in the form that it takes in the filter media (e.g., in a form that comprises one or more pluralities of undulations, such as a second plurality of undulations positioned within a first plurality of undulations).

The non-woven fiber webs of the second type described herein may have a relatively high initial efficiency at 4 microns. The initial efficiency at 4 microns of a non-woven fiber web of the second type may be greater than or equal to 10%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, greater than or equal to 95%, greater than or equal to 97%, greater than or equal to 98%, greater than or equal to 99%, greater than or equal to 99.5%, greater than or equal to 99.6%, greater than or equal to 99.7%, greater than or equal to 99.8%, greater than or equal to 99.9%, greater than or equal to 99.95%, greater than or equal to 99.99%, or greater than or equal to 99.999%. The initial efficiency at 4 microns of a non-woven fiber web of the second type may be less than or equal to 100%, less than or equal to 99.999%, less than or equal to 99.99%, less than or equal to 99.95%, less than or equal to 99.9%, less than or equal to 99.8%, less than or equal to 99.7%, less than or equal to 99.6%, less than or equal to 99.5%, less than or equal to 99%, less than or equal to 98%, less than or equal to 97%, less than or equal to 95%, less than or equal to 90%, less than or equal to 80%, less than or equal to 70%, less than or equal to 60%, less than or equal to 50%, less than or equal to 40%, less than or equal to 30%, or less than or equal to 20%. Combinations of the above-referenced ranges are also possible (e.g., greater than or equal to 10% and less than or equal to 100%, greater than or equal to 20% and less than or equal to 99.999%, or greater than or equal to 30% and less than or equal to 99.99%). Other ranges are also possible.

The initial efficiency at 4 microns of a non-woven fiber web of the second type may be determined when the non-woven fiber web of the second type is in the form that it takes in the filter media (e.g., in a form that comprises one or more pluralities of undulations, such as a second plurality of undulations positioned within a first plurality of undulations).

When a filter media comprises two or more non-woven fiber webs of the second type, each non-woven fiber web of the second type may independently have an initial efficiency at 4 microns in one or more of the above-referenced ranges.

The non-woven fiber webs of the second type described herein may have a relatively high overall efficiency at 4 microns. The overall efficiency at 4 microns of a non-woven fiber web of the second type may be greater than or equal to 10%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, greater than or equal to 95%, greater than or equal to 97%, greater than or equal to 98%, greater than or equal to 99%, greater than or equal to 99.5%, greater than or equal to 99.6%, greater than or equal to 99.7%, greater than or equal to 99.8%, greater than or equal to 99.9%, greater than or equal to 99.95%, greater than or equal to 99.99%, or greater than or equal to 99.999%. The overall efficiency at 4 microns of a non-woven fiber web of the second type may be less than or equal to 100%, less than or equal to 99.999%, less than or equal to 99.99%, less than or equal to 99.95%, less than or equal to 99.9%, less than or equal to 99.8%, less than or equal to 99.7%, less than or equal to 99.6%, less than or equal to 99.5%, less than or equal to 99%, less than or equal to 98%, less than or equal to 97%, less than or equal to 95%, less than or equal to 90%, less than or equal to 80%, less than or equal to 70%, less than or equal to 60%, less than or equal to 50%, less than or equal to 40%, less than or equal to 30%, or less than or equal to 20%. Combinations of the above-referenced ranges are also possible (e.g., greater than or equal to 10% and less than or equal to 100%, greater than or equal to 20% and less than or equal to 99.999%, or greater than or equal to 30% and less than or equal to 99.99%). Other ranges are also possible.

When a filter media comprises two or more non-woven fiber webs of the second type, each non-woven fiber web of the second type may independently have an overall efficiency at 4 microns in one or more of the above-referenced ranges. The overall efficiency at 4 microns of a non-woven fiber web of the second type may be determined when the non-woven fiber web of the second type is in the form that it takes in the filter media (e.g., in a form that comprises one or more pluralities of undulations, such as a second plurality of undulations positioned within a first plurality of undulations).

The non-woven fiber webs of the second type described herein may have a relatively high dust holding capacity. The dust holding capacity of a non-woven fiber web of the second type may be greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 150 gsm, greater than or equal to 200 gsm, greater than or equal to 300 gsm, greater than or equal to 400 gsm, greater than or equal to 500 gsm, greater than or equal to 600 gsm, greater than or equal to 700 gsm, greater than or equal to 800 gsm, or greater than or equal to 900 gsm. The dust holding capacity of a non-woven fiber web of the second type may be than or equal to 1000 gsm, less than or equal to 900 gsm, less than or equal to 800 gsm, less than or equal to 700 gsm, less than or equal to 600 gsm, less than or equal to 500 gsm, less than or equal to 400 gsm, less than or equal to 300 gsm, less than or equal to 200 gsm, less than or equal to 150 gsm, less than or equal to 100 gsm, less than or equal to 90 gsm, less than or equal to 80 gsm, less than or equal to 70 gsm, or less than or equal to 60 gsm. Combinations of the above-referenced ranges are also possible (e.g., greater than or equal to 50 gsm and less than or equal to 1000 gsm, greater than or equal to 100 gsm and less than or equal to 500 gsm, or greater than or equal to 150 gsm and less than or equal to 500 gsm). Other ranges are also possible.

As described elsewhere herein, dust holding capacity may be measured according to ISO 19438 (2013) using ISO medium test dust (A3) and a flow velocity of 0.06 cm/s; dust holding capacity is measured when the pressure drop across the fiber web reaches 100 kPa. The relevant dust holding capacity is the injected dust holding capacity (i.e., a non-woven fiber web of the second type may have an injected dust holding capacity in one or more of the ranges described above). The dust holding capacity of a non-woven fiber web of the second type may be determined when the non-woven fiber web of the second type is in the form that it takes in the filter media (e.g., in a form that comprises one or more pluralities of undulations, such as a second plurality of undulations positioned within a first plurality of undulations).

When a filter media comprises two or more non-woven fiber webs of the second type, each non-woven fiber web of the second type may independently have an dust holding capacity in one or more of the above-referenced ranges.

As described above, in some embodiments, a non-woven fiber web of the first type and/or a non-woven fiber web of the second type is fabricated by a wet laying process. In general, a wet laying process involves mixing together fibers of one or more type; for example, a plurality of glass fibers may be mixed together on its own or with a plurality of staple fibers and/or a plurality of binder fibers to provide a fiber slurry. The slurry may be, for example, an aqueous-based slurry. In some embodiments, fibers are optionally stored separately, or in combination, in various holding tanks prior to being mixed together.

In some embodiments, each plurality of fibers may be mixed and pulped together in separate containers. As an example, a plurality of glass fibers may be mixed and pulped together in one container, a plurality of staple fibers may be mixed and pulped in a second container, and a plurality of binder fibers may be mixed and pulped in a third container. The pluralities of fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture (e.g., additives). Furthermore, it should be appreciated that other combinations of fibers types may be used in fiber mixtures, such as the fiber types described herein.

A wet laying process may comprise applying a single dispersion (e.g., a pulp) in a solvent (e.g., an aqueous solvent such as water) or slurry onto a wire conveyor in a papermaking machine (e.g., a fourdrinier or a rotoformer) to form a single layer supported by the wire conveyor. Vacuum may be continuously applied to the dispersion of fibers during the above process to remove the solvent from the fibers, thereby resulting in an article containing the single layer.

In some embodiments, multiple layers (e.g., comprising at least one non-woven fiber web of the first type) may be formed simultaneously or sequentially in a wet laying process. For instance, a layer may be formed as described above, and then one or more layers may be formed on that layer by following the same procedure. As an example, a dispersion in a solvent or slurry may be applied to a first layer on a wire conveyor, and vacuum applied to the dispersion or slurry to form a second layer on the first layer. Further layers may be formed on the first layer and the second layer by following this same process. The first layer, second layer, and/or one or more of the further layers may be non-woven fiber webs of the first type.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, a wet laying process uses similar equipment as in a conventional papermaking process, for example, a hydropulper, a former or a headbox, a dryer, and/or an optional converter. A layer can also be made with a laboratory handsheet mold in some instances. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of the fibers is in a suitable range, such as for example, between about 0.1% and 0.5% by weight.

In some cases, the pH of the slurry may be adjusted as desired. For instance, fibers of the slurry may be dispersed under acidic or neutral conditions.

Before the slurry is sent to a headbox, the slurry may optionally be passed through centrifugal cleaners and/or pressure screens for removing undesired material (e.g., unfiberized material). The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, or an inclined wire fourdrinier.

As described elsewhere herein, in some embodiments, a filter media comprises two or more layers. One or more of the layers present in the filter media may be a non-woven fiber web of the first type as described elsewhere herein and/or one or more layers present in the filter media may be a non-woven fiber web of the second type as described elsewhere herein. It is also possible for a filter media to comprise one or more layers differing from the non-woven fiber webs of the first type described elsewhere herein in one or more ways and/or to comprise one or more layers differing from the non-woven fiber webs of the second type described herein in one or more ways. For instance, the filter media may comprise a layer of a different type than those listed as suitable for the non-woven fiber webs described above. Non-limiting examples of such layers include extruded meshes, woven meshes, and expanded wire supports. It is also possible for a filter media to comprise a non-woven fiber web of a third type, a fourth type, a fifth type, and/or of further types. These further layers and/or non-woven fiber webs, when present, may comprise two or more pluralities of undulations (e.g., they may be undulated together with or separately from another layer) or may lack undulations.

One example of a type of layer that may be included in a filter media is a nanofiber layer. The nanofiber layer may be a non-woven fiber web (e.g., a non-woven fiber web of a third type) and/or may be present in a filter media further comprising another non-woven fiber web (e.g., a non-woven fiber web of the first type, a non-woven fiber web of the second type). The nanofiber layer may enhance the filtration performance of the filter media and/or may serve as an efficiency layer (e.g., a second efficiency layer in embodiments in which the filter media also comprises another efficiency layer).

Nanofiber layers may have a variety of suitable morphologies. For instance, the nanofiber layer may be an electrospun non-woven fiber web, a meltblown non-woven fiber web, a centrifugal spun non-woven fiber web, or an electroblown spun non-woven fiber web.

Fibers present in the nanofiber layer may be of a variety of suitable types. In some embodiments, a nanofiber layer includes fibers comprising one or more of: poly(ether)-b-poly(amide), poly(sulfone), poly(amide)s (e.g., nylons, such as nylon 6), poly(ester)s (e.g., poly(caprolactone), poly(butylene terephthalate)), poly(urethane)s, poly(urea)s, acrylics, polymers comprising a side chain comprising a carbonyl functional group (e.g., poly(vinyl acetate), cellulose ester, poly(acrylamide)), poly(ether sulfone), poly(acrylic)s (e.g., poly(acrylonitrile), poly(acrylic acid)), fluorinated polymers (e.g., poly(vinylidene difluoride)), polyols (e.g., poly(vinyl alcohol)), poly(ether)s (e.g., poly(ethylene oxide)), poly(vinyl pyrrolidone), poly(allylamine), butyl rubber, poly(ethylene), polymers comprising a silane functional group, polymers comprising a thiol functional group, and polymers comprising a methylol functional group (e.g., phenolic polymers, melamine polymers, melamine-formaldehyde polymers, cross-linkable polymers comprising pendant methylol groups).

When a filter media comprises two or more nanofiber layers, each nanofiber layer may independently comprise fibers having one or more of the above-referenced compositions.

Nanofiber layers may comprise fibers having a variety of suitable average fiber diameters. In some embodiments, a nanofiber layer comprises fibers having an average fiber diameter of greater than or equal to 0.1 micron, greater than or equal to 0.02 microns, greater than or equal to 0.03 microns, greater than or equal to 0.04 microns, greater than or equal to 0.05 microns, greater than or equal to 0.06 microns, greater than or equal to 0.08 microns, greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.6 microns, or greater than or equal to 0.8 microns. In some embodiments, a nanofiber layer comprises fibers having an average fiber diameter of less than or equal to 1 micron, less than or equal to 0.8 microns, less than or equal to 0.6 microns, less than or equal to 0.5 microns, less than or equal to 0.4 microns, less than or equal to 0.3 microns, less than or equal to 0.25 microns, less than or equal to 0.2 microns, less than or equal to 0.15 microns, less than or equal to 0.125 microns, less than or equal to 0.1 micron, less than or equal to 0.08 microns, less than or equal to 0.06 microns, less than or equal to 0.05 microns, less than or equal to 0.04 microns, less than or equal to 0.03 microns, or less than or equal to 0.02 microns. Combinations of the above-referenced ranges are also possible (e.g., greater than or equal to 0.01 micron and less than or equal to 1 micron, greater than or equal to 0.04 microns and less than or equal to 1 micron, greater than or equal to 0.05 microns and less than or equal to 1 micron, or greater than or equal to 0.08 microns and less than or equal to 0.3 microns). Other ranges are also possible.

When a filter media comprises two or more nanofiber layers, each nanofiber layer may independently have an average fiber diameter in one or more of the above-referenced ranges.

Nanofiber layers may have a variety of suitable basis weights. In some embodiments, a nanofiber layer has a basis weight of greater than or equal to 0.01 gsm, greater than or equal to 0.02 gsm, greater than or equal to 0.03 gsm, greater than or equal to 0.04 gsm, greater than or equal to 0.05 gsm, greater than or equal to 0.06 gsm, greater than or equal to 0.08 gsm, greater than or equal to 0.1 gsm, greater than or equal to 0.2 gsm, greater than or equal to 0.5 gsm, greater than or equal to 0.75 gsm, greater than or equal to 1 gsm, greater than or equal to 1.25 gsm, greater than or equal to 1.5 gsm, greater than or equal to 1.75 gsm, greater than or equal to 2 gsm, greater than or equal to 2.5 gsm, greater than or equal to 3 gsm, greater than or equal to 3.5 gsm, greater than or equal to 4 gsm, or greater than or equal to 4.5 gsm. In some embodiments, a nanofiber layer has a basis weight of less than or equal to 5 gsm, less than or equal to 4.5 gsm, less than or equal to 4 gsm, less than or equal to 3.5 gsm, less than or equal to 3 gsm, less than or equal to 2.5 gsm, less than or equal to 2 gsm, less than or equal to 1.75 gsm, less than or equal to 1.5 gsm, less than or equal to 1.25 gsm, less than or equal to 1 gsm, less than or equal to 0.75 gsm, less than or equal to 0.5 gsm, less than or equal to 0.2 gsm, less than or equal to 0.1 gsm, less than or equal to 0.08 gsm, less than or equal to 0.06 gsm, less than or equal to 0.05 gsm, less than or equal to 0.04 gsm, less than or equal to 0.03 gsm, or less than or equal to 0.02 gsm. Combinations of the above-referenced ranges are also possible (e.g., greater than or equal to 0.01 gsm and less than or equal to 5 gsm, greater than or equal to 0.03 gsm and less than or equal to 4 gsm, or greater than or equal to 0.05 gsm and less than or equal to 2 gsm). Other ranges are also possible.

The basis weight of a nanofiber layer may be determined when the nanofiber layer is in the form that it takes in the filter media (e.g., in a form that comprises one or more pluralities of undulations, such as a second plurality of undulations positioned within a first plurality of undulations).

When a filter media comprises two or more nanofiber layers, each nanofiber layer may independently have a basis weight in one or more of the above-referenced ranges.

Nanofiber layers may have a variety of suitable thicknesses. In some embodiments, a nanofiber layer has a thickness of greater than or equal to 0.1 micron, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.6 microns, greater than or equal to 0.8 microns, greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, or greater than or equal to 80 microns. In some embodiments, a nanofiber layer has a thickness of less than or equal to 100 microns, less than or equal to 80 microns, less than or equal to 60 microns, less than or equal to 50 microns, less than or equal to 40 microns, less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 2 microns, less than or equal to 1 micron, less than or equal to 0.8 microns, less than or equal to 0.6 microns, less than or equal to 0.5 microns, less than or equal to 0.4 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 micron and less than or equal to 100 microns, greater than or equal to 0.2 microns and less than or equal to 50 microns, or greater than or equal to 0.5 microns and less than or equal to 10 microns). Other ranges are also possible.

The thickness of a nanofiber layer may be determined by cross-sectional scanning electron microscopy. The thickness of a nanofiber layer may be determined when the nanofiber layer is in the form that it takes in the filter media (e.g., in a form that comprises one or more pluralities of undulations, such as a second plurality of undulations positioned within a first plurality of undulations).

When a filter media comprises two or more nanofiber layers, each nanofiber layer may independently have a thickness in one or more of the above-referenced ranges.

Nanofiber layers may have a variety of suitable solidities. In some embodiments, a nanofiber layer has a solidity of greater than or equal to 0.1%, greater than or equal to 0.2%, greater than or equal to 0.3%, greater than or equal to 0.4%, greater than or equal to 0.5%, greater than or equal to 0.6%, greater than or equal to 0.8%, greater than or equal to 1%, greater than or equal to 2%, greater than or equal to 5%, greater than or equal to 7.5%, greater than or equal to 10%, greater than or equal to 12.5%, greater than or equal to 15%, greater than or equal to 20%, or greater than or equal to 25%. In some embodiments, a nanofiber layer has a solidity of less than or equal to 30%, less than or equal to 25%, less than or equal to 20%, less than or equal to 15%, less than or equal to 12.5%, less than or equal to 10%, less than or equal to 7.5%, less than or equal to 5%, less than or equal to 2%, less than or equal to 1%, less than or equal to 0.8%, less than or equal to 0.6%, less than or equal to 0.5%, less than or equal to 0.4%, less than or equal to 0.3%, or less than or equal to 0.2%. Combinations of the above-referenced ranges are also possible (e.g., greater than or equal to 0.1% and less than or equal to 30%, greater than or equal to 0.5% and less than or equal to 20%, or greater than or equal to 1% and less than or equal to 10%). Other ranges are also possible.

The solidity of a nanofiber layer may be determined as described elsewhere herein with respect to the determination of the solidity of a support layer. The solidity of a nanofiber layer may be determined when the nanofiber layer is in the form that it takes in the filter media (e.g., in a form that comprises one or more pluralities of undulations, such as a second plurality of undulations positioned within a first plurality of undulations).

When a filter media comprises two or more nanofiber layers, each nanofiber layer may independently have a solidity in one or more of the above-referenced ranges.

Nanofiber layers may have a variety of suitable air permeabilities. In some embodiments, a nanofiber layer has an air permeability of greater than or equal to 10 CFM, greater than or equal to 20 CFM, greater than or equal to 30 CFM, greater than or equal to 40 CFM, greater than or equal to 50 CFM, greater than or equal to 60 CFM, greater than or equal to 70 CFM, greater than or equal to 80 CFM, greater than or equal to 100 CFM, greater than or equal to 125 CFM, or greater than or equal to 150 CFM. In some embodiments, a nanofiber layer has an air permeability of less than or equal to 170 CFM, less than or equal to 150 CFM, less than or equal to 125 CFM, less than or equal to 100 CFM, less than or equal to 80 CFM, less than or equal to 60 CFM, less than or equal to 50 CFM, less than or equal to 40 CFM, less than or equal to 30 CFM, or less than or equal to 20 CFM. Combinations of the above-referenced ranges are also possible (e.g., greater than or equal to 10 CFM and less than or equal to 170 CFM, greater than or equal to 30 CFM and less than or equal to 80 CFM, or greater than or equal to 40 CFM and less than or equal to 70 CFM). Other ranges are also possible.

The air permeability may be determined in accordance with ASTM D737-04 (2016) at a pressure of 125 Pa. The air permeability of a nanofiber layer may be determined when the nanofiber layer is in the form that it takes in the filter media (e.g., in a form that comprises one or more pluralities of undulations, such as a second plurality of undulations positioned within a first plurality of undulations).

When a filter media comprises two or more nanofiber layers, each nanofiber layer may independently have an air permeability in one or more of the above-referenced ranges.

In some embodiments, a filter media comprises a meltblown layer in addition to a non-woven fiber web of the first type and/or a non-woven fiber web of the second type. The meltblown layer may comprise a meltblown non-woven fiber web. Additionally, the meltblown layer may be a non-woven fiber web of a third or higher type. When present, the meltblown layer may serve as a prefilter for a non-woven fiber web of another type that serves as an efficiency layer. In such embodiments, the meltblown layer may comprise coarser fibers than the efficiency layer and/or may serve to filter out larger particles from a fluid prior to exposure of an efficiency layer of the first type and/or a nanofiber layer to the fluid. This may advantageously reduce clogging of either or both of these layers by such larger particles, thereby extending the lifetime of the filter media. It is also possible for the meltblown layers described herein to serve as capacity layers in a filter media and/or to provide stiffness to a filter media that enhances the ease with which it is pleated. In some embodiments, a meltblown layer may serve to protect (e.g., mechanically) a relatively delicate nanofiber layer and/or efficiency layer to which it is adjacent.

Meltblown layers may comprise continuous fibers, such as synthetic continuous fibers. Continuous fibers may be made by a “continuous” fiber-forming process and typically have longer lengths than non-continuous fibers.

In some embodiments, a meltblown layer comprises synthetic fibers. The synthetic fibers may comprise a variety of materials, including poly(ester)s (e.g., poly(ethylene terephthalate), poly(butylene terephthalate)), poly(carbonate), poly(amide)s (e.g., various nylon polymers), poly(aramid)s, poly(imide)s, poly(olefin)s (e.g., poly(ethylene), poly(propylene)), poly(ether ether ketone), poly(acrylic)s (e.g., poly(acrylonitrile), dryspun poly(acrylic)), poly(vinyl alcohol), regenerated cellulose (e.g., synthetic cellulose such cellulose acetate, rayon), fluorinated polymers (e.g., poly(vinylidene difluoride) (PVDF)), copolymers of poly(ethylene) and PVDF, and poly(ether sulfone)s.

When a filter media comprises two or more meltblown layers, each meltblown layer may independently comprise fibers having one or more of the above-referenced compositions.

Meltblown layers may comprise fibers having a variety of suitable average fiber diameters. In some embodiments, the average fiber diameter of the fibers in a meltblown layer is greater than or equal to 0.4 microns, greater than or equal to 0.5 microns, greater than or equal to 0.6 microns, greater than or equal to 0.8 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 6 microns, greater than or equal to 8 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, greater than or equal to 30 microns, greater than or equal to 35 microns, greater than or equal to 40 microns, or greater than or equal to 45 microns. In some embodiments, the average fiber diameter of the fibers in a meltblown layer is less than or equal to 50 microns, less than or equal to 45 microns, less than or equal to 40 microns, less than or equal to 35 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.8 microns, less than or equal to 0.6 microns, or less than or equal to 0.5 microns. Combinations of the above-referenced ranges are also possible (e.g., greater than or equal to 0.4 microns and less than or equal to 50 microns, greater than or equal to 0.5 microns and less than or equal to 30 microns, or greater than or equal to 1 micron and less than or equal to 20 microns). Other ranges are also possible.

When a filter media comprises two or more meltblown layers, each meltblown layer may independently comprise fibers having an average fiber diameter in one or more of the above-referenced ranges.

In some embodiments, a meltblown layer comprises one or more additives, one example of which is a charge-stabilizing additive. One example of a suitable class of charge-stabilizing additives is hindered amine light stabilizers. Without wishing to be bound by any particular theory, it is believed that hindered amine light stabilizers are capable accepting and stabilizing charged species (e.g., a positively charged species, such as a proton from water; a negatively charged species) thereon. Further non-limiting examples of suitable charge-stabilizing additives include fused aromatic thioureas, organic triazines, UV stabilizers, phosphites, additives comprising two or more amide groups (e.g., bisamides, trisamides), stearates (e.g., magnesium stearate, calcium stearate), and stearamides (e.g., ethylene bis-stearamide). Charge-stabilizing additives may be incorporated into fibers and/or may be incorporated into the meltblown layer in another manner (e.g., as particles, as a coating on the fibers). One example of a manner in which charge-stabilizing additives may be incorporated into fibers is by forming a continuous fiber from a composition comprising the charge-stabilizing additive.

When a filter media comprises two or more meltblown layers, each meltblown layer may independently comprise one or more of the above-described charge-stabilizing additives.

Another example of a suitable type of additive is an additive that enhances the heat stability of the meltblown layer. For instance, such additives may reduce the degradation exhibited by one or more polymers present in the meltblown layer upon exposure to heat. The degradation reduced may comprise a change in one or more physical or chemical properties of the polymer as observed by gel permeation chromatography (e.g., in the case of degradation that comprises a change in molecular weight), changes in melt viscosity, and/or changes in color. Non-limiting examples of such additives include phosphites, phenolics, hydroxyl amines and hindered amine light stabilizers.

When a filter media comprises two or more meltblown layers, each meltblown layer may independently comprise one or more of the above-described additives that enhance heat stability.

In some embodiments, a meltblown layer is charged. It is also possible for a filter media to comprise an uncharged meltblown layer. When present, charge (e.g., electrostatic charge) may be induced on the meltblown layer by a variety of suitable charging processes, non-limiting examples of which include corona discharging (e.g., employing AC corona, employing DC corona), employing an ionic charge bar (e.g., powered by a positive current, powered by a negative current), and/or tribocharging (e.g., hydrocharging, charging by fiber friction).

A hydro charging process may comprise impinging jets and/or streams of water droplets onto an initially uncharged meltblown layer to cause it to become charged electrostatically. At the conclusion of the hydro charging process, the meltblown layer may have an electret charge. The jets and/or streams of water droplets may impinge on the meltblown layer at a variety of suitable pressures, such as a pressure of between 10 to 50 psi, and may be provided by a variety of suitable sources, such as a sprayer. In some embodiments, a meltblown layer is hydro charged by using an apparatus that may be employed for the hydroentanglement of fibers which is operated at a lower pressure than is typical for the hydroentangling process. The water impinging on the meltblown layer may be relatively pure; for instance, it may be distilled water and/or deionized water. After electrostatic charging in this manner, the meltblown layer may be dried, such as with air dryer.

In some embodiments, a meltblown layer is hydro charged while being moved laterally. The meltblown layer may be transported on a porous belt, such as a screen or mesh-type conveyor belt. As it is being transported on the porous belt, it may be exposed to a spray and/or jets of water pressurized by a pump. The water jets and/or spray may impinge on the meltblown layer and/or penetrate therein. In some embodiments, a vacuum is provided beneath the porous transport belt, which may aid the passage of water through the meltblown layer and/or reduce the amount of time and energy necessary for drying the meltblown layer at the conclusion of the hydro charging process.

A fiber friction charging process (also referred to as a triboelectric charging process) may comprise bringing into contact and then separating two surfaces, at least one of which is a surface at which fibers to be charged are positioned. This process may cause the transfer of charge between the two surfaces and the associated buildup of charge on the two surfaces. The surfaces may be selected such that they have sufficiently different positions in the triboelectric series to result in a desirable level of charge transfer therebetween upon contact.

When a filter media comprises two or more meltblown layers, each meltblown layer may independently be uncharged or be charged in one or more of the above-described manners.

Meltblown layers may have a variety of suitable basis weights. In some embodiments, a meltblown layer has a basis weight of greater than or equal to 1 gsm, greater than or equal to 1.5 gsm, greater than or equal to 2 gsm, greater than or equal to 3 gsm, greater than or equal to 4 gsm, greater than or equal to 5 gsm, greater than or equal to 7.5 gsm, greater than or equal to 10 gsm, greater than or equal to 20 gsm, greater than or equal to 50 gsm, greater than or equal to 75 gsm, greater than or equal to 100 gsm, greater than or equal to 150 gsm, greater than or equal to 200 gsm, greater than or equal to 250 gsm, greater than or equal to 300 gsm, greater than or equal to 350 gsm, greater than or equal to 400 gsm, greater than or equal to 450 gsm, greater than or equal to 500 gsm, or greater than or equal to 550 gsm. In some embodiments, a meltblown layer has a basis weight of less than or equal to 600 gsm, less than or equal to 550 gsm, less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 100 gsm, less than or equal to 75 gsm, less than or equal to 50 gsm, less than or equal to 20 gsm, less than or equal to 10 gsm, less than or equal to 7.5 gsm, less than or equal to 5 gsm, less than or equal to 4 gsm, less than or equal to 3 gsm, less than or equal to 2 gsm, or less than or equal to 1.5 gsm. Combinations of the above-referenced ranges are also possible (e.g., greater than or equal to 1 gsm and less than or equal to 600 gsm, greater than or equal to 2 gsm and less than or equal to 300 gsm, or greater than or equal to 5 gsm and less than or equal to 100 gsm). Other ranges are also possible.

The basis weight of a meltblown layer may be determined in accordance with ISO 536:2012. The basis weight of a meltblown layer may be determined when the meltblown layer is in the form that it takes in the filter media (e.g., in a form that comprises one or more pluralities of undulations, such as a second plurality of undulations positioned within a first plurality of undulations).

When a filter media comprises two or more meltblown layers, each meltblown layer may independently have a basis weight in one or more of the above-referenced ranges.

When present, a meltblown layer may have a variety of suitable thicknesses. In some embodiments, a meltblown layer has a thickness of greater than or equal to 0.01 mm, greater than or equal to 0.02 mm, greater than or equal to 0.03 mm, greater than or equal to 0.05 mm, greater than or equal to 0.075 mm, greater than or equal to 0.1 mm, greater than or equal to 0.2 mm, greater than or equal to 0.5 mm, greater than or equal to 0.75 mm, greater than or equal to 1 mm, greater than or equal to 1.5 mm, greater than or equal to 2 mm, greater than or equal to 3 mm, greater than or equal to 4 mm, or greater than or equal to 6 mm. In some embodiments, a meltblown layer has a thickness of less than or equal to 8 mm, less than or equal to 6 mm, less than or equal to 4 mm, less than or equal to 3 mm, less than or equal to 2 mm, less than or equal to 1.5 mm, less than or equal to 1 mm, less than or equal to 0.75 mm, less than or equal to 0.5 mm, less than or equal to 0.2 mm, less than or equal to 0.1 mm, less than or equal to 0.075 mm, less than or equal to 0.05 mm, less than or equal to 0.03 mm, or less than or equal to 0.02 mm. Combinations of the above-referenced ranges are also possible (e.g., greater than or equal to 0.01 mm and less than or equal to 8 mm, greater than or equal to 0.05 mm and less than or equal to 4 mm, or greater than or equal to 0.1 mm and less than or equal to 2 mm). Other ranges are also possible.

The thickness of a meltblown layer may be determined in accordance with ASTM D1777 (2015) under an applied pressure of 0.2 kPa. The thickness of a meltblown layer may be determined when the meltblown layer is in the form that it takes in the filter media (e.g., in a form that comprises one or more pluralities of undulations, such as a second plurality of undulations positioned within a first plurality of undulations).

When a filter media comprises two or more meltblown layers, each meltblown layer may independently have a thickness in one or more of the above-referenced ranges.

Meltblown layers may have a variety of suitable solidities. In some embodiments, a meltblown layer has a solidity of greater than or equal to 1%, greater than or equal to 1.5%, greater than or equal to 2%, greater than or equal to 2.5%, greater than or equal to 3%, greater than or equal to 4%, greater than or equal to 5%, greater than or equal to 7.5%, greater than or equal to 10%, greater than or equal to 12.5%, greater than or equal to 15%, greater than or equal to 17.5%, greater than or equal to 20%, or greater than or equal to 22.5%. In some embodiments, a meltblown layer has a solidity of less than or equal to 25%, less than or equal to 22.5%, less than or equal to 20%, less than or equal to 17.5%, less than or equal to 15%, less than or equal to 12.5%, less than or equal to 10%, less than or equal to 7.5%, less than or equal to 5%, less than or equal to 4%, less than or equal to 3%, less than or equal to 2.5%, less than or equal to 2%, or less than or equal to 1.5%. Combinations of the above-referenced ranges are also possible (e.g., greater than or equal to 1% and less than or equal to 25%, greater than or equal to 2% and less than or equal to 15%, or greater than or equal to 3% and less than or equal to 10%). Other ranges are also possible.

The solidity of a meltblown layer may be determined by the same techniques that may be employed to determine the solidity of a support layer described elsewhere herein. The solidity of a meltblown layer may be determined when the meltblown layer is in the form that it takes in the filter media (e.g., in a form that comprises one or more pluralities of undulations, such as a second plurality of undulations positioned within a first plurality of undulations).

When a filter media comprises two or more meltblown layers, each meltblown layer may independently have a solidity in one or more of the above-referenced ranges.

Meltblown layers may have a variety of suitable air permeabilities. In some embodiments, a meltblown layer has an air permeability of greater than or equal to 1 CFM, greater than or equal to 2 CFM, greater than or equal to 10 CFM, greater than or equal to 20 CFM, greater than or equal to 50 CFM, greater than or equal to 75 CFM, greater than or equal to 100 CFM, greater than or equal to 200 CFM, greater than or equal to 500 CFM, greater than or equal to 800 CFM, greater than or equal to 1000 CFM, or greater than or equal to 1250 CFM. In some embodiments, a meltblown layer has an air permeability of less than or equal to 1500 CFM, less than or equal to 1250 CFM, less than or equal to 1000 CFM, less than or equal to 800 CFM, less than or equal to 500 CFM, less than or equal to 200 CFM, less than or equal to 100 CFM, less than or equal to 75 CFM, less than or equal to 50 CFM, less than or equal to 20 CFM, less than or equal to 10 CFM, or less than or equal to 2 CFM. Combinations of the above-referenced ranges are also possible (e.g., greater than or equal to 1 CFM and less than or equal to 1500 CFM, greater than or equal to 10 CFM and less than or equal to 800 CFM, greater than or equal to 20 CFM and less than or equal to 500 CFM, or greater than or equal to 100 CFM and less than or equal to 500 CFM). Other ranges are also possible.

The air permeability of a meltblown layer may be determined in accordance with ASTM D737-04 (2016) at a pressure of 125 Pa. The air permeability of a meltblown layer may be determined when the meltblown layer is in the form that it takes in the filter media (e.g., in a form that comprises one or more pluralities of undulations, such as a second plurality of undulations positioned within a first plurality of undulations).

When a filter media comprises two or more meltblown layers, each melblown layer may independently have an air permeability in one or more of the above-referenced ranges.

In some embodiments, a filter media comprises a scrim in addition to a non-woven fiber web of the first type and/or a non-woven fiber web of the second type. The scrim may be a non-woven fiber web of a third or higher type. It is also possible for the scrim to be a type of layer other than a non-woven fiber web.

Scrims may be layers that are fairly open. For instance, a scrim may have a relatively high air permeability (e.g., in excess of 1000 CFM and/or up to 20,000 CFM) and/or a relatively low pressure drop (e.g., a pressure drop that does not contribute appreciably to the pressure drop of the filter media as a whole). A filter media may comprise a scrim that supports one or more other layers (e.g., one or more non-woven fiber webs of the first type, one or more non-woven fiber webs of the second type, and/or one or more nanofiber layers) while not adding appreciably to the pressure drop of the filter media. Some filter media may comprise a scrim that protects one or more layers of the filter media.

A variety of suitable scrims may be employed in the filter media described herein. As described above, in some embodiments, a filter media comprises a scrim that is fibrous. For instance, a filter media may comprise a scrim that is a non-woven fiber web, such as a spunbond fiber web. In such embodiments, the scrim may comprise continuous fibers. As another example, a filter media may comprise a scrim that is a mesh, such as an extruded mesh. As a third example, a filter media may comprise a scrim that is a woven material. As fourth and fifth examples, a filter media may comprise a scrim that is a perforated film and/or a fibrillated film.

Scrims may comprise a variety of suitable types of fibers. A scrim may comprise fibers that are synthetic fibers, such as polyolefin fibers (e.g., poly(propylene) fibers), polyester fibers, and/or nylon fibers.

When a filter media comprises two or more scrims, each scrim may independently comprise fibers of one or more of the above-referenced types.

Scrims may comprise fibers having a variety of suitable average diameters. A scrim may comprise fibers having an average diameter of greater than or equal to 1 micron, greater than or equal to 2 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. A scrim may comprise fibers having an average diameter of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, or less than or equal to 2 microns. Combinations of the above-referenced ranges are also possible (e.g., greater than or equal to 1 micron and less than or equal to 50 microns, or greater than or equal to 15 microns and less than or equal to 35 microns). Other ranges are also possible.

When a filter media comprises two or more scrims, each scrim may independently comprise fibers having an average fiber diameter in one or more of the above-referenced ranges.

It should also be noted that it is possible for a scrim to comprise fibers having two or more different diameters and/or two or more different types of cross-sections. Such fibers having differing cross-section and/or diameter may be of the same chemical composition or may have different chemical compositions. Non-limiting embodiments of suitable cross-sections include circular, oval, Y-shaped, I-shaped (e.g., dog bone), closed C-shaped, multilobal (e.g., trilobal, 4-lobed, 5-lobed, 6-lobed, comprising more than 6 lobes, X-shaped, crenulated).

When a filter media comprises two or more scrims, each scrim may independently comprise fibers having a cross-section and/or combination of cross-sections in one or more of the above-referenced ranges.

Scrims may have a variety of suitable basis weights. A scrim may have a basis weight of greater than or equal to 0.1 gsm, greater than or equal to 0.2 gsm, greater than or equal to 0.3 gsm, greater than or equal to 0.5 gsm, greater than or equal to 0.75 gsm, greater than or equal to 1 gsm, greater than or equal to 2 gsm, greater than or equal to 3 gsm, greater than or equal to 5 gsm, greater than or equal to 7.5 gsm, greater than or equal to 10 gsm, greater than or equal to 15 gsm, greater than or equal to 20 gsm, greater than or equal to 25 gsm, greater than or equal to 30 gsm, greater than or equal to 40 gsm, greater than or equal to 50 gsm, greater than or equal to 60 gsm, greater than or equal to 70 gsm, greater than or equal to 80 gsm, or greater than or equal to 100 gsm. A scrim may have a basis weight of less than or equal to 120 gsm, less than or equal to 100 gsm, less than or equal to 80 gsm, less than or equal to 70 gsm, less than or equal to 60 gsm, less than or equal to 50 gsm, less than or equal to 40 gsm, less than or equal to 30 gsm, less than or equal to 25 gsm, less than or equal to 20 gsm, less than or equal to 15 gsm, less than or equal to 10 gsm, less than or equal to 7.5 gsm, less than or equal to 5 gsm, less than or equal to 3 gsm, less than or equal to 2 gsm, less than or equal to 1 gsm, less than or equal to 0.75 gsm, less than or equal to 0.5 gsm, less than or equal to 0.3 gsm, or less than or equal to 0.2 gsm. Combinations of the above-referenced ranges are also possible (e.g., greater than or equal to 0.1 gsm and less than or equal to 120 gsm, greater than or equal to 1 gsm and less than or equal to 120 gsm, greater than or equal to 5 gsm and less than or equal to 120 gsm, greater than or equal to 20 gsm and less than or equal to 80 gsm, or greater than or equal to 40 gsm and less than or equal to 60 gsm). Other ranges are also possible.

The basis weight of a scrim may be determined in accordance with ISO 536:2012. The basis weight of a scrim may be determined when the scrim is in the form that it takes in the filter media (e.g., in a form that comprises one or more pluralities of undulations, such as a second plurality of undulations positioned within a first plurality of undulations).

When a filter media comprises two or more scrims, each scrim may independently have a basis weight in one or more of the above-referenced ranges.

Scrims may have a variety of suitable thicknesses. A scrim may have a thickness of greater than or equal to 0.01 mm, greater than or equal to 0.015 mm, greater than or equal to 0.02 mm, greater than or equal to 0.025 mm, greater than or equal to 0.03 mm, greater than or equal to 0.035 mm, greater than or equal to 0.04 mm, greater than or equal to 0.045 mm, greater than or equal to 0.05 mm, greater than or equal to 0.055 mm, greater than or equal to 0.06 mm, greater than or equal to 0.065 mm, greater than or equal to 0.07 mm, greater than or equal to 0.08 mm, greater than or equal to 0.09 mm, greater than or equal to 0.1 mm, greater than or equal to 0.15 mm, greater than or equal to 0.2 mm, greater than or equal to 0.25 mm, greater than or equal to 0.3 mm, greater than or equal to 0.35 mm, greater than or equal to 0.4 mm, greater than or equal to 0.45 mm, greater than or equal to 0.5 mm, greater than or equal to 0.55 mm, greater than or equal to 0.6 mm, greater than or equal to 0.65 mm, greater than or equal to 0.7 mm, greater than or equal to 0.8 mm, greater than or equal to 0.9 mm, greater than or equal to 1 mm, greater than or equal to 1.5 mm, greater than or equal to 2 mm, greater than or equal to 3 mm, or greater than or equal to 4 mm. A scrim may have a thickness of less than or equal to 5 mm, less than or equal to 4 mm, less than or equal to 3 mm, less than or equal to 2 mm, less than or equal to 1.5 mm, less than or equal to 1 mm, less than or equal to 0.9 mm, less than or equal to 0.8 mm, less than or equal to 0.7 mm, less than or equal to 0.65 mm, less than or equal to 0.6 mm, less than or equal to 0.55 mm, less than or equal to 0.5 mm, less than or equal to 0.45 mm, less than or equal to 0.4 mm, less than or equal to 0.35 mm, less than or equal to 0.3 mm, less than or equal to 0.25 mm, less than or equal to 0.2 mm, less than or equal to 0.15 mm, less than or equal to 0.1 mm, less than or equal to 0.09 mm, less than or equal to 0.08 mm, less than or equal to 0.07 mm, less than or equal to 0.065 mm, less than or equal to 0.06 mm, less than or equal to 0.055 mm, less than or equal to 0.05 mm, less than or equal to 0.045 mm, less than or equal to 0.04 mm, less than or equal to 0.035 mm, less than or equal to 0.03 mm, less than or equal to 0.025 mm, less than or equal to 0.02 mm, or less than or equal to 0.015 mm. Combinations of the above-referenced ranges are also possible (e.g., greater than or equal to 0.01 mm and less than or equal to 5 mm, greater than or equal to 0.01 mm and less than or equal to 2.5 mm, greater than or equal to 0.1 mm and less than or equal to 5 mm, greater than or equal to 0.3 mm and less than or equal to 1 mm, or greater than or equal to 0.4 mm and less than or equal to 0.6 mm).

The thickness of a scrim may be determined in accordance with ASTM D1777 (2015) under an applied pressure of 0.2 kPa. The thickness of a scrim may be determined when the scrim is in the form that it takes in the filter media (e.g., in a form that comprises one or more pluralities of undulations, such as a second plurality of undulations positioned within a first plurality of undulations).

When a filter media comprises two or more scrims, each scrim may independently have a thickness in one or more of the above-referenced ranges.

As described above, some scrims may be relatively open. A scrim may comprise openings that may be parametrized by a longest line that has endpoints on the outer boundary of the opening and passes over the opening. This line would be equivalent to a diameter for a circular opening or to a diagonal for a rectangular opening. In some embodiments, a scrim comprises openings having a longest line that has endpoints on the outer boundary of the opening and passes over the opening of greater than or equal to 0.1 inch, greater than or equal to 0.15 inches, greater than or equal to 0.2 inches, greater than or equal to 0.25 inches, greater than or equal to 0.3 inches, greater than or equal to 0.35 inches, greater than or equal to 0.4 inches, greater than or equal to 0.45 inches, greater than or equal to 0.5 inches, greater than or equal to 0.6 inches, greater than or equal to 0.8 inches, greater than or equal to 1 inch, greater than or equal to 1.25 inches, greater than or equal to 1.5 inches, greater than or equal to 1.75 inches, greater than or equal to 2 inches, greater than or equal to 2.5 inches, greater than or equal to 3 inches, or greater than or equal to 4 inches. A scrim may comprise openings having a longest line that has endpoints on the outer boundary of the opening and passes over the opening of less than or equal to 5 inches, less than or equal to 4 inches, less than or equal to 3 inches, less than or equal to 2.5 inches, less than or equal to 2 inches, less than or equal to 1.75 inches, less than or equal to 1.5 inches, less than or equal to 1.25 inches, less than or equal to 1 inch, less than or equal to 0.9 inches, less than or equal to 0.6 inches, less than or equal to 0.5 inches, less than or equal to 0.45 inches, less than or equal to 0.4 inches, less than or equal to 0.35 inches, less than or equal to 0.3 inches, less than or equal to 0.25 inches, less than or equal to 0.2 inches, or less than or equal to 0.15 inches. Combinations of the above-referenced ranges are also possible (e.g., greater than or equal to 0.1 inch and less than or equal to 5 inches, greater than or equal to 0.1 inch and less than or equal to 1 inch, or greater than or equal to 0.1 inch and less than or equal to 0.5 inches). Other ranges are also possible. The openings may have a variety of shapes (e.g., square, rectangular, and the like).

When a filter media comprises two or more scrims, each scrim may independently comprise openings having a longest line that has endpoints on the outer boundary of the opening and passes over the opening of greater than or equal to in one or more of the above-referenced ranges.

As described above, some filter media, such as waved filter media, comprise one or more support layers. The support layer(s) may support one or more other layer(s) of the filter media that are waved. In some embodiments, one or more support layers may function as prefilter(s) and/or as backer(s). When serving as a prefilter, a support layer may be positioned upstream of an efficiency layer and may assist with filtering out large particles from a fluid prior to exposure to the efficiency layer. This may enhance the capacity of the filter media and/or protect the efficiency layer. Support layers serving as backers may be relatively open (e.g., they may contribute only minimally to the air resistance of the filter media) and/or may provide structural support to the filter media. In some embodiments, a filter media comprises a support layer that is also a backer layer that is relatively stiff and/or pleatable.

In an exemplary embodiment, a filter media includes a downstream support layer disposed on the air outflow side of the waved layer(s) and that is effective to hold the waved layer(s) in the waved configuration. The filter media can also include an upstream support layer that is disposed on the air entering side of the waved layer(s) opposite to the downstream support layer. The upstream support layer can likewise help maintain the waved layer(s) in a waved configuration. As indicated above, a person skilled in the art will appreciate that the filter media can include any number of layers, and it need not include two support layers, or a top layer. In certain exemplary embodiments, the filter media can include a single support layer positioned either upstream or downstream of the other waved layers. In other embodiments, the filter media can include any number of additional layers arranged in various configurations. The particular number and type of layers will depend on the intended use of the filter media.

The support layers described herein can be formed using various techniques known in the art, including meltblowing, air laying, carding, spunbonding, and extrusion. In an exemplary embodiment, a filter media comprises one or more support layers that is a carded or air laid web. In some embodiments, a filter media comprises one or more support layers that is an extruded mesh. It is also possible for a filter media to comprise one or more support layers that are perforated films and/or fibrillated films.

When a filter media includes two or more support layers, each support layer may independently be formed by one or more of the techniques described above.

Various materials can also be used to form the fibers of any support layers included in the filter media described herein, including synthetic and non-synthetic materials. The support layer or layers may comprise meltblown fibers, staple fibers, and/or spunbond fibers.

In one exemplary embodiment, one or more support layers are formed from staple fibers, and in particular from a combination of binder fibers and non-binder fibers. One suitable fiber composition is a blend of at least 20% binder fibers and a balance of non-binder fibers. A variety of types of binder and non-binder fibers can be used to form the support layers of the present invention. The binder fibers can be formed from any material that is effective to facilitate thermal bonding between the layers in the filter media, and will thus have an activation temperature that is lower than the melting point of the non-binder fibers. The binder fibers can be monocomponent fibers or any one of a number of multicomponent (e.g., bicomponent) binder fibers as described elsewhere herein. In one embodiment, the binder fibers can be bicomponent fibers, and each component can have a different melting point. For example, the binder fibers can include a core and a sheath where the activation temperature of the sheath is lower than the melting point of the core. This allows the sheath to melt prior to the core, such that the sheath binds to other fibers in the layer, while the core maintains its structural integrity. This may be particularly advantageous in that it creates a more cohesive layer for trapping filtrate.

When a filter media comprises two or more support layers, each support layer may independently comprise one or more of the fiber types described above.

The non-binder fibers, if present in one or more support layers, can be synthetic and/or non-synthetic, and, in an exemplary embodiment, the non-binder fibers can be 100 wt % synthetic. Synthetic fibers may have advantageous properties with respect to resistance to moisture, heat, long-term aging, and/or microbiological degradation. In some embodiments, the weight percentage of synthetic fibers in each support layer is independently between 80 wt % and 100 wt % of the fibers in the support layer. In some embodiments, the weight percentage of synthetic fibers in each support layer is independently greater than or equal to 80 wt %, greater than or equal to 90 wt %, or greater than or equal to 95 wt %. In some embodiments, the weight percentage of the synthetic fibers in each support layer is independently less than or equal to 100 wt %, less than or equal to 95 wt %, less than or equal to 90 wt %, or less than or equal to 85 wt %. Combinations of the above-referenced ranges are also possible (e.g., greater than or equal to 80 wt % and less than or equal to 100 wt %). Other ranges are also possible. In some embodiments, one or more support layers includes 100 wt % of synthetic fibers. In some embodiments, one or more support layers includes the above-noted ranges of synthetic fibers with respect to the total weight of the support layer (e.g., including any resins).

When a support layer comprises two or more types of synthetic fibers, each type of synthetic fiber may independently make up an amount of the support layer in one or more of the ranges described above and/or all of the synthetic fibers in a support layer may together make up an amount of the support layer in one or more of the ranges described above. Similarly, when a filter media comprises two or more support layers, each support layer may independently comprise an amount of any particular type of synthetic fiber in one or more of the ranges described above and/or may comprise a total amount of synthetic fibers in one or more of the ranges described above.

Exemplary synthetic non-binder fibers can include poly(ester)s, acrylics, poly(olefin)s, nylons, rayons, and combinations thereof.

When a filter media comprises two or more support layers, each support layer may independently comprise one or more of the types of synthetic fibers described above.

Support layers can comprise fibers having a variety of fiber types and sizes. In an exemplary embodiment where a filter media comprises a downstream support layer, the downstream support layer is formed from fibers having an average diameter that is greater than or equal to an average diameter of the fibers in the other layers present in the filter media. In some cases in which a filter media comprises both an upstream support layer and a downstream support layer, the upstream support layer is formed from fibers having an average diameter that is less than or equal to an average diameter of the fibers of the downstream support layer, but that is greater than an average diameter of the other fibers of the other layers present in the filter media. In certain exemplary embodiments, a filter media comprises a downstream support layer and/or an upstream support layer formed from fibers having an average fiber diameter in the range of 10 microns to 32 microns, or 12 microns to 32 microns. For example, the average fiber diameter of the downstream support layer and/or the upstream support layer may be in the range of 18 microns to 22 microns. In some cases, the downstream and/or the upstream support layer may comprise relatively fine fibers. For example, in some embodiments, the finer downstream and/or finer upstream support layer can be formed from fibers having an average fiber diameter in the range of 9 microns to 18 microns. For example, the finer downstream and/or finer upstream support layer average fiber diameter may be in the range of 12 microns to 15 microns.

When a support layer comprises two or more types of fibers, each type of fiber may independently have an average fiber diameter in one or more of the ranges described above and/or all of the fibers in a support layer may together have an average fiber diameter in one or more of the ranges described above. Similarly, when a filter media comprises two or more support layers, each support layer may independently comprise one or more types of fibers having an average fiber diameter in one or more of the ranges described above and/or may comprise fibers that overall have an average fiber diameter in one or more of the ranges described above.

Support layers may comprise fibers having a variety of suitable average fiber lengths. The fibers may comprise staple fibers and/or continuous fibers. In some embodiments, a support layer comprises fibers having an average fiber length of greater than or equal to 3 mm, greater than or equal to 5 mm, greater than or equal to 7.5 mm, greater than or equal to 10 mm, greater than or equal to 20 mm, greater than or equal to 50 mm, greater than or equal to 75 mm, greater than or equal to 100 mm, greater than or equal to 200 mm, greater than or equal to 250 mm, greater than or equal to 300 mm, greater than or equal to 400 mm, greater than or equal to 500 mm, greater than or equal to 750 mm, greater than or equal to 1 m, greater than or equal to 2 m, greater than or equal to 5 m, greater than or equal to 10 m, greater than or equal to 20 m, greater than or equal to 50 m, or greater than or equal to 100 m. In some embodiments, a support layer comprises fibers having an average fiber length of having an average length of less than or equal to 200 m, less than or equal to 100 m, less than or equal to 50 m, less than or equal to 20 m, less than or equal to 10 m, less than or equal to 5 m, less than or equal to 2 m, less than or equal to 1 m, less than or equal to 750 mm, less than or equal to 500 mm, less than or equal to 400 mm, less than or equal to 300 mm, less than or equal to 250 mm, less than or equal to 200 mm, less than or equal to 100 mm, less than or equal to 75 mm, less than or equal to 50 mm, less than or equal to 20 mm, less than or equal to 10 mm, less than or equal to 7.5 mm, or less than or equal to 5 mm. Combinations of the above-referenced ranges are also possible (e.g., greater than or equal to 3 mm and less than or equal to 200 m, greater than or equal to 20 mm and less than or equal to 200 m, greater than or equal to 20 mm and less than or equal to 100 mm, or greater than or equal to 20 mm and less than or equal to 75 mm). Other ranges are also possible.

When a support layer comprises two or more types of fibers, each type of fiber may independently have an average fiber length in one or more of the ranges described above and/or all of the fibers in a support layer may together have an average fiber length in one or more of the ranges described above. Similarly, when a filter media comprises two or more support layers, each support layer may independently comprise one or more types of fibers having an average fiber length in one or more of the ranges described above and/or may comprise fibers that overall have an average fiber length in one or more of the ranges described above.

It should also be noted that it is possible for a support layer to comprise fibers having two or more different diameters and/or two or more different types of cross-sections. Such fibers having differing cross-section and/or diameter may be of the same chemical composition or may have different chemical compositions. Non-limiting embodiments of suitable cross-sections include circular, oval, Y-shaped, I-shaped (e.g., dog bone), closed C-shaped, multilobal (e.g., trilobal, 4-lobed, 5-lobed, 6-lobed, comprising more than 6 lobes, X-shaped, crenulated).

Support layers may have a variety of suitable basis weights. In some embodiments, a support layer has a basis weight of greater than or equal to 10 gsm, greater than or equal to 20 gsm, greater than or equal to 22 gsm, greater than or equal to 33 gsm, greater than or equal to 50 gsm, greater than or equal to 60 gsm, greater than or equal to 70 gsm, greater than or equal to 80 gsm, or greater than or equal to 90 gsm. In some embodiments, a support layer has a basis weight of less than or equal to 99 gsm, less than or equal to 90 gsm, less than or equal to 80 gsm, less than or equal to 70 gsm, less than or equal to 60 gsm, less than or equal to 50 gsm, less than or equal to 33 gsm, less than or equal to 22 gsm, or less than or equal to 20 gsm. Combinations of the above-referenced ranges are also possible (e.g., greater than or equal to 10 gsm and less than or equal to 99 gsm, or greater than or equal to 33 gsm and less than or equal to 70 gsm). Other ranges are also possible.

The basis weight of a support layer may be determined in accordance with ISO 536:2012. The basis weight of a support layer may be determined when the support layer is in the form that it takes in the filter media (e.g., in a form that comprises one or more pluralities of undulations, such as a second plurality of undulations positioned within a first plurality of undulations).

When a filter media comprises two or more support layers, each support layer may independently have a basis weight in one or more of the above-referenced ranges.

Support layers may have a variety of suitable thicknesses. In some embodiments, a support layer has a thickness of greater than or equal to 3 mil, greater than or equal to 4 mil, greater than or equal to 5 mil, greater than or equal to 6 mil, greater than or equal to 8 mil, greater than or equal to 10 mil, greater than or equal to 12 mil, greater than or equal to 15 mil, greater than or equal to 20 mil, greater than or equal to 25 mil, greater than or equal to 30 mil, greater than or equal to 40 mil, greater than or equal to 50 mil, greater than or equal to 60 mil, greater than or equal to 75 mil, greater than or equal to 100 mil, greater than or equal to 125 mil, greater than or equal to 150 mil, or greater than or equal to 175 mil. In some embodiments, a support layer has a thickness of less than or equal to 200 mil, less than or equal to 175 mil, less than or equal to 150 mil, less than or equal to 125 mil, less than or equal to 100 mil, less than or equal to 75 mil, less than or equal to 60 mil, less than or equal to 50 mil, less than or equal to 40 mil, less than or equal to 30 mil, less than or equal to 25 mil, less than or equal to 20 mil, less than or equal to 15 mil, less than or equal to 12 mil, less than or equal to 10 mil, less than or equal to 8 mil, less than or equal to 6 mil, less than or equal to 5 mil, or less than or equal to 4 mil. Combinations of the above-referenced ranges are also possible (e.g., greater than or equal to 4 mil and less than or equal to 200 mil, greater than or equal to 4 mil and less than or equal to 100 mil, greater than or equal to 8 mil and less than or equal to 30 mil, greater than or equal to 15 mil and less than or equal to 60 mil, or greater than or equal to 12 mil and less than or equal to 20 mil). Other ranges are also possible.

The thickness of a support layer may be determined in accordance with ASTM D1777 (2015) under an applied pressure of 0.2 kPa. The thickness of a support layer may be determined when the support layer is in the form that it takes in the filter media (e.g., in a form that comprises one or more pluralities of undulations, such as a second plurality of undulations positioned within a first plurality of undulations).

When a filter media comprises two or more support layers, each support layer may independently have a thickness in one or more of the above-referenced ranges.

Support layers may have a variety of suitable mean flow pore sizes. In some embodiments, a support layer has a mean flow pore size of greater than or equal to 30 microns, greater than or equal to 40 microns, greater than or equal to 50 microns, greater than or equal to 75 microns, greater than or equal to 100 microns, or greater than or equal to 120 microns. In some embodiments, a support layer has a mean flow pore size of less than or equal to 150 microns, less than or equal to 120 microns, less than or equal to 100 microns, less than or equal to 75 microns, less than or equal to 50 microns, or less than or equal to 40 microns. Combinations of the above-referenced ranges are also possible (e.g., greater than or equal to 30 microns and less than or equal to 150 microns, or greater than or equal to 50 microns and less than or equal to 120 microns). Other ranges are also possible.

The mean flow pore size of a support layer may be determined in accordance with ASTM F316 (2003). The mean flow pore size of a support layer may be determined when the support layer is in the form that it takes in the filter media (e.g., in a form that comprises one or more pluralities of undulations, such as a second plurality of undulations positioned within a first plurality of undulations).

Support layers may have a variety of suitable stiffnesses. In some embodiments, a support layer has a stiffness of greater than or equal to 200 mg, greater than or equal to 300 mg, greater than or equal to 500 mg, greater than or equal to 750 mg, greater than or equal to 1000 mg, greater than or equal to 2000 mg, greater than or equal to 5000 mg, or greater than or equal to 7500 mg. In some embodiments, a support layer has a stiffness of less than or equal to 10000 mg, less than or equal to 7500 mg, less than or equal to 5000 mg, less than or equal to 2000 mg, less than or equal to 1000 mg, less than or equal to 750 mg, less than or equal to 500 mg, or less than or equal to 300 mg. Combinations of the above-referenced ranges are also possible (e.g., greater than or equal to 200 mg and less than or equal to 10000 mg). Other ranges are also possible.

The stiffness of a support layer may be determined in accordance with WSP 90.2 (2015). The stiffness of a support layer may be determined when the support layer is in the form that it takes in the filter media (e.g., in a form that comprises one or more pluralities of undulations, such as a second plurality of undulations positioned within a first plurality of undulations).

When a filter media comprises two or more support layers, each support layer may independently have a stiffness in one or more of the above-referenced ranges.

In one exemplary embodiment, a filter media comprises a downstream support layer and an upstream support layer, as measured in a planar configuration, each of which have a thickness of greater than or equal to 8 mil and less than or equal to 30 mil (e.g., greater than or equal to 12 mil and less than or equal to 20 mil), a basis weight of greater than or equal to 10 gsm and less than or equal to 99 gsm (e.g., greater than or equal to 22 gsm and less than or equal to 99 gsm, or greater than or equal to 33 gsm and less than or equal to 70 gsm), and a mean flow pore size of greater than or equal to 30 microns and less than or equal to 150 microns (e.g., greater than or equal to 50 microns and less than or equal to 120 microns).

As described above, some filter media, such as waved filter media, include one or more outer or cover layers disposed on the air entering side I and/or the air outflow side O. By way of example, FIG. 6A illustrates a top layer 18 that is a cover layer disposed on the air entering side I of the filter media 110. In some embodiments, a filter media comprises an outer-most layer that is a wire backing. In some embodiments, a filter media comprises a cover layer that can function as a dust loading layer and/or that can function as an aesthetic layer. In an exemplary embodiment, the cover layer is a planar layer that is mated to the rest of the filter media after assembly and/or waving. The cover layer may provide a top surface that is aesthetically pleasing.

Cover layers can be formed from fibers having a variety of fiber types and sizes. In an exemplary embodiment, a filter media comprises a cover layer that is formed from fibers having an average fiber diameter other than an average fiber diameter of fibers in an upstream support layer, if one is present. In certain exemplary embodiments, a filter media comprises a cover layer that is formed from fibers having an average fiber diameter of greater than or equal to 5 microns and less than or equal to 20 microns. As a result, the cover layer can function as a dust holding layer without affecting the gamma value of the filter media.

It is also possible for a filter media to comprise a cover layer that is non-fibrous. Non-limiting examples of suitable non-fibrous cover layers include perforated films and fibrillated films.

In some embodiments (e.g., the embodiment shown in FIG. 6B), a filter media includes a bottom layer disposed on the air outflow side. The bottom layer can function as strengthening component that provides structural integrity to the filter media to help maintain the waved configuration if the filter media comprises one or more layers that are waved. The bottom layer can also function to offer abrasion resistance. The bottom layer can have a configuration similar to the cover layer, as discussed above. In some embodiments, a filter media comprises both a bottom layer and a cover layer. In an exemplary embodiment, the bottom layer is the coarsest layer, i.e., it is formed from fibers having an average diameter that is greater than an average diameter of fibers forming all of the other layers of the filter media. One exemplary bottom layer is a spunbond layer, however various other layers can be used having various configurations.

Outer layer(s), such as cover layers and/or bottom layers, can also be formed using various techniques known in the art, including meltblowing, wet laid techniques, air laid techniques, carding, spunbonding, and extrusion. In an exemplary embodiment, a filter media comprises a cover layer that is an air laid layer and the bottom layer is a spunbond layer. In some embodiments, a filter media comprises a cover layer that is an extruded mesh and/or a net. The resulting layer(s) can also have a variety of thicknesses, air permeabilities, and basis weights depending upon the requirements of a desired application.

Cover layers and bottom layers can comprise fibers of a variety of suitable types, including synthetic and non-synthetic materials. In one exemplary embodiment, a filter media comprises a cover layer and/or a bottom layer formed from staple fibers, and in particular from a combination of binder fibers and non-binder fibers. One suitable fiber composition is a blend of at least 20% binder fiber and a balance of non-binder fiber. A variety of types of binder and non-binder fibers can be used to form the cover and/or bottom layers of the present invention, including those previously discussed above with respect to the support layers.

In one exemplary embodiment, a filter media comprises a cover layer and/or a bottom layer, as measured in a planar configuration, each of which independently has a thickness of greater than or equal to 2 mil and less than or equal to 50 mil, an air permeability of greater than or equal to 100 CFM and less than or equal to 1200 CFM, and a basis weight of greater than or equal to 10 gsm and less than or equal to 50 gsm. It is also possible for a cover layer to have an air permeability of greater than 1200 CFM, such as an air permeability in excess of 1500 CFM (e.g., in addition to having a thickness and/or air permeability in the above-described ranges, without having a thickness or air permeability in the above-described ranges). The thickness of a cover layer may be determined in accordance with ASTM D1777 (2015) under an applied pressure of 0.2 kPa. The air permeability of a cover layer may be determined in accordance with ASTM Test Standard D737-04 (2006) under a pressure drop of 125 Pa. The basis weight of a cover layer may be determined in accordance with ISO 536:2012.

As described elsewhere herein, some filter media (e.g., comprising one or more of the layers described above) may have one or more advantageous properties. Further details regarding some possible properties of the filter media are provided below.

The initial gamma of the filter media described herein may have a variety of suitable values. The initial gamma value of a filter media is a rating applied thereto based on the relationship between initial penetration and initial pressure drop across the filter media, or initial particulate efficiency as a function of initial pressure drop across the filter media. Generally, higher initial gamma values are indicative of better filter performance, i.e., an initial high particulate efficiency as a function of initial pressure drop. Initial gamma is defined by the following formula: Initial gamma=(−log₁₀(initial penetration %/100)/initial pressure drop, mm H₂O)×100. Penetration, often expressed as a percentage, is defined as follows: Pen (%)=(C/C₀)*100% where C is the particle concentration after passage through the filter and C₀ is the particle concentration before passage through the filter. The initial penetration is the penetration measured upon first exposure of the filter media to the particles, and the initial pressure drop is the pressure drop measured upon first exposure of the filter media to the particles.

The initial penetration and initial gamma described herein are those measured using NaCl particles with an average diameter of 0.26 microns. The initial penetration and initial pressure drop can both be measured using a variety of suitable instruments. As two examples, the initial penetration and pressure drop can be measured by employing a TSI 8130 Automated Filter Tester (8130 CertiTest™ Filter Tester from TSI) for values of penetration in excess of 0.001% and a TSI 3160 Automated Filter Tester for values of penetration of less than or equal to 0.001%. Both instruments have a circular opening with an area of 100 cm² to analyze a flat-sheet filter media.

When measuring initial gamma, the TSI 8130 Automated Filter Tester or TSI 3160 Automated Filter Tester may be employed to blow an NaCl aerosol made up of NaCl particles with an average diameter of 0.26 microns at the filter media. The NaCl particles may be generated from a 2 wt % aqueous solution of NaCl which is caused to form an NaCl aerosol by blowing dilution air through the solution at a rate of 70 L/min at a pressure of 30 psi. The aerosol may then be blown through the filter media at a pressure 30 psi and a rate of 32 L/min, which corresponds to a face velocity of 5.3 cm/s. As the TSI 8130 Automated Filter Tester or TSI 3160 Automated Filter Tester is blowing the NaCl aerosol, both the pressure drop across the filter media and the penetration of the NaCl aerosol may be measured by two condensation nucleus particle counters simultaneously, one of which is upstream of the filter media and one of which is downstream of the filter media. The particle collection efficiency may be reported at the beginning of the test, and is the percentage of upstream challenge particles collected by the filter at the beginning of the test. The initial pressure drop may also be measured at the beginning of the test.

In some embodiments, a filter media has an initial gamma of greater than or equal to 3, greater than or equal to 3.5, greater than or equal to 4, greater than or equal to 4.5, greater than or equal to 5, greater than or equal to 6, greater than or equal to 6.5, greater than or equal to 7, greater than or equal to 7.5, greater than or equal to 8, greater than or equal to 8.5, greater than or equal to 9, greater than or equal to 9.5, greater than or equal to 10, greater than or equal to 12.5, greater than or equal to 15, greater than or equal to 17.5, greater than or equal to 20, greater than or equal to 25, greater than or equal to 30, greater than or equal to 35, greater than or equal to 40, greater than or equal to 45, greater than or equal to 50, greater than or equal to 75, greater than or equal to 100, greater than or equal to 150, greater than or equal to 200, greater than or equal to 250, greater than or equal to 300, or greater than or equal to 350. In some embodiments, a filter media has an initial gamma of less than or equal to 400, less than or equal to 350, less than or equal to 300, less than or equal to 250, less than or equal to 200, less than or equal to 150, less than or equal to 100, less than or equal to 75, less than or equal to 50, less than or equal to 45, less than or equal to 40, less than or equal to 35, less than or equal to 30, less than or equal to 25, less than or equal to 20, less than or equal to 17.5, less than or equal to 15, less than or equal to 12.5, less than or equal to 10, less than or equal to 9.5, less than or equal to 9, less than or equal to 8.5, less than or equal to 8, less than or equal to 7.5, less than or equal to 7, less than or equal to 6.5, less than or equal to 5, less than or equal to 4.5, less than or equal to 4, or less than or equal to 3.5. Combinations of the above-referenced ranges are also possible (e.g., greater than or equal to 3 and less than or equal to 400, or greater than or equal to 4 and less than or equal to 300). Other ranges are also possible.

The initial penetration for the filter media described herein may have a variety of suitable values. In some embodiments, a filter media has an initial penetration of greater than or equal to 0.000001%, greater than or equal to 0.000002%, greater than or equal to 0.000005%, greater than or equal to 0.0000075%, greater than or equal to 0.00001%, greater than or equal to 0.00002%, greater than or equal to 0.00005%, greater than or equal to 0.000075%, greater than or equal to 0.0001%, greater than or equal to 0.0002%, greater than or equal to 0.0005%, greater than or equal to 0.00075%, greater than or equal to 0.001%, greater than or equal to 0.002%, greater than or equal to 0.005%, greater than or equal to 0.0075%, greater than or equal to 0.01%, greater than or equal to 0.02%, greater than or equal to 0.05%, greater than or equal to 0.075%, greater than or equal to 0.1%, greater than or equal to 0.2%, greater than or equal to 0.5%, greater than or equal to 0.75%, greater than or equal to 1%, greater than or equal to 2%, greater than or equal to 5%, greater than or equal to 7.5%, greater than or equal to 10%, greater than or equal to 20%, greater than or equal to 30%, greater than or equal to 40%, greater than or equal to 50%, greater than or equal to 60%, greater than or equal to 70%, or greater than or equal to 80%. In some embodiments, a filter media has an initial penetration of less than or equal to 90%, less than or equal to 80%, less than or equal to 70%, less than or equal to 60%, less than or equal to 50%, less than or equal to 40%, less than or equal to 30%, less than or equal to 20%, less than or equal to 10%, less than or equal to 7.5%, less than or equal to 5%, less than or equal to 2%, less than or equal to 1%, less than or equal to 0.75%, less than or equal to 0.5%, less than or equal to 0.2%, less than or equal to 0.1%, less than or equal to 0.075%, less than or equal to 0.05%, less than or equal to 0.02%, less than or equal to 0.01%, less than or equal to 0.0075%, less than or equal to 0.005%, less than or equal to 0.002%, less than or equal to 0.001%, less than or equal to 0.00075%, less than or equal to 0.0005%, less than or equal to 0.0002%, less than or equal to 0.0001%, less than or equal to 0.000075%, less than or equal to 0.00005%, less than or equal to 0.00002%, less than or equal to 0.00001%, less than or equal to 0.0000075%, less than or equal to 0.000005%, or less than or equal to 0.000002%. Combinations of the above-referenced ranges are also possible (e.g., greater than or equal to 0.000001% and less than or equal to 90%, or greater than or equal to 0.0001% and less than or equal to 70%). Other ranges are also possible.

The initial penetration of a filter media may be determined by the same measurement technique described elsewhere herein for the measurement of initial gamma.

In some embodiments, a filter media has a beta 200 micron rating of greater than or equal to 1 micron, greater than or equal to 1.5 microns, greater than or equal to 2 microns, greater than or equal to 2.5 microns, greater than or equal to 3 microns, greater than or equal to 3.5 microns, greater than or equal to 4 microns, greater than or equal to 5 microns, greater than or equal to 7.5 microns, greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a filter media has a beta 200 micron rating of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 4 microns, less than or equal to 3.5 microns, less than or equal to 3 microns, less than or equal to 2.5 microns, less than or equal to 2 microns, or less than or equal to 1.5 microns. Combinations of the above-referenced ranges are also possible (e.g., greater than or equal to 1 micron and less than or equal to 50 microns, or greater than or equal to 3 microns and less than or equal to 40 microns). Other ranges are also possible.

The micron rating for a beta 200 micron rating may be determined as described elsewhere herein with respect to non-woven fiber webs of the first type.

Some filter media described herein may have a relatively low apparent density. The apparent density may be less than or equal to 175 gsm/mm, less than or equal to 170 gsm/mm, less than or equal to 165 gsm/mm, less than or equal to 160 gsm/mm, less than or equal to 150 gsm/mm, less than or equal to 140 gsm/mm, less than or equal to 130 gsm/mm, less than or equal to 120 gsm/mm, less than or equal to 110 gsm/mm, less than or equal to 100 gsm/mm, less than or equal to 90 gsm/mm, less than or equal to 85 gsm/mm, less than or equal to 80 gsm/mm, less than or equal to 70 gsm/mm, less than or equal to 60 gsm/mm, or less than or equal to 50 gsm/mm. The apparent density may be greater than or equal to 40 gsm/mm, greater than or equal to 50 gsm/mm, greater than or equal to 60 gsm/mm, greater than or equal to 70 gsm/mm, greater than or equal to 80 gsm/mm, greater than or equal to 85 gsm/mm, greater than or equal to 90 gsm/mm, greater than or equal to 100 gsm/mm, greater than or equal to 110 gsm/mm, greater than or equal to 120 gsm/mm, greater than or equal to 130 gsm/mm, greater than or equal to 140 gsm/mm, greater than or equal to 150 gsm/mm, greater than or equal to 160 gsm/mm, greater than or equal to 165 gsm/mm, or greater than or equal to 170 gsm/mm. Combinations of the above-referenced ranges are also possible (e.g., less than or equal to 175 gsm/mm and greater than or equal to 40 gsm/mm, or less than or equal to 170 gsm/mm and greater than or equal to 85 gsm/mm). Other ranges are also possible.

Some filter media described herein may have a relatively high dust holding capacity. The dust holding capacity may be greater than or equal to 10 gsm, greater than or equal to 15 gsm, greater than or equal to 20 gsm, greater than or equal to 25 gsm, greater than or equal to 30 gsm, greater than or equal to 50 gsm, greater than or equal to 75 gsm, greater than or equal to 100 gsm, greater than or equal to 150 gsm, greater than or equal to 200 gsm, greater than or equal to 250 gsm, greater than or equal to 300 gsm, greater than or equal to 350 gsm, greater than or equal to 400 gsm, or greater than or equal to 450 gsm. The dust holding capacity may be less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 100 gsm, less than or equal to 75 gsm, less than or equal to 50 gsm, less than or equal to 30 gsm, less than or equal to 25 gsm, less than or equal to 20 gsm, or less than or equal to 15 gsm. Combinations of the above-referenced ranges are also possible (e.g., greater than or equal to 10 gsm and less than or equal to 500 gsm, or greater than or equal to 20 gsm and less than or equal to 450 gsm). Other ranges are also possible.

The dust holding capacity of a filter media may be determined by performing the Multipass Filter Test based on ISO 16889 (2008) as described elsewhere herein. As also described elsewhere herein, the relevant dust holding capacity is the injected dust holding capacity (i.e., a filter media may have an injected dust holding capacity in one or more of the ranges described above).

Some filter media may have a relatively high ratio of dust holding capacity to beta 200 micron rating. The ratio of dust holding capacity to beta 200 micron rating may be greater than or equal to 10 gsm/micron, greater than or equal to 20 gsm/micron, greater than or equal to 30 gsm/micron, greater than or equal to 40 gsm/micron, greater than or equal to 50 gsm/micron, greater than or equal to 60 gsm/micron, greater than or equal to 70 gsm/micron, greater than or equal to 80 gsm/micron, or greater than or equal to 90 gsm/micron. The ratio of dust holding capacity to beta 200 micron rating may be less than or equal to 100 gsm/micron, less than or equal to 90 gsm/micron, less than or equal to 80 gsm/micron, less than or equal to 70 gsm/micron, less than or equal to 60 gsm/micron, less than or equal to 50 gsm/micron, less than or equal to 40 gsm/micron, less than or equal to 30 gsm/micron, or less than or equal to 20 gsm/micron. Combinations of the above-referenced ranges are also possible (e.g., greater than or equal to 10 gsm/micron and less than or equal to 100 gsm/micron). Other ranges are also possible.

The filter media described herein may have a variety of suitable basis weights. In some embodiments, a filter media has a basis weight of greater than or equal to 5 gsm, greater than or equal to 7.5 gsm, greater than or equal to 10 gsm, greater than or equal to 20 gsm, greater than or equal to 50 gsm, greater than or equal to 75 gsm, greater than or equal to 100 gsm, greater than or equal to 200 gsm, greater than or equal to 500 gsm, or greater than or equal to 750 gsm. In some embodiments, a filter media has a basis weight of less than or equal to 1000 gsm, less than or equal to 750 gsm, less than or equal to 500 gsm, less than or equal to 200 gsm, less than or equal to 100 gsm, less than or equal to 75 gsm, less than or equal to 50 gsm, less than or equal to 20 gsm, less than or equal to 10 gsm, or less than or equal to 7.5 gsm. Combinations of the above-referenced ranges are also possible (e.g., greater than or equal to 5 gsm and less than or equal to 1000 gsm, or greater than or equal to 10 gsm and less than or equal to 500 gsm). Other ranges are also possible.

The basis weight of a filter media may be determined in accordance with ISO 536:2012.

The filter media described herein may have a variety of suitable thicknesses. In some embodiments, a filter media has a thickness of greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, greater than or equal to 7.5 mm, greater than or equal to 10 mm, greater than or equal to 12.5 mm, greater than or equal to 15 mm, greater than or equal to 17.5 mm, greater than or equal to 20 mm, greater than or equal to 22.5 mm, greater than or equal to 25 mm, greater than or equal to 27.5 mm, greater than or equal to 30 mm, greater than or equal to 32.5 mm, greater than or equal to 35 mm, greater than or equal to 37.5 mm, greater than or equal to 40 mm, or greater than or equal to 42.5 mm. In some embodiments, a filter media has a thickness of less than or equal to 45 mm, less than or equal to 42.5 mm, less than or equal to 40 mm, less than or equal to 37.5 mm, less than or equal to 35 mm, less than or equal to 32.5 mm, less than or equal to 30 mm, less than or equal to 27.5 mm, less than or equal to 25 mm, less than or equal to 22.5 mm, less than or equal to 20 mm, less than or equal to 17.5 mm, less than or equal to 15 mm, less than or equal to 12.5 mm, less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, or less than or equal to 0.2 mm. Combinations of the above-referenced ranges are also possible (e.g., greater than or equal to 0.1 mm and less than or equal to 40 mm, greater than or equal to 0.1 mm and less than or equal to 30 mm, or greater than or equal to 0.2 mm and less than or equal to 20 mm). Other ranges are also possible.

The thickness of a filter media may be determined in accordance with ASTM D1777 (2015) under an applied pressure of 0.2 kPa.

The filter media described herein may have relatively low mean flow pore sizes. The mean flow pore size may be less than or equal to 200 microns, less than or equal to 150 microns, less than or equal to 100 microns, less than or equal to 80 microns, less than or equal to 60 microns, less than or equal to 50 microns, less than or equal to 40 microns, less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 2 microns, less than or equal to 1 micron, less than or equal to 0.75 microns, less than or equal to 0.6 microns, less than or equal to 0.5 microns, less than or equal to 0.4 microns, less than or equal to 0.3 microns, or less than or equal to 0.25 microns. The mean flow pore size may be greater than or equal to 0.2 microns, greater than or equal to 0.25 microns, greater than or equal to 0.3 microns, greater than or equal to 0.4 microns, greater than or equal to 0.5 microns, greater than or equal to 0.6 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, greater than or equal to 80 microns, greater than or equal to 100 microns, or greater than or equal to 150 microns. Combinations of the above-referenced ranges are also possible (e.g., less than or equal to 200 microns and greater than or equal to 0.2 microns, or less than or equal to 100 microns and greater than or equal to 0.3 microns). Other ranges are also possible.

The mean flow pore size of a filter media may be determined in accordance with ASTM F316 (2003).

The filter media described herein may have a variety of suitable maximum pore sizes. In some embodiments, a filter media has a maximum pore size of greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 20 microns, greater than or equal to 50 microns, greater than or equal to 75 microns, greater than or equal to 100 microns, greater than or equal to 150 microns, greater than or equal to 200 microns, greater than or equal to 250 microns, greater than or equal to 300 microns, or greater than or equal to 350 microns. In some embodiments, a filter media has a maximum pore size of less than or equal to 400 microns, less than or equal to 350 microns, less than or equal to 300 microns, less than or equal to 250 microns, less than or equal to 200 microns, less than or equal to 150 microns, less than or equal to 100 microns, less than or equal to 75 microns, less than or equal to 50 microns, less than or equal to 20 microns, less than or equal to 10 microns, less than or equal to 7.5 microns, less than or equal to 5 microns, less than or equal to 2 microns, less than or equal to 1 micron, or less than or equal to 0.75 microns. Combinations of the above-referenced ranges are also possible (e.g., greater than or equal to 0.5 microns and less than or equal to 400 microns, or greater than or equal to 1 micron and less than or equal to 200 microns). Other ranges are also possible.

The maximum pore size of a filter media may be determined in accordance with ASTM F316 (2003).

The filter media described herein may have a variety of suitable air permeabilities. In some embodiments, a filter media has an air permeability of greater than or equal to 0.2 CFM, greater than or equal to 0.3 CFM, greater than or equal to 0.4 CFM, greater than or equal to 0.5 CFM, greater than or equal to 0.6 CFM, greater than or equal to 0.75 CFM, greater than or equal to 1 CFM, greater than or equal to 2 CFM, greater than or equal to 5 CFM, greater than or equal to 7.5 CFM, greater than or equal to 10 CFM, greater than or equal to 20 CFM, greater than or equal to 50 CFM, greater than or equal to 75 CFM, greater than or equal to 100 CFM, greater than or equal to 200 CFM, greater than or equal to 300 CFM, greater than or equal to 400 CFM, greater than or equal to 500 CFM, greater than or equal to 600 CFM, or greater than or equal to 800 CFM. In some embodiments, a filter media has an air permeability of less than or equal to 1000 CFM, less than or equal to 800 CFM, less than or equal to 600 CFM, less than or equal to 500 CFM, less than or equal to 400 CFM, less than or equal to 300 CFM, less than or equal to 200 CFM, less than or equal to 100 CFM, less than or equal to 75 CFM, less than or equal to 50 CFM, less than or equal to 20 CFM, less than or equal to 10 CFM, less than or equal to 7.5 CFM, less than or equal to 5 CFM, less than or equal to 2 CFM, less than or equal to 1 CFM, less than or equal to 0.75 CFM, less than or equal to 0.6 CFM, less than or equal to 0.5 CFM, less than or equal to 0.4 CFM, or less than or equal to 0.3 CFM. Combinations of the above-referenced ranges are also possible (e.g., greater than or equal to 0.2 CFM and less than or equal to 1000 CFM, or greater than or equal to 0.5 CFM and less than or equal to 800 CFM). Other ranges are also possible.

The air permeability of a filter media may be determined in accordance with ASTM D737-04 at a pressure of 125 Pa.

In some embodiments, a filter media described herein may be a component of a filter element. That is, the filter media may be incorporated into an article suitable for use by an end user.

Non-limiting examples of suitable filter elements include flat panel filters, V-bank filters (comprising, e.g., between 1 and 24 Vs), cartridge filters, cylindrical filters, conical filters, and curvilinear filters. Filter elements may have any suitable height (e.g., between 2 in and 124 in for flat panel filters, between 4 in and 124 in for V-bank filters, between 1 in and 124 in for cartridge and cylindrical filter media). Filter elements may also have any suitable width (between 2 in and 124 in for flat panel filters, between 4 in and 124 in for V-bank filters). Some filter media (e.g., cartridge filter media, cylindrical filter media) may be characterized by a diameter instead of a width; these filter media may have a diameter of any suitable value (e.g., between 1 in and 124 in). Filter elements typically comprise a frame, which may be made of one or more materials such as cardboard, aluminum, steel, alloys, wood, and polymers.

As described above, in some embodiments, a filter media described herein may be a component of a filter element and may be pleated. The pleat height and pleat density (number of pleats per unit length of the media) may be selected as desired. In some embodiments, the pleat height may be greater than or equal to 3 mm, greater than or equal to 5 mm, greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 53 mm, greater than or equal to 55 mm, greater than or equal to 60 mm, greater than or equal to 65 mm, greater than or equal to 70 mm, greater than or equal to 75 mm, greater than or equal to 80 mm, greater than or equal to 85 mm, greater than or equal to 90 mm, greater than or equal to 95 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, greater than or equal to 275 mm, greater than or equal to 300 mm, greater than or equal to 325 mm, greater than or equal to 350 mm, greater than or equal to 375 mm, greater than or equal to 400 mm, greater than or equal to 425 mm, greater than or equal to 450 mm, greater than or equal to 475 mm, or greater than or equal to 500 mm. In some embodiments, the pleat height is less than or equal to 510 mm, less than or equal to 500 mm, less than or equal to 475 mm, less than or equal to 450 mm, less than or equal to 425 mm, less than or equal to 400 mm, less than or equal to 375 mm, less than or equal to 350 mm, less than or equal to 325 mm, less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 95 mm, less than or equal to 90 mm, less than or equal to 85 mm, less than or equal to 80 mm, less than or equal to 75 mm, less than or equal to 70 mm, less than or equal to 65 mm, less than or equal to 60 mm, less than or equal to 55 mm, less than or equal to 53 mm, less than or equal to 50 mm, less than or equal to 45 mm, less than or equal to 40 mm, less than or equal to 35 mm, less than or equal to 30 mm, less than or equal to 25 mm, less than or equal to 20 mm, less than or equal to 15 mm, less than or equal to 10 mm, or less than or equal to 5 mm. Combinations of the above-referenced ranges are also possible (e.g., greater than or equal to 3 mm and less than or equal to 510 mm, greater than or equal to 10 mm and less than or equal to 510 mm, or greater than or equal to 10 mm and less than or equal to 100 mm). Other ranges are also possible.

In some embodiments, a filter media has a pleat density of greater than or equal to 5 pleats per 100 mm, greater than or equal to 6 pleats per 100 mm, greater than or equal to 10 pleats per 100 mm, greater than or equal to 15 pleats per 100 mm, greater than or equal to 20 pleats per 100 mm, greater than or equal to 25 pleats per 100 mm, greater than or equal to 28 pleats per 100 mm, greater than or equal to 30 pleats per 100 mm, or greater than or equal to 35 pleats per 100 mm. In some embodiments, a filter media has a pleat density of less than or equal to 40 pleats per 100 mm, less than or equal to 35 pleats per 100 mm, less than or equal to 30 pleats per 100 mm, less than or equal to 28 pleats per 100 mm, less than or equal to 25 pleats per 100 mm, less than or equal to 20 pleats per 100 mm, less than or equal to 15 pleats per 100 mm, less than or equal to 10 pleats per 100 mm, or less than or equal to 6 pleats per 100 mm. Combinations of the above-referenced ranges are also possible (e.g., greater than or equal to 5 pleats per 100 mm and less than or equal to 40 pleats per 100 mm, greater than or equal to 6 pleats per 100 mm and less than or equal to 40 pleats per 100 mm, or greater than or equal to 25 pleats per 100 mm and less than or equal to 28 pleats per 100 mm). Other ranges are also possible.

Other pleat heights and densities may also be possible. For instance, filter media within flat panel or V-bank filters may have pleat heights between ¼ in and 24 in, and/or pleat densities between 1 pleat/in and 50 pleats/in. As another example, filter media within cartridge filters or conical filters may have pleat heights between ¼ in and 24 in and/or pleat densities between ½ pleats/in and 100 pleats/in. In some embodiments, pleats are separated by a pleat separator made of, e.g., polymer, glass, aluminum, and/or cotton. In other embodiments, the filter element lacks a pleat separator. The filter media may be wire-backed, or it may be self-supporting.

The filter media described herein may be employed to filter a variety of suitable fluids. Some methods may comprise passing a fluid through a filter media. Non-limiting examples of suitable types of fluid include hydraulic fluid, diesel, mineral oil, and HFA liquids.

### Example 1

This Example compares selected properties of a synthetic filter media comprising two pluralities of undulations to an otherwise equivalent synthetic filter media lacking undulations and to a glass filter media lacking undulations.

The synthetic filter media were formed by using a paper machine to make a wetlaid non-woven fiber web for which 100 wt % of the fibers were synthetic fibers. The wetlaying was performed by dispersing monocomponent and bicomponent synthetic fibers in a hydropulper and then transferring the resulting dispersion to a machine chest and then to a paper machine. After wetlaying, some of the remaining water was drained from the non-woven fiber web. Then, the non-woven fiber web was transferred to dryer cans to remove further remaining water. While positioned in the dryer cans, the lower melting point component of the bicomponent fibers melted and bonded the non-woven fiber web together.

The glass filter media were formed in a manner similar to that employed to form the synthetic filter media. However, glass fibers and a binder resin were employed instead of monocomponent and bicomponent synthetic fibers.

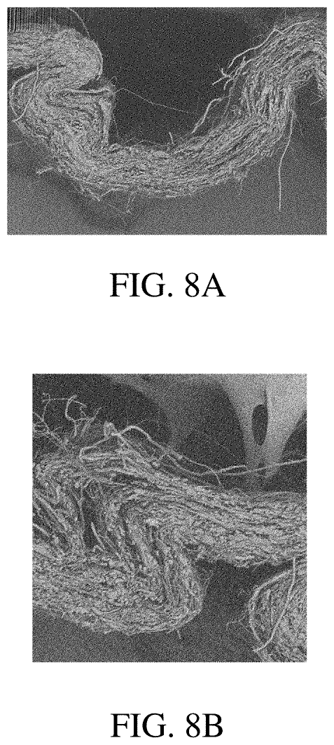

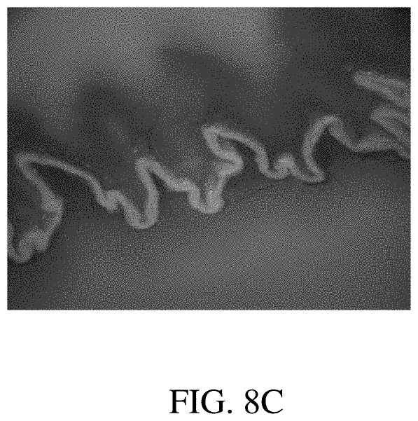

After formation, one synthetic filter media underwent a microcreping process, after which it included two pluralities of undulations. Micrographs of this filter media are shown in FIGS. 8A-8C.

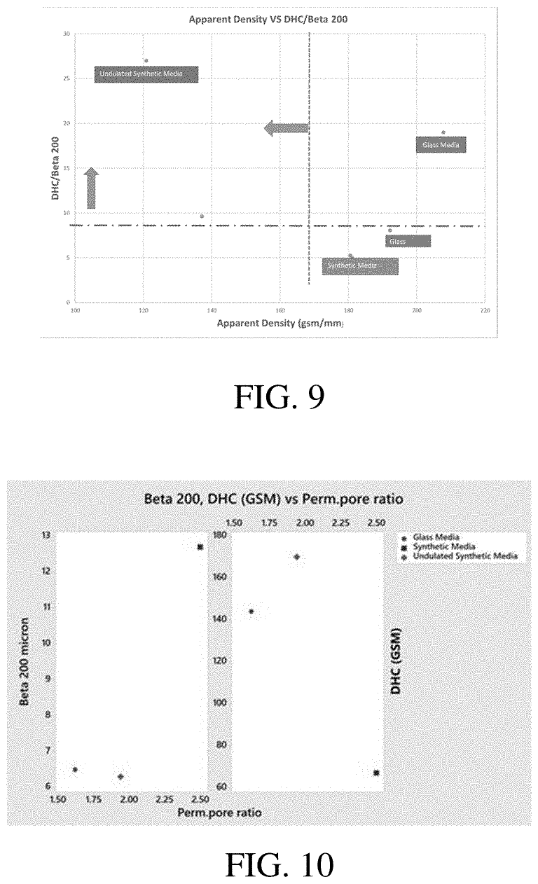

FIG. 9 shows the ratio of dust holding capacity to beta 200 micron rating for the various filter media plotted as a function of the ratio of apparent density. In FIG. 9, data from the synthetic filter media comprising two pluralities of undulations is labeled “Undulated Synthetic Media”, data from the synthetic filter media that did not undergo the microcreping process is labeled “Synthetic Media”, and data from the glass filter media is labeled “Glass Media”. As can be seen in FIG. 9, the synthetic filter media comprising two pluralities of undulations has the lowest apparent density of all of the filter media and has the highest ratio of dust holding capacity to beta 200 micron rating. This latter parameter is indicative of both good dust holding capacity and high efficiency.

FIG. 10 shows the beta 200 micron ratings and dust holding capacities for three of these filter media plotted as a function of the ratio of mean flow pore size to square root of air permeability. The x-axis is the ratio of mean flow pore size to square root of air permeability. The left y-axis is the beta 200 micron rating, and the right y-axis is the dust holding capacity. FIG. 10 also has the same sample key as FIG. 9. From FIG. 10, it is clear that the synthetic filter media comprising two pluralities of undulations alone has a high dust holding capacity and low beta 200 micron rating.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A filter media, comprising:
a non-woven fiber web comprising fibers,
wherein a ratio of an average fiber diameter of the fibers in the non-woven fiber web to a mean flow pore size of the non-woven fiber web is greater than or equal to 0.8.

2. A filter media as in claim 1, wherein the non-woven fiber web comprises a first plurality of undulations.

3. A filter media as in claim 2, wherein the non-woven fiber web comprises a second plurality of undulations positioned within at least a portion of the first plurality of undulations.

4. (canceled)

5. A filter media as in claim 3, wherein the first and second pluralities of undulations are irregular.

6. A filter media, comprising:
a non-woven fiber web comprising fibers, wherein:
the non-woven fiber web has an apparent density of less than or equal to 170 gsm/mm,
the non-woven fiber web has a dust holding capacity and a beta 200 micron rating, and
a ratio of the dust holding capacity to the beta 200 micron is greater than or equal to 10 gsm/micron.

7-10. (canceled)

11. A filter media, comprising:
a non-woven fiber web comprising fibers, wherein:
the non-woven fiber web comprises a first plurality of undulations;
the non-woven fiber web comprises a second plurality of undulations positioned within at least a portion of the first plurality of undulations;
the second plurality of undulations comprises at least one undulation; and
the first and second pluralities of undulations are irregular.

12-18. (canceled)

19. A filter media as in claim 1, wherein the non-woven fiber web comprises a synthetic, unfibrillated fibers.

20. (canceled)

21. A filter media as in claim 19, wherein the synthetic, unfibrillated fibers have an average fiber diameter of greater than or equal to 0.01 micron and less than or equal to 3 microns.

22-25. (canceled)

26. A filter media as in claim 1, wherein the non-woven fiber web comprises two types of synthetic, unfibrillated fibers.

27. (canceled)

28. A filter media as in claim 19, wherein the synthetic, unfibrillated fibers have an average fiber diameter of greater than or equal to 3 microns and less than or equal to 50 microns.

29-33. (canceled)

34. A filter media as in claim 1, wherein the non-woven fiber web comprises natural, fibrillated fibers.

35-49. (canceled)

50. A filter media as in claim 1, wherein the non-woven fiber web comprises multicomponent fibers.

51-59. (canceled)

60. A filter media as in claim 1, wherein the non-woven fiber web comprises glass fibers.

61-67. (canceled)

68. A filter media as in claim 1, wherein the non-woven fiber web is a wet laid layer.

69. A filter media as in claim 1, wherein the non-woven fiber web has an air permeability of greater than or equal to 0.5 CFM and less than or equal to 800 CFM.

70. A filter media as in claim 1, wherein the non-woven fiber web has a mean flow pore size of greater than or equal to 0.3 microns and less than or equal to 100 microns.

71. A filter media as in claim 1, wherein the ratio of the mean flow pore size to the square root of the air permeability is greater than or equal to 0.3 microns/(CFM)^{0.5} and less than or equal to 6 microns/(CFM)^{0.5}

72-77. (canceled)

78. A filter media as in claim 1, wherein the filter media has an apparent density of greater than or equal to 5 gsm/mm and less than or equal to 170 gsm/mm.

79. A filter media as in claim 1, wherein the filter media has a beta 200 of greater than or equal to 3 microns and less than or equal to 40 microns.

80. A filter media as in claim 1, wherein the filter media has a dust holding capacity of greater than or equal to 20 gsm and less than or equal to 450 gsm.

81-107. (canceled)
